(19) United States
(12) Patent Application Publication
(10) Pub. No.: US 2025/0136209 A1
(43) Pub. Date: May 1, 2025

(54) Modular Trailer Kit and Accessory Systems

(71) Applicant: Harbor Freight Tools USA, Inc., Calabasas, CA (US)

(72) Inventor: Troy Lee Freeman, Sweetser, IN (US)

(21) Appl. No.: 18/928,827

(22) Filed: Oct. 28, 2024

Related U.S. Application Data
(60) Provisional application No. 63/546,507, filed on Oct. 30, 2023.

(51) Int. Cl. B62D 63/08; B62D 21/17; B62D 27/06; B62D 65/12

(52) U.S. Cl. CPC B62D 63/08; B62D 21/17; B62D 27/065; B62D 65/12

(57) ABSTRACT

A base trailer and trailer kit for forming a base trailer is disclosed. The base trailer and trailer kit comprises a plurality of modular rails and a plurality of brackets. To form a trailer frame without welding or drilling, the plurality of modular rails are interconnected by the plurality of brackets. Depending on the desired trailer configuration, the type of load carried, or the task to be performed, the base trailer and trailer kit accommodate an accessory mounting system, at least one accessory bracket, and/or one or more accessories. The base trailer and trailer kit allow for modification and customization of a single trailer frame into one or more trailer configurations.

### CROSS-REFERENCE TO RELATED APPLICATIONS

This application claims priority to U.S. Provisional Application No. 63/546,507, filed Oct. 30, 2023, the entire contents of which are incorporated by reference herein.

### BACKGROUND

The present disclosure relates generally to a base trailer configuration and modular trailer kits comprised of a plurality of modular rails and a plurality of brackets.

Most trailers require welding or drilling to form a complete chassis or frame. It is common to supply these trailers in a pre-assembled configuration designed to be used for a specific purpose. Due to the bulk of a completed trailer frame, however, these trailers may be difficult to package and ship domestically or internationally. It is therefore advantageous to provide a trailer or trailer kit having a trailer frame that can be assembled using readily available tools without requiring specialized skills such as welding.

Additionally, current trailers and trailer kits comprised of rails and brackets are limited in their application. For example, a trailer may be limited to a particular configuration such as a trailer with an upper railing system or wall system to enclose a bed of the trailer. Other trailers assembled from kits may include brackets designed for a specific location on a trailer frame, or brackets designed for a singular particular purpose, thereby limiting the type of load carried or task performed.

Users often require different trailer configurations for hauling different types of loads or may require a variety of accessories mounted to a trailer for different tasks. A user may also desire to change or modify an existing trailer configuration to avoid purchasing a separate trailer with a different configuration. As such, it is beneficial for a single trailer to have a wide range of applications such that it may be used to complete a variety of tasks. It is therefore advantageous to provide a trailer or trailer kit that includes selectively mountable brackets that allow for modification and customization of a trailer frame depending on the desired trailer configuration, the type of load carried, and the task performed.

### SUMMARY

A trailer kit comprised of a plurality of modular rails and a plurality of brackets is disclosed, as illustrated by and described in connection with the figures of the present disclosure, and as set forth in the claims.

Specifically, disclosed is an example trailer kit. The trailer kit includes a plurality of modular rails, wherein the plurality of modular rails forms a trailer frame. The trailer frame includes at least one cross member. The trailer kit further includes a plurality of brackets. The plurality of brackets includes a frame bracket operable to join at least two modular rails. The plurality of brackets further includes a tongue bracket operable to secure a trailer tongue assembly to the trailer frame. The plurality of brackets further includes an axle bracket operable to secure an axle and wheel assembly to the trailer frame. The plurality of brackets further includes a cross member bracket operable to secure the at least one cross member to the trailer frame.

In one example, each of the plurality of modular rails defines a first end, a second end, and a channel extending between the first and the second end. In another example, the trailer kit further includes at least one fastener, wherein at least a portion of the least one fastener is received within the channel such that the at least one fastener is operable to be fastened to any of the plurality of modular rails. In one example, the at least one fastener comprises a nut and a bolt, wherein the nut is received within the channel, the at least one fastener operable to fasten any of the plurality of brackets to any of the plurality of modular rails.

In another example, the channel of each of the plurality of modular rails is operable to receive an electrical harness, the electrical harness operable to power a trailer lighting system. In one example, the trailer kit further includes a channel cover secured within the channel of each of the plurality of modular rails, the channel cover operable to at least partially seal the channel.

In one example, each of the plurality of brackets includes a body, at least one tab extending from the body, operable to couple the body to any of the plurality of modular rails, and at least one fastener receiver formed in the body, operable to receive the least one fastener for fastening the body to any of the plurality of modular rails or any of the plurality of brackets. In another example, the trailer frame includes an upper set of modular rails and a lower set of modular rails.

In another example, the at least one tab comprises at least one upper tab and at least one lower tab. In this example, the at least one fastener receiver comprises at least one upper fastener receiver and at least one lower fastener receiver. Also in this example, the at least one upper tab is operable to couple the body to the upper set of modular rails and the at least one lower tab is operable to couple the body to the lower set of modular rails. Also in this example, the at least one upper fastener receiver is operable to receive the fastener for fastening the body to the upper set of modular rails and the at least one lower fastener receiver is operable to receive the fastener for fastening the body to the lower set of modular rails, thereby coupling the upper set of modular rails to the lower set of modular rails.

In one example, the plurality of brackets further includes at least one accessory bracket operable to secure one or more accessories to the trailer frame, the least one cross member, and/or at least one of the plurality of uprights. In another example, the frame bracket includes a corner bracket operable to join at least one of the plurality of modular rails to another one of the modular rails at a 90 degree angle and a longitudinal bracket operable to join at least one of the plurality of modular rails to another one of the plurality of modular rails. In yet another example, the corner bracket further includes a lighting receiver, operable to receive and mount a light to the corner bracket.

In another example, the tongue bracket includes a front end bracket operable to secure at least one tongue rail to a front end of the trailer frame and a tongue rail bracket operable to secure the at least one tongue rail to a side of the trailer frame. In one example, the cross member bracket includes at least one opening in at least one tab formed on a body such that the fastener inserted through the at least one opening is operable to fasten the cross member bracket to any of the plurality of brackets.

Also disclosed is another example of a base trailer. The base trailer includes a plurality of modular rails, wherein the plurality of modular rails forms a trailer frame. The base trailer further includes a plurality of brackets operable to reinforce the trailer frame. In this example, the base trailer is configurable into one or more trailer configurations and the trailer configurations are interchangeable.

In one example, the multiple trailer configurations can be configured on the trailer frame. In another example, the base trailer further includes an accessory mounting system. In yet another example, the accessory mounting system includes one or more accessory brackets. In one example, the trailer configurations includes one or more accessories.

In one example, the accessory brackets and/or accessories are interchangeably fastened to the trailer frame with at least one fastener. In one example, each of the trailer configurations are interchangeably configurable to the trailer frame without welding or drilling into the trailer frame.

Also disclosed is an example method of assembling a trailer kit. The method includes providing a trailer kit, the trailer kit having a plurality of modular rails and a plurality of brackets. The plurality of brackets includes a frame bracket, a tongue bracket, an axle bracket, and a cross member bracket. The method further includes forming a trailer frame and at least one cross member from the plurality of modular rails. The method further includes affixing the frame bracket to the trailer frame, wherein the frame bracket is operable to join at least two modular rails. The method further includes affixing the cross member bracket to the trailer frame and the least one cross member. The method further includes attaching a trailer tongue assembly to the trailer frame with the at least one tongue bracket. The method further includes attaching an axle and wheel assembly to the trailer frame with the axle bracket.

In one example, the method further includes attaching at least one accessory mounting system, at least one accessory bracket, one or more accessories to the trailer frame, and/or at least one of plurality of uprights. In another example, the method further includes removing the at least one accessory mounting system, the at least one accessory bracket, the one or more accessories from the trailer frame, and/or the plurality of uprights.

### BRIEF DESCRIPTION OF SEVERAL VIEWS OF THE DRAWINGS

The following is a brief description of the drawings pertaining to the present disclosure, which will be discussed in more detail in the detailed description section below:

FIG. 1 illustrates an exploded perspective view of a modular base trailer.

FIG. 2 illustrates a perspective view of an assembled modular base trailer.

FIG. 3 illustrates a perspective view of a rail and at least one nut and at least one bolt.

FIG. 4 illustrates a perspective view of the nut.

FIG. 4A illustrates a top perspective view of another embodiment of the nut.

FIG. 4B illustrates a side perspective view of the other embodiment of the nut.

FIG. 4C illustrates a top perspective view of the other embodiment of the nut inserted into a portion of the rail.

FIG. 4D illustrates a top perspective view of the other embodiment of the nut rotated approximately 90-degrees inserted into a portion of the rail.

FIG. 5 illustrates a perspective view of the assembled modular base trailer showing references for FIGS. 7, 9, 13, 15, and 18.

FIG. 6 illustrates a top-rear perspective view of a corner bracket.

FIG. 7 illustrates an exploded detail view of the corner bracket.

FIG. 8 illustrates a top-rear perspective view of a longitudinal bracket.

FIG. 9 illustrates an exploded detail view of the longitudinal bracket.

FIG. 10 illustrates a bottom-rear perspective view of a front end bracket.

FIG. 11 illustrates a top-rear perspective view of a tongue rail bracket.

FIG. 12 illustrates a top-front perspective view of a tongue rail.

FIG. 13 illustrates an exploded detail view of the front end bracket, the tongue rail bracket, and a tongue assembly.

FIG. 14 illustrates a top-rear perspective view of an axle bracket.

FIG. 15 illustrates an exploded perspective view of at least one axle bracket and an axle and wheel assembly.

FIG. 16 illustrates a partial top-rear perspective view of a cross member bracket secured to the modular base trailer, specifically the axle bracket and a cross-member rail, showing certain components as transparent for clarity of illustration.

FIG. 17 illustrates a top-rear perspective view of the cross member bracket.

FIG. 18 illustrates a bottom-rear perspective detail view of the cross member bracket secured to the modular base trailer, specifically secured to the cross-member rail and the longitudinal bracket.

FIG. 19 illustrates a partial top-rear perspective view of the cross member bracket secured to the modular base trailer, specifically the corner bracket and the cross-member rail, showing certain components as transparent for clarity of illustration.

FIG. 20 illustrates a partial top-rear perspective view of at least a portion of a trailer lighting system including a channel cover protecting an electrical harness of the trailer lighting system, shown in dashed lines behind the channel cover

FIG. 21 illustrates a top-rear perspective view of the channel cover.

FIG. 22 illustrates a cross-sectional view of the channel cover and the rail taken along line 22-22 of FIG. 20.

FIG. 23 illustrates a top-front perspective view of the modular base trailer with a decking, a fairing system, a ramp storage system, and a stabilizer jack assembly.

FIG. 24 illustrates an exploded detail view of the fairing system.

FIG. 25 illustrates a top-front perspective view of the ramp storage system in a closed configuration.

FIG. 26 illustrates a top-rear perspective view of the ramp storage system in the closed configuration and showing a ramp stowed.

FIG. 27 illustrates a top-rear perspective view of the ramp storage system in an opened configuration and showing the ramp deployed.

FIG. 28 illustrates a top-front perspective view of the modular base trailer with the decking and a frame extension system.

FIG. 29 illustrates a partially exploded top-front perspective view of the frame extension system secured to a trailer frame.

FIG. 30 illustrates a partially exploded bottom perspective view of the frame extension system secured to the trailer frame.

FIG. 31 illustrates a partial top perspective view of the modular base trailer with the decking and the frame extension system.

FIG. 32 illustrates a partially exploded bottom perspective view of the frame extension system secured to the trailer frame.

FIG. 33 illustrates a partial top-rear perspective view of the frame extension system secured to the trailer frame.

FIG. 34 illustrates a partial bottom perspective view of the frame extension system secured to the trailer frame.

FIG. 35 illustrates a top-front perspective view of the modular base trailer with the decking and a fence system.

FIG. 36 illustrates a partially exploded top-rear perspective view of a tailgate system.

FIG. 37 illustrates a partial top perspective view of a latch assembly of the tailgate system in a closed configuration.

FIG. 38 illustrates a partial top, right-side perspective view of the latch assembly of the tailgate system in an open configuration.

FIG. 39 illustrates a bottom-rear perspective view of the tailgate system in a closed configuration and a partially exploded undercarriage ramp storage system.

FIG. 40 illustrates a partially exploded top right-side perspective view of a spare tire bracket.

FIG. 41 illustrates a partial top-right side perspective view of a spare tire secured to the spare tire bracket on the fence system, showing certain components as transparent for clarity of illustration.

FIG. 42 illustrates a top-rear perspective view of the modular base trailer with the decking, a portion of the fence system, a hitch assembly, a plurality of rack assemblies, a plurality of toolbox assemblies, and a tongue tray.

FIG. 43 illustrates an exploded top rear perspective view of one of the rack assemblies.

FIG. 44 illustrates a partially exploded bottom-front perspective detail view of the hitch assembly.

FIG. 45 illustrates a partial top-right side perspective view of the modular base trailer with the decking, the longitudinal bracket, a tie down bracket, and a stabilizer jack assembly.

FIG. 46 illustrates an exploded top right-side perspective view of one of the stabilizer jack assemblies.

FIG. 47 illustrates a bottom right-side perspective view of one of the toolbox assemblies.

FIG. 48 illustrates a top-front perspective view of the tongue tray.

FIG. 49 illustrates a top-front perspective view of the tongue tray secured to the trailer frame.

FIG. 50 is a flow chart illustrating example steps for assembling the modular base trailer.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

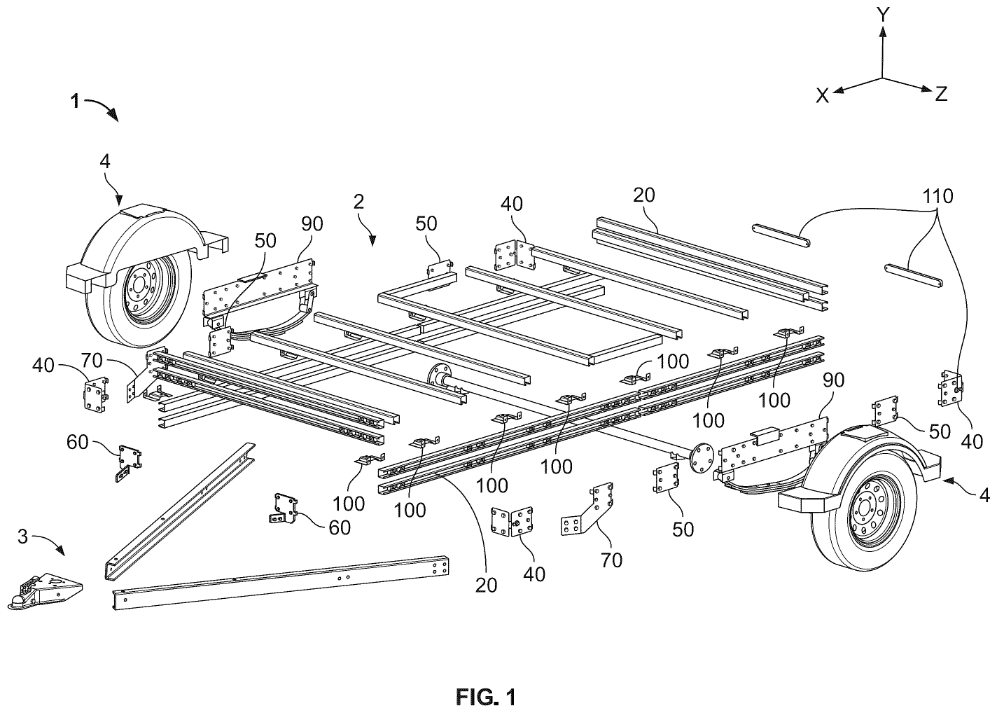

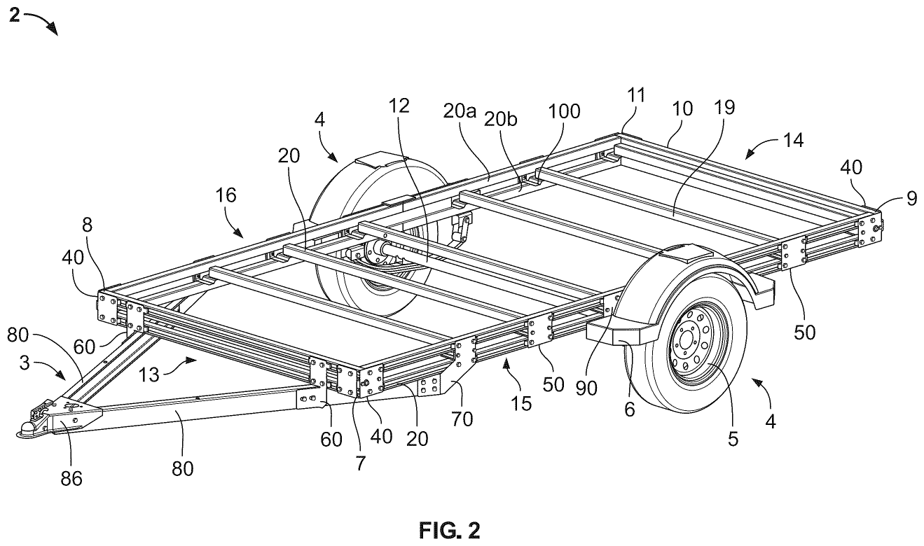

FIG. 1 shows components of a trailer kit 1 to assemble a modular base trailer 2. The trailer kit 1 includes a trailer tongue assembly 3, a plurality of corner brackets 40, a plurality of longitudinal brackets 50, a plurality of front end brackets 60, a plurality of tongue rail brackets 70, a plurality of axle brackets 90, a plurality of cross-member brackets 100, an axle and wheel assembly 4, a plurality of rails 20, at least one cross-member rail 19, and a trailer lighting system 110. The corner brackets 40 and the longitudinal brackets 50 may be referred to as frame brackets. The frame brackets couple at least two rails together. The front end brackets 60 and the tongue rail brackets 70 may be referred to as tongue brackets. The tongue brackets couple the tongue assembly 3 to the trailer frame 10 (as shown in FIG. 2). The modular base trailer 2 has a payload capacity of at least 2100 pounds. The trailer tongue assembly 3 is operable to hitch the modular base trailer 2 to a vehicle (not shown). The axle and wheel assembly 4 is operable to withstand various road conditions and facilitate payload capacity. The trailer lighting system 110 meets the safety and compliance requirements for all types of roads, such as city streets, interstates, paved roads, non-paved roads, etc. Also shown in FIG. 1 are x, y, and z-axes to assist in the description of the various movements and relationships of the components of the trailer kit 1. A key advantage of the trailer kit 1 is the modular base trailer 2 may be assembled by interconnecting any and each of the rails 20 and the cross-member rails 19 with any of the brackets, such as the corner brackets 40, the longitudinal brackets 50, the front end brackets 60, the tongue rail brackets 70, the axle brackets 90, and the cross-member brackets 100 without the use of welding or drilling.

FIG. 2 shows an assembled view of the modular base trailer 2. The rails 20 and the cross-member rails 19 are interconnected by using the corner brackets 40, the longitudinal brackets 50, and the cross-member brackets 100 to form a trailer frame 10. The trailer frame 10 may be assembled by interconnecting the rails 20 to form an upper rail frame 20a in the shape of a rectangle and a lower rail frame 20b in the shape of a rectangle. The rails 20 forming the upper rail frame 20a are generally parallel with the rails 20 forming the lower rail frame 20b when extending along the same side or opposite sides of the trailer frame 10. The rails 20 forming the upper rail frame 20a and the rails 20 forming the lower rail frame 20b are generally perpendicular with each other when the rails 20 of the upper rail frame 20a the lower rail frame 20b are extending in different directions. For example, the rails 20 are generally perpendicular when the rails 20 form a corner on the trailer frame 10. In other embodiments, the trailer frame 10 forms a square shape or other differently configured rectangular or quadrilateral structures.

Referring to FIG. 2, the upper rail frame 20a and the lower rail frame 20b include a front end 13, a rear end 14, a first side 15, and a second side 16. The upper rail frame 20a has substantially the same configuration and dimensions as the lower rail frame 20b. The upper rail frame 20a is vertically displaced from the lower rail frame 20b, such that the upper rail frame 20a is located above the lower rail frame 20b. The front end 13 of the trailer frame 10 extends between two corner brackets 40 located on opposite ends of the rails 20, a first rail end 7 and a second rail end 8. The rails 20 extending between the first rail end 7 and the second rail end 8 form the front end 13 of the upper rail frame 20a and the lower rail frame 20b. The first side 15 of the trailer frame 10 extends between two corner brackets 40 located on opposite ends of the rails 20, the first rail end 7 and a third rail end 9. The rails 20 extending between the first rail end 7 and the third rail end 9 form the first side 15 of the upper rail frame 20a and the lower rail frame 20b. The second side 16 of the trailer frame extends between two corner brackets 40 located on opposite ends of the rails 20, the second rail end 8 and a fourth rail end 11. The rails 20 extending between the second rail end 8 and the fourth rail end 11 form the second side 16 of the upper rail frame 20a and the lower rail frame 20b. The first side 15 is located on the opposite lateral side of the second side 16. The rear end 14 of the trailer frame 10 extends between two corner brackets 40 located on opposite ends of the rails 20, the third rail end 9 and the fourth rail end 11. The rails 20 extending between the third rail end 9 and the fourth rail end 11 form the rear end 14 of the upper rail frame 20a and the lower rail frame 20b. The rear end 14 is located on the opposite longitudinal side of the front end 13.

Referring to FIG. 2, the first rail end 7 includes the corner bracket 40 coupling to the rails 20 of the front end 13 of the upper rail frame 20a and the lower rail frame 20b to the rails 20 of the first side 15 of the upper rail frame 20a and the lower rail frame 20b. The corner bracket 40 couples the rails 20 of the front end 13 to the rails 20 of the first side 15 to form an approximate 90-degree angle. The second rail end 8 includes the corner bracket 40 coupling the rails 20 of the front end 13 of the upper rail frame 20a and the lower rail frame 20b to the rails 20 of the second side 16 of the upper rail frame 20a and the lower rail frame 20b. The corner bracket 40 couples the rails 20 of the front end 13 to the rails 20 of the second side 16 to form an approximate 90-degree angle. The third rail end 9 includes the corner bracket 40 coupling the rails 20 of the rear end 14 of the upper rail frame 20a and the lower rail frame 20b to the rails 20 of the first side 15 of the upper rail frame 20a and the lower rail frame 20b. The corner bracket 40 couples the rails 20 of the rear end 14 to the rails 20 of the first side 15 to form an approximate 90-degree angle. The fourth rail end 11 includes the corner bracket 40 coupling the rails 20 of the rear end 14 of the upper rail frame 20a and the lower rail frame 20b to the rails 20 of the second side 16 of the upper rail frame 20a and the lower rail frame 20b. The corner bracket 40 couples the rails 20 of the rear end 14 to the rails 20 of the second side 16 to form an approximate 90-degree angle.

Referring to FIG. 2, the cross-member rails 19 may be located between the first side 15 of the trailer frame 10 and the second side 16 of the trailer frame 10. In the preferred embodiment, the cross-member rails 19 may be coupled to portions of the first side 15 of the trailer frame and extend to the second side 16 of the trailer frame and be coupled to portions of the second side 16 of the trailer frame 10. More than one cross-member rail 19 may be located between the first side 15 and the second side 16. The cross-member rails 19 may be longitudinally spaced apart from each other along the first side 15 and the second side 16 of the trailer frame 10. The cross-member rails 19 extending between the first side 15 and the second side 16 of the trailer frame 10 are coupled to the cross-member brackets 100. The cross-member brackets 100 are located on the first side 15 of the trailer frame 10 and the second side 16 of the trailer frame. The cross-member brackets 100 are configured to couple the cross-member rails 19 to other brackets included to form the modular base trailer 2, such as the corner brackets 40, the longitudinal brackets 50, the tongue rail brackets 70, and the axle brackets 90. One of the advantages may be all of the rails 20 included to form the modular base trailer 2 have the same dimensions, to form portions of the trailer frame 10, such as the upper rail frame 20a, the lower rail frame 20b. In another embodiment, the rails 20 may have different dimensions, such as being comprised of different lengths. In the preferred embodiment, each of the plurality of rails 20 and the cross-member rails 19 are comprised of an elongated metal extrusion. In other embodiments, each of the rails 20 and cross-member rails 19 are comprised of any suitable material that provides strength and rigidity to the modular base trailer 2. The present disclosure contemplates that rails 20 and cross-member rails 19 are interchangeable with one another such that any of the rails 20 or cross-member rails 19 may form any side or cross-member rail of trailer frame 10.

Referring to FIG. 2, the axle and wheel assembly 4 includes a plurality of wheels 5, a plurality of fenders 6 and an axle 12. The axle bracket 90 couples the axle and wheel assembly 4 to the trailer frame 10. One of the axle brackets 90 is located on the first side 15 of the trailer frame 10 and another one of the axle brackets 90 is located on the second side 16 of the trailer frame 10. The axle brackets 90 located on the first side 15 and the second side 16 are mirror images of each other. One of the fenders 6 is located on the first side 15 of the trailer frame 10 and the other fender 6 is located on the second side 16 of the trailer frame 10. The axle bracket 90 couples one of the fenders 6, one of the wheels 5, and a portion of the axle 12 to the trailer frame 10. The other axle bracket 90 couples another fender 6, another wheel 5, and portion of the axle 12 to the trailer frame 10. The axle 12 extends between the axle and wheel assemblies 4 coupled to the trailer frame 10. In the preferred embodiment, there are two axle and wheel assemblies 4. In alternative embodiments, there may be more axle and wheel assemblies 4 to accommodate for larger sized and configured trailer frames 10, such as four axle and wheel assemblies 4.

Referring to FIG. 2, the trailer tongue assembly 3 is shown coupled to the trailer frame 10. The trailer tongue assembly 3 includes a hitch 86 and a plurality of tongue rails 80. One of the tongue rails 80 is coupled to the first side 15 of the trailer frame 10 and another tongue rail 80 is coupled to the second side 16 of the trailer frame 10. The tongue rails 80 coupled to the first side 15 and the second side 16 are mirror images of each other. The modular base trailer 2 may be formed by coupling multiple tongue rail brackets 70 and multiple front end brackets 60 to the trailer frame 10. One of the tongue rail brackets 70 is coupled to the first side 15 of the trailer frame 10 and another one of the tongue rail brackets 70 is coupled to the second side 16 of the trailer frame 10. The tongue rail brackets 70 coupled to the first side 15 and the second side 16 are mirror images of each other. One of the front end brackets 60 is located near the first rail end 7 and coupled to the front end 13 of the trailer frame 10. Another one of the front end brackets 60 is located near the second rail end 8 and coupled to the front end 13 of the trailer frame 10. One of the front end brackets 60 couples one of the tongue rails 80 to the front end 13 of the trailer frame 10 near the first rail end 7. Another one of the front end brackets 60 couples the other tongue rail 80 to the front end 13 of the trailer frame 10 near the second rail end 8. The tongue rail bracket 70 located on the first side 15 couples one of the tongue rails 80 to the first side 15 of the trailer frame 10 in between the first rail end 7 and the axle bracket 90 located on the first side 15. The tongue rail bracket 70 located on the second side 16 of the trailer frame couples the tongue rail 80 to the second side 16 of the trailer frame 10 in between the second rail end 8 and the axle bracket 90 located on the second side 16.

### Modular Rail

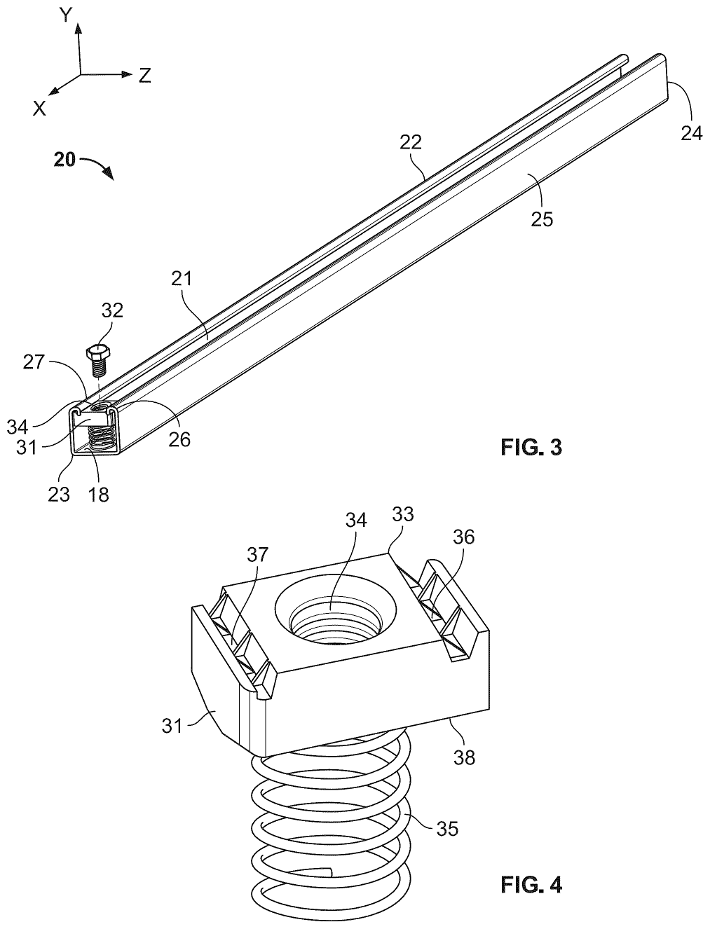

FIG. 3 illustrates one of the rails 20. Each rail 20 is comprised of an elongated body having a top wall 22, a first end 23, a second end 24, a bottom wall 25, and a rear wall 18. A channel 21 is formed by the top wall 22, the bottom wall 25, and the rear wall 18. The channel 21 extends between the first end 23 and the second end 24 of the rails 20. The bottom wall 25 includes a first inwardly-turned edge 26. The top wall 22 includes a second inwardly-turned edge 27. The channel 21 is sized to allow a nut 31 to be inserted into the channel 21.

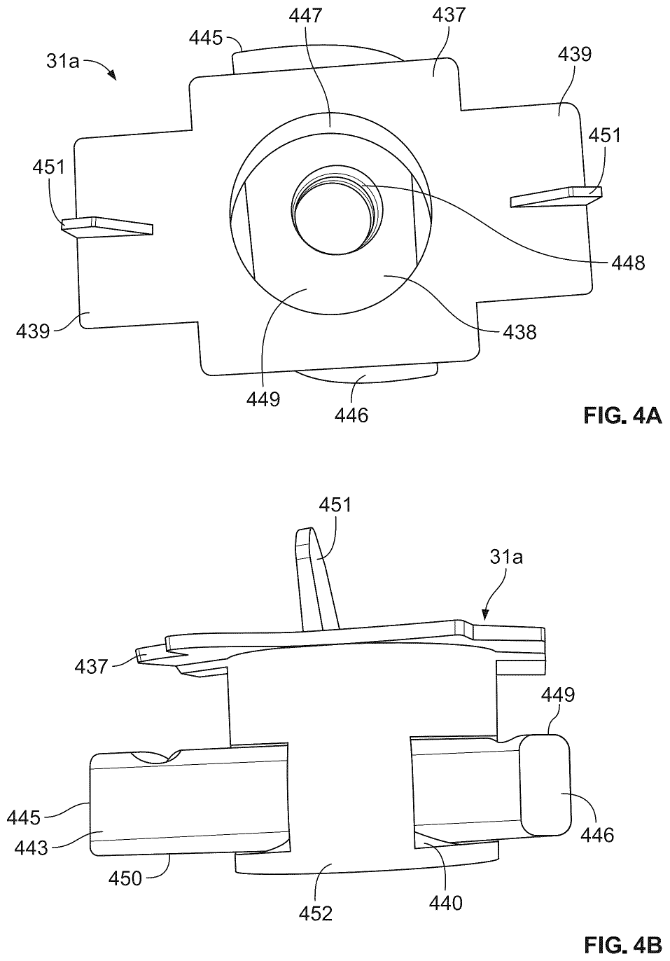

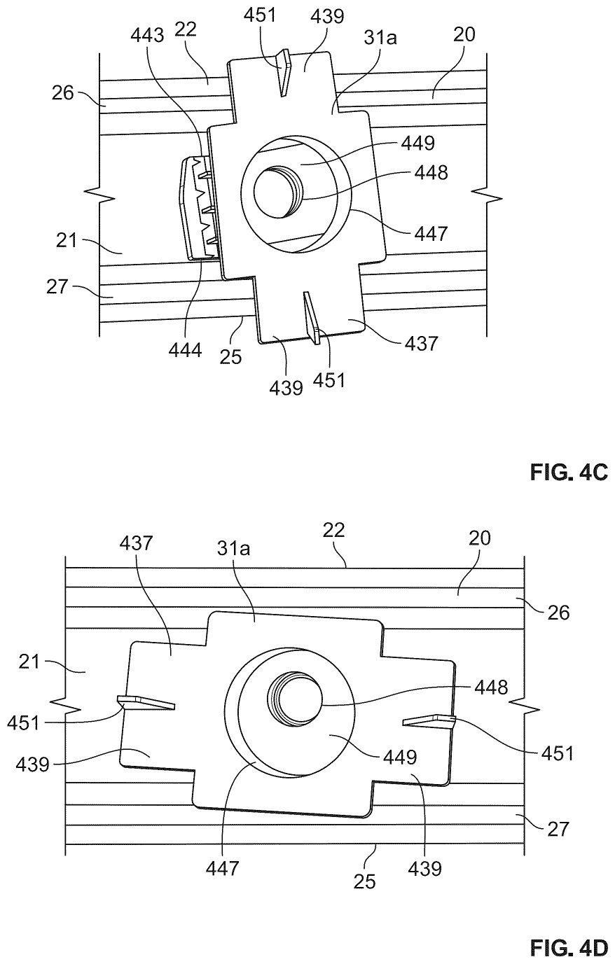

Referring to FIG. 3 and FIG. 4, each of the rails 20 is operable to slidably receive the nut 31 within the channel 21. An advantage of the rails 20 is the slidable placement of the nut 31 anywhere along the channel 21, by either inserting the nut 31 into the channel 21 near the first end 23 or the second end 24. The nut 31 may slightly be compressed to slide into either the first end 23 or the second end 24 to fit under the first inwardly-turned edge 26 and the second inwardly-turned edge 27. Once the nut 31 is slidably received in the channel 21, the nut 31 is biased into making contact with the first inwardly-turned edge 26 of the bottom wall 25 and the second-inwardly turned edge 27 of the top wall 22. In alternative embodiments, the nut 31 may be received in the channel 21 at any position between the first end 23 or the second end 24. In the preferred embodiment, the nut 31 comprises a rectangular head 33 shaped for insertion and rotation within the channel 21 and at any point along the length of the rails 20. The rectangular head 33 includes a threaded aperture 34 operable to receive the first bolt 32. The rectangular head 33 further includes a first groove 36 and a second groove 37 corresponding to the first inwardly-turned edge 26 and second inwardly-turned edge 27 of each of the rails 20. The first groove 36 is configured to receive the first inwardly turned edge 26 or the second inwardly turned edge 27. The second groove 37 is configured to receive the first inwardly turned edge 26 or the second inwardly turned edge 27. The nut 31 further comprises a biasing member 35 attached to a bottom portion 38 of the rectangular head 33, operable to bias the rectangular head 33 against the first inwardly-turned edge 26 and the second inwardly-turned edge 27 of the rails 20.

Referring to FIGS. 4A-4D, the nut 31a may also be non-compressible and include a holding member 437 and a threaded nut 438. The holding member 437 includes at least two support flanges 439, a cylindrical base 452, and a first opening 440 extending through the cylindrical base 452. The holding member 437 also includes a second opening 447 located between the two support flanges 439. The support flanges 439 include a gripping portion 451. The gripping portion 451 extends away from the support flanges 439 at a 90-degree angle approximately. The threaded nut 438 includes a first channel sidewall 443, a second channel sidewall 444, a first engagement sidewall 445, a second engagement sidewall 446, a top surface 449, a channel surface 450, and a threaded aperture 448. The threaded aperture 448 may be located between the first channel sidewall 443 and the second channel sidewall 444. The threaded aperture 448 extends from the top surface 449 to the channel surface 450 and configured to receive the first bolts 32. The first opening 440 is configured to receive the threaded nut 438. The first engagement sidewall 445 or the second engagement sidewall 445 of the threaded nut 438 may be inserted into the first opening 440 of the holding member 437. The threaded nut 438 is received in the holding member 437 such that the threaded aperture 448 may be substantially concentric with the second opening 447. The nut 31a may be inserted into the channels 21 of the rails 20 with the first channel sidewall 443 and the second channel sidewall 444 of the threaded nut 438 being parallel with the top wall 22 and the bottom wall 25 of the rails 20. The two support flanges 439 of the holding member 437 extend over the first inwardly turned edge 26 and the second inwardly turned edge 27. To retain the nut 31a in the channel 21, the user may grasp the gripping portions 451 extending from the support flanges 439 and rotate the nut 31a approximately 90 degrees in a clockwise or counter-clockwise direction or until the first engagement sidewall 445 and/or the second engagement sidewall 446 make contact with or are adjacent to the top wall 22 and/or the bottom wall 25 of the rails 20. The first channel sidewall 443 and the second channel sidewall 444 of the threaded nut 438 may be substantially perpendicular with the top wall 22 and the bottom wall 25 of the rails 20 when the nut 31a is retained within the channels 21 of the rails 20. The two support flanges 439 on the holding member 437 may be parallel with the top wall 22 and the bottom wall 25 of the rails 20 when the nut 31a is retained within the channels 21 of the rails 20. The holding member 437 may be composed of a flexible material, such as plastic or another flexible composite. The threaded nut 438 may be made of steel, such as stainless steel, carbon steel, alloy steel, or aluminum, titanium, copper, brass, nickel, or other various alloys.

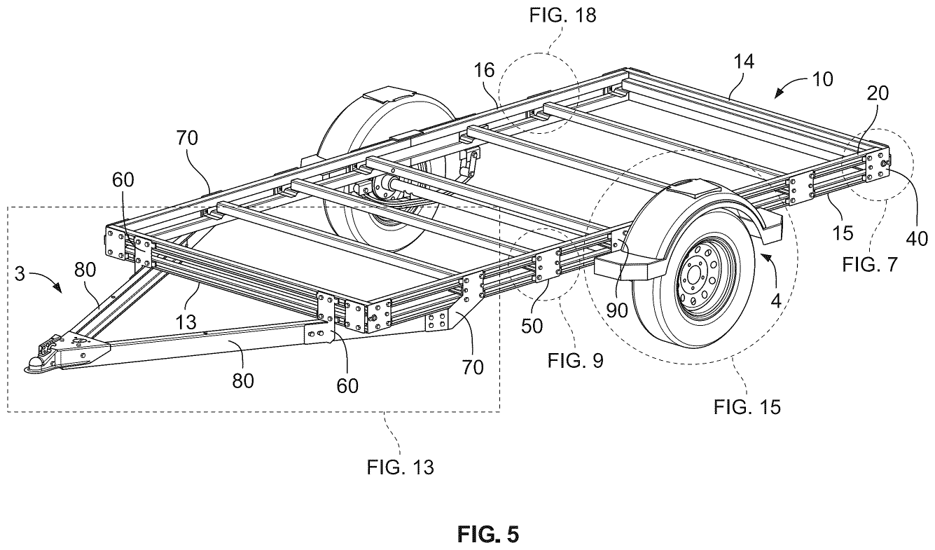

FIG. 5 illustrates an assembled modular base trailer 2 showing various brackets of the present invention.

### Corner Bracket

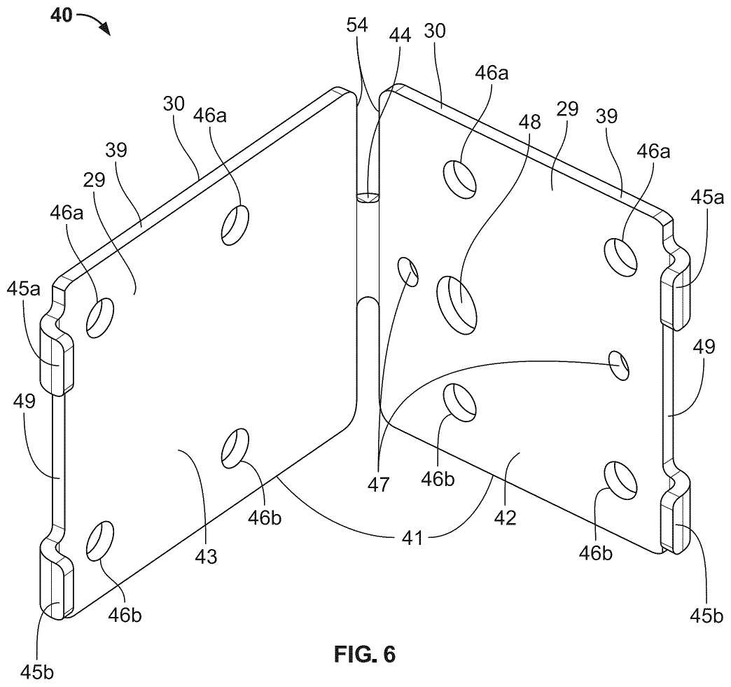

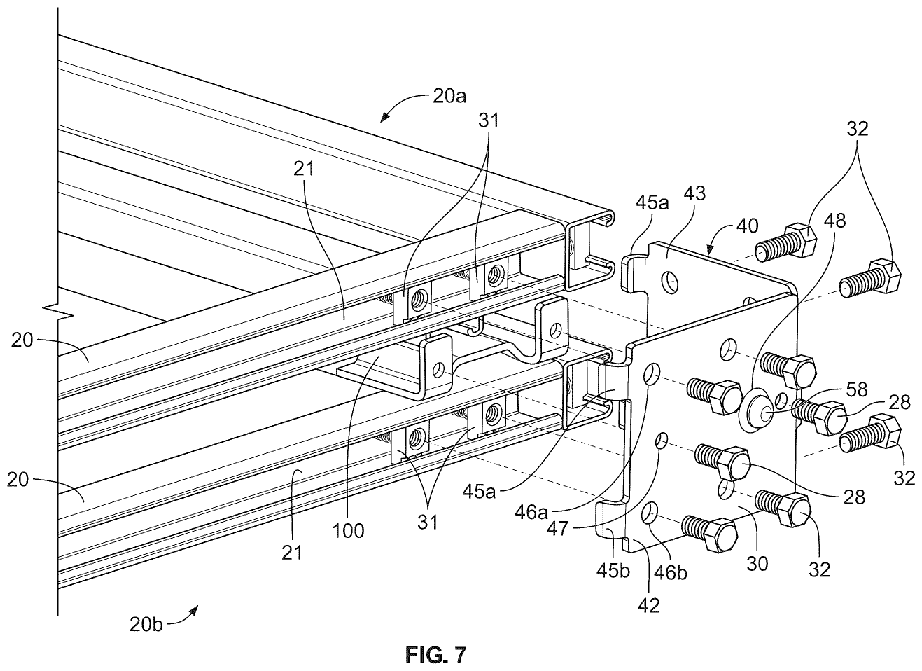

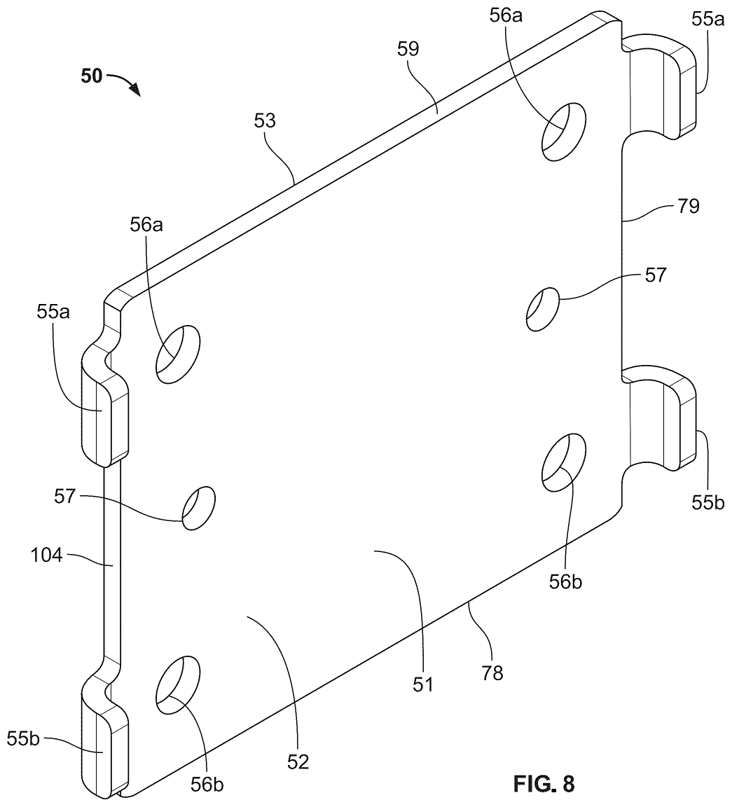

Referring to FIG. 6, the corner bracket 40 comprises a first planar plate 42 and a second planar plate 43 joined by an elbow 44 at an approximate 90-degree. In alternative embodiments, the elbow 44 may join the first planar plate 42 and the second planar plate 43 at an angle not being substantially 90-degrees. The first planar plate 42 and the second planar plate 43 include a trailer surface 29, a front corner surface 30, a corner top edge 39, a corner bottom edge 41, a tab edge 49, and an elbow edge 54. The trailer surface 29 when coupled to the modular base trailer 2 is adjacent to the trailer frame 10, see FIG. 2. The front corner surface 30 is on the opposite side of the first planar plate 42 from the trailer surface 29 (see FIG. 7). The corner top edge 39 extends between the trailer surface 29 and the front corner surface 30. The corner top edge 39 also extends in between the elbow edge 54 and the tab edge 49. The tab edge 49 extends from the corner top edge 39 downwards towards the corner bottom edge 41. The elbow edge 54 extends from the corner top edge 39 downwards towards the corner bottom edge 41. The corner bottom edge 41 extends between the elbow edge 54 and the tab edge 49. The first planar plate 42 and the second planar plate 43 comprise at least one upper tab 45a and at least one lower tab 45b. The upper tabs 45a and the lower tabs 45b extend from the tab edge 49 having a curved or arcuate shape. The first planar plate 42 includes one of the upper tabs 45a and one of the lower tabs 45b. The second planar plate 43 includes one of the upper tabs 45a and one of the lower tabs 45b. The upper tab 45a extends from the tab edge 49 near the corner top edge 39 of the first planar plate 42. The upper tab 45a extends from the tab edge 49 near the corner top edge 39 of the second planar plate 43. The lower tab 45b extends from the tab edge 49 near the corner bottom edge 41 of the first planar plate 42. The lower tab 45b extends from the tab edge 49 near the corner bottom edge 41 of the second planar plate 43. The first planar plate 42 also comprises at least one fastener receiver 46. More specifically, the first planar plate 42 includes at least one upper fastener receiver 46a and at least one lower fastener receiver 46b. The upper fastener receivers 46a of the first planar plate 42 are located near the corner top edge 39. The lower fastener receivers 46b of the first planar plate 42 are located near the corner bottom edge 41. The second planar plate 43 also comprises at least one fastener receiver 46. More specifically, the second planar plate 43 includes at least one upper fastener receiver 46a and at least one lower fastener receiver 46b. The upper fastener receivers 46a of the second planar plate 43 are located near the corner top edge 39. The lower fastener receivers 46b of the second planar plate 43 are located near the corner bottom edge 41. The first planar plate 42 also includes at least one secondary fastener receiver 47 and a light aperture 48. The secondary fastener receivers 47 are located between the upper fastener receivers 46a and the lower fastener receivers 46b. The secondary fastener receivers 47 may be slightly smaller in size than the upper fastener receivers 46a and the lower fastener receivers 46b. In alternative embodiments, the secondary fastener receivers 47 may be substantially the same size or larger than the upper fastener receivers 46a and the lower fastener receivers 46b. The first planar plate 42 may include one of the secondary fastener receivers 47 located near the elbow edge 54 and another secondary fastener receiver 47 located near the tab edge 49. In alternative embodiments, secondary fastener receivers 47 may be formed in the second planar plate 43 of the corner bracket 40. The light aperture 48 is also located between the upper fastener receivers 46a and the lower fastener receivers 46b. The light aperture 48 may also be located between the secondary fastener receivers 47. More specifically, the light aperture 48 may be located more near the secondary fastener 47 located near the elbow edge 54 than the secondary fastener receiver 47 located near the tab edge 49. In alternative embodiments, there may be a different number, dimension, and configuration of upper fastener receivers 46a, lower fastener receivers 46b, secondary fastener receivers 47, and light apertures 48.

Referring to FIG. 7, the corner bracket 40 is operable to join rails 20 of the upper rail frame 20a to the rails 20 of the lower rail frame 20b at an approximate 90-degree angle or at another angle substantially close to a 90-degree angle. In the illustrated embodiment, the upper tabs 45a and the lower tabs 45b of the corner bracket 40 may be inserted into the channel 21 of the rails 20. More specifically, the upper tab 45a of the first planar plate 42 and the upper tab 45a of the second planar plate 43 may be inserted into the channel 21 of the rails 20 forming a portion of the upper rail frame 20a. The lower tab 45b of the first planar plate 42 and the lower tab 45b of the second planar plate 43 may be inserted into the channel 21 of the rails 20 forming a portion of the lower rail frame 20b. The corner bracket 40 is coupled to the trailer frame 10 by inserting the first bolts 32 through the upper fastener receivers 46a and the lower fastener receivers 46b and into corresponding nuts 31 located in the channel 21 of the rails 20 forming portions of the upper rail frame 20a and the lower rail frame 20b. In the preferred embodiment, two first bolts 32 are inserted through the upper fastener receivers 46a located on the first planar plate 42 and two first bolts 32 are inserted through the lower fastener receivers 46b located on the first planar plate 42 to couple the corner bracket 40 to the trailer frame 10. In the preferred embodiment, two first bolts 32 are inserted through the upper fastener receivers 46a located on the second planar plate 43 and two first bolts 32 are inserted through the lower fastener receivers 46b located on the second planar plate 43 to couple the corner bracket 40 to the trailer frame 10. In alternative embodiments, a different number of first bolts 32 may be used to couple the corner bracket 40 to the trailer frame 10. The corner bracket 40 is also coupled to the trailer frame 10 by inserting a second bolt 28 through each of the secondary fastener receivers 47 and into corresponding apertures located in the cross-member brackets 100 located on the trailer frame 10 in between the upper rail frame 20a and the lower rail frame 20b. In the preferred embodiment, two second bolts 28 are inserted into corresponding secondary fastener receivers 47. In alternative embodiments, more than two or less than two second bolts 28 may be used to couple the corner bracket 40 to the trailer frame 10. A corner light 58 may be coupled to the corner bracket 40. The corner light 58 may be inserted into the light aperture 48 or mounted to the light aperture 48. It is to be understood that the present disclosure contemplates that the corner bracket 40 rigidly secures any corner formed by the upper rail frame 20a and/or the lower rail frame 20b of the trailer frame 10.

### Longitudinal Bracket

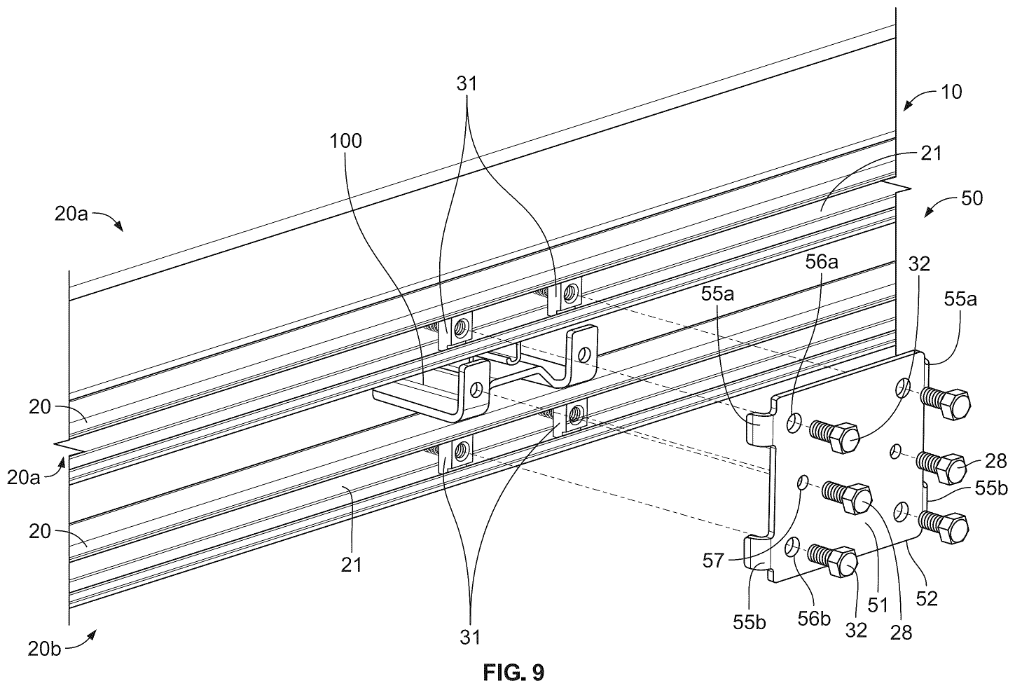

FIG. 8 illustrates the longitudinal bracket 50. The longitudinal bracket 50 comprises a planar plate 51. The planar plate 51 includes a longitudinal trailer surface 52, a front longitudinal surface 53, a longitudinal top edge 59, a longitudinal bottom edge 78, a first tab edge 79, and a second tab edge 104. The longitudinal trailer surface 52 when coupled to the modular base trailer 2 is adjacent to the trailer frame 10, see FIG. 2. The front longitudinal surface 53 is on the opposite side of the planar plate 51 from the longitudinal trailer surface 52 (see FIG. 9). The longitudinal top edge 59 extends between the longitudinal trailer surface 52 and the front longitudinal surface 53. The longitudinal top edge 59 also extends in between the first tab edge 79 and the second tab edge 104. The first tab edge 79 extends from the longitudinal top edge 59 downwards towards the longitudinal bottom edge 78. The second tab edge 104 extends from the longitudinal top edge 59 downwards towards the longitudinal bottom edge 78. The first tab edge 79 and the second tab edge 104 are located on opposite sides of the longitudinal top edge 59 and the longitudinal bottom edge 78. The longitudinal bottom edge 78 extends between the first tab edge 79 and the second tab edge 104. The longitudinal bracket 50 also comprises at least one upper tab 55a and at least one lower tab 55b. The upper tabs 55a and the lower tabs 55b extend from the first tab edge 79 and the second tab edge 104 having a curved or arcuate shape. One of the upper tabs 55a extends from the first tab edge 79 near the longitudinal top edge 59 and the other upper tab 55a extends from the second tab edge 104 near the longitudinal top edge 59. One of the lower tabs 55b extends from the first tab edge 79 near the longitudinal bottom edge 78 and the other lower tab 55b extends from the second tab edge 104 near the longitudinal bottom edge 78.

Referring to FIG. 8, the longitudinal bracket 50 also comprises at least one upper fastener receiver 56a and at least one lower fastener receiver 56b located on the planar plate 51. The upper fastener receivers 56a are located near the longitudinal top edge 59. The lower fastener receivers 56b are located near the longitudinal bottom edge 78. The longitudinal bracket 50 also includes at least one secondary fastener receiver 57 located on the planar plate 51. The secondary fastener receivers 57 are located between the upper fastener receivers 56a and the lower fastener receivers 56b. The secondary fastener receivers 57 may be slightly smaller in size than the upper fastener receivers 56a and the lower fastener receivers 56b. In alternative embodiments, the secondary fastener receivers 57 may be substantially the same size or larger than the upper fastener receivers 56a and the lower fastener receivers 56b. In the preferred embodiment, one of the secondary fastener receivers 57 is located near the first tab edge 79 and another one of the secondary fastener receivers 57 is located near the second tab edge 104.

Referring to FIG. 9, the longitudinal bracket 50 is operable to couple rails 20 forming portions of the upper rail frame 20a to the rails 20 forming portions of the lower rail frame 20b. In the preferred embodiment, the upper tabs 55a and the lower tabs 55b of the longitudinal bracket 50 may be inserted into the channel 21 of the rails 20. More specifically, the upper tabs 55a of the longitudinal bracket 50 may be inserted into the channel 21 of the rails 20 forming a portion of the upper rail frame 20a. The lower tabs 55b of the longitudinal bracket 50 may be inserted into the channel 21 of the rails 20 forming a portion of the lower rail frame 20b. The longitudinal bracket 50 is coupled to the trailer frame 10 by inserting the first bolts 32 through the upper fastener receivers 56a and the lower fastener receivers 56b and into the corresponding nuts 31 located in the channel 21 of the rails 20. In the preferred embodiment, two first bolts 32 are inserted through each of the upper fastener receivers 56a located on the planar plate 51 to couple the longitudinal bracket 50 to the trailer frame 10. Additionally, in the preferred embodiment, two first bolts 32 are inserted through each of the lower fastener receivers 56b located on the planar plate 51 to couple the longitudinal bracket 50 to the trailer frame 10. In alternative embodiments, a different number of first bolts 32 may be used to couple the longitudinal bracket 50 to the trailer frame 10. The longitudinal bracket 50 is also coupled to the trailer frame 10 by inserting the second bolt 28 through each of the secondary fastener receivers 57 and into the corresponding apertures located in the cross-member brackets 100 located on the trailer frame 10 in between the upper rail frame 20a and the lower rail frame 20b. In the preferred embodiment, two second bolts 28 are inserted into corresponding secondary fastener receivers 57. In alternative embodiments, more than two or less than two second bolts 28 may be used to couple the longitudinal bracket 50 to the trailer frame 10. An advantage of the longitudinal bracket 50 is that it is selectively mounted at a location on the trailer frame 10 that may need reinforcement or selectively mounted to make space for mountable accessories.

### Front End Bracket

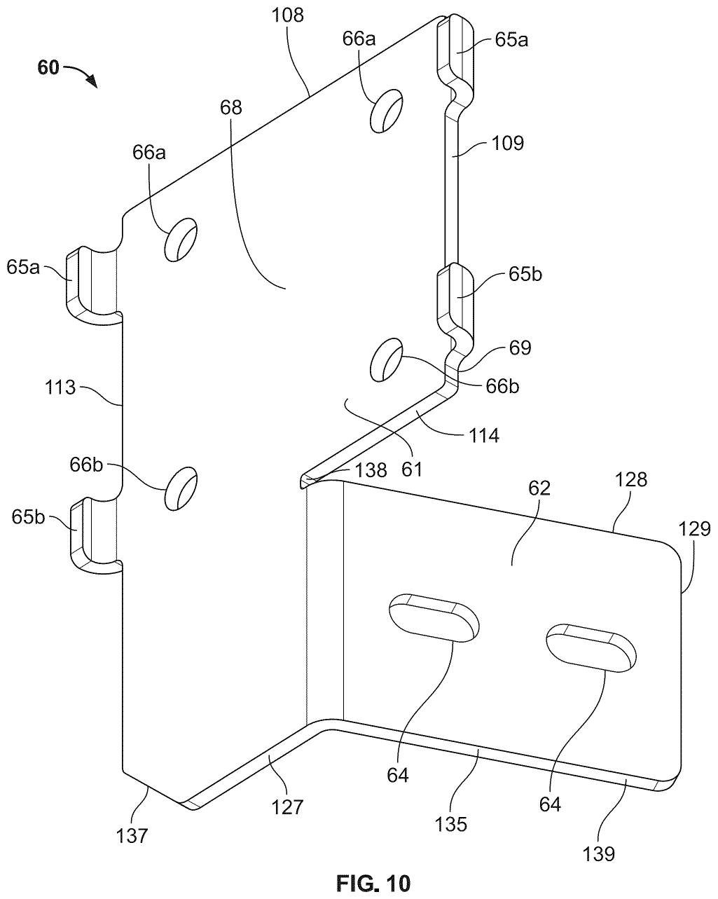

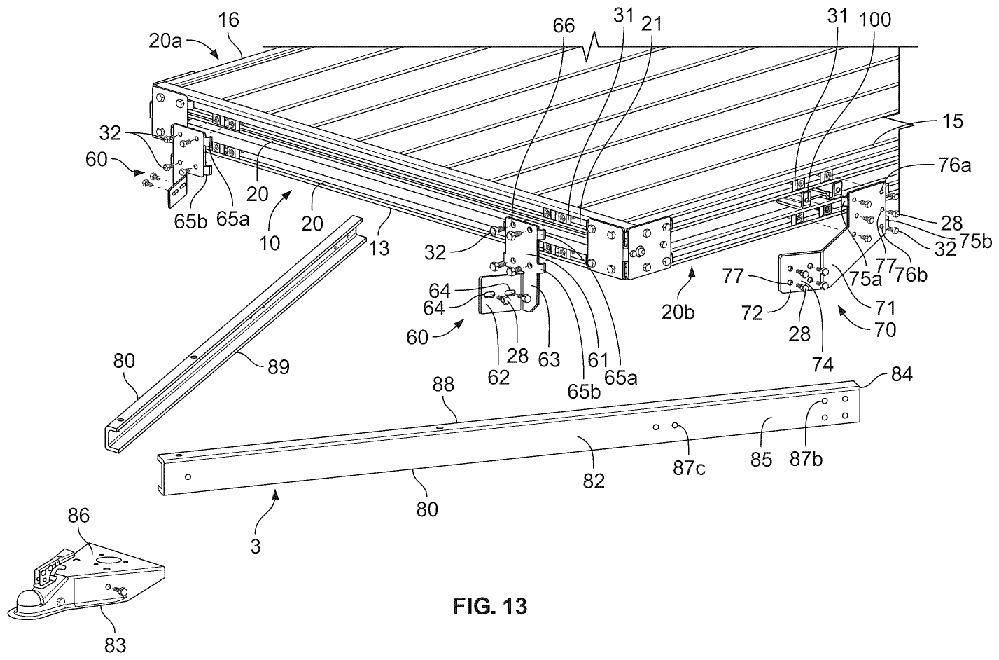

FIG. 10 shows an example of the front end bracket 60 to be coupled to the first side 15 of the trailer frame 10 (see FIG. 2). The following description describes the front end bracket located near the first side 15 of the trailer frame 10. It is understood the front end bracket 60 coupled to the second side 16 of the trailer frame 10 is a mirror image of the front end bracket 60 located near the first side 15. The front end bracket 60 includes a front end planar plate 61 and a winged plate 62. The front end bracket 60 includes a front end trailer surface 68 and a front end front surface 69. The front end planar plate 61 includes a front end top edge 108, a front end short edge 109, a front end elongated edge 113, a front end bottom edge 114, and a front end tongue rail edge 127. The winged plate 62 includes a winged plate top edge 128, a winged plate side edge 129, and a winged plate bottom edge 139. The front end trailer surface 68 when coupled to the modular base trailer 2 is adjacent to the trailer frame 10 and the trailer tongue assembly 3, see FIG. 2. The front end front end surface 69 is on the opposite side from the front end trailer surface 68 of the front end bracket 60, see FIG. 13. The front end top edge 108 extends between the front end trailer surface 68 and the front end front surface 69. The front end top edge 108 also extends in between the front end elongated edge 113 and the front end short edge 109. The front end elongated edge 113 extends from the front end top edge 108 downwards towards the front end tongue rail edge 127. The front end short edge 109 extends from the front end top edge 108 downwards towards the front end bottom edge 114. The front end elongated edge 113 and the front end short edge 109 are located on opposite sides of the front end top edge 108. The front end bracket 60 further includes a slanted portion 137. The slanted portion 137 extends downward from the front end elongated edge 113 at an angle towards the front end tongue rail edge 127. The front end tongue rail edge 127 extends towards the winged plate bottom edge 139. The front end tongue rail edge 127 is parallel with the front end top edge 108. The winged plate bottom edge 139 extends away from the front end tongue rail edge 127 at an angle from the front end front surface 69, such that the winged plate bottom edge 139 is closer to the front end elongated edge 113 than the front end short edge 109. The winged plate side edge 129 extends upward from the winged plate bottom edge 139 towards the winged plate top edge 128. The winged plate top edge 128 extends from the winged plate side edge 129 towards the front end planar plate 61. The wing plate top edge 128 and the winged plate bottom edge 139 are parallel with each other. The winged plate top edge 128 extends away from the winged plate side edge 129 and towards a middle edge 138. The middle edge 138 is located between the front end bottom edge 114 and the winged plate top edge 128. The front end bottom edge 114 and the winged plate top edge 128 are vertically spaced apart approximately the same distance as the length of the middle edge 138. The front end bracket 60 comprises at least one upper tab 65a and at least one lower tab 65b. The upper tabs 65a and the lower tabs 65b extend from the front end elongated edge 113 and the front end short edge 109 having a curved or arcuate shape. One of the upper tabs 65a extends from the front end elongated edge 113 near the front end top edge 108 and the other upper tab 65a extends from the front end short edge 109 near the front end top edge 108. One of the lower tabs 65b extends from the front end elongated edge 113 between the slanted portion 137 and the upper tab 65a. The other lower tab 65b extends from the front end short edge 109 near the front end bottom edge 114.

Referring to FIG. 10, the front end bracket 60 also includes at least one upper fastener receiver 66a and at least one lower fastener receiver 66b located on the front end planar plate 61. The upper fastener receivers 66a are located near the front end top edge 108. The lower fastener receivers 66b are located near the front end bottom edge 114. The front end bracket 60 also includes at least one slot 64 formed in the winged plate 62 in between the winged plate top edge 128 and the winged plate bottom edge 139. One of the slots 64 is located near the winged plate side edge 129 and another slot 64 may be located near the front end planar plate 61. The slots 64 may be oval in shape. In the preferred embodiment, there are two oval shaped slots 64 and the slots 64 may be shaped differently from the upper fastener receivers 66a and the lower fastener receivers 66b. In the alternative embodiments, the slots 64 may be different shapes or there may be more than two slots 64 or less than two slots 64. Additionally, in alternative embodiments, the upper fastener receivers 66a and/or the lower fastener receivers 66b may be the same configuration as the slots 64

### Tongue Rail Bracket

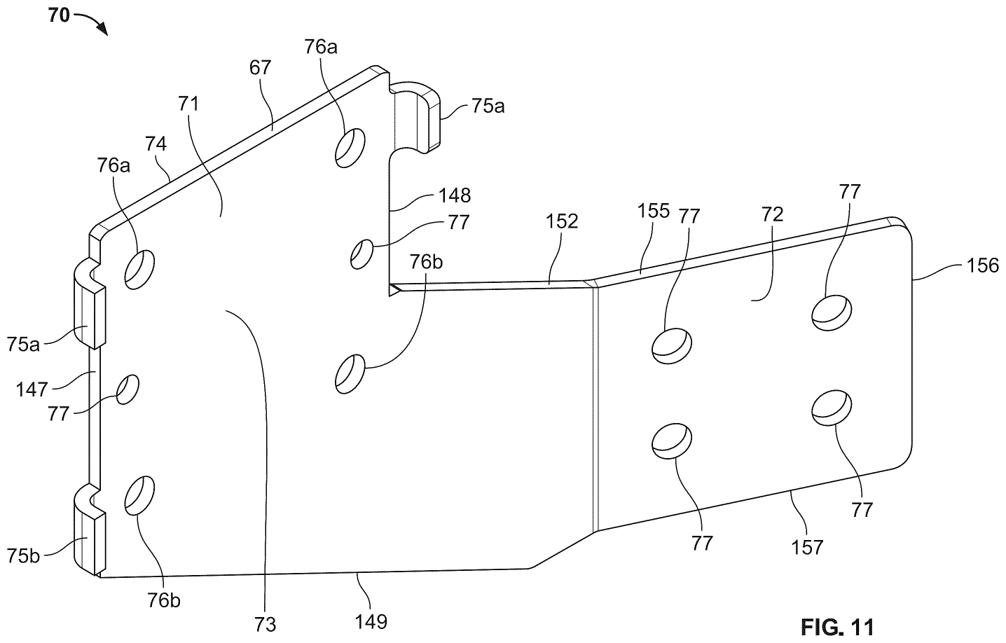

Referring to FIG. 11, an example of the tongue rail bracket 70 is shown. The following description describes the tongue rail bracket 70 that may be located on the first side 15 of the trailer frame 10. It is understood the tongue rail bracket 70 coupled to the second side 16 of the trailer frame is a mirror image of the tongue rail bracket 70 coupled to the first side 15. The tongue rail bracket 70 includes a trailer planar plate 71 and a tongue rail planar plate 72. The tongue rail bracket 70 includes a tongue rail trailer surface 73 and a tongue rail front surface 74. The trailer planar plate 71 includes a trailer rail first top edge 67, a trailer rail elongated edge 147, a trailer rail short edge 148, a trailer rail bottom edge 149, and a trailer rail second top edge 152. The tongue rail planar plate 72 includes a tongue rail top edge 155, a tongue rail side edge 156, and a tongue rail bottom edge 157. The tongue rail trailer surface 73 when coupled to the modular base trailer 2 is adjacent to the trailer frame 10 and the trailer tongue assembly 3, see FIG. 2. The tongue rail front surface 74 is on the opposite side of the tongue rail planar plate 72 and the trailer planar plate 71 from the tongue rail trailer surface 73. The trailer rail first top edge 67 extends between the tongue rail front surface 74 and the tongue rail trailer surface 73. The trailer rail first top edge 67 also extends between the trailer rail elongated edge 147 and the trailer rail short edge 148. The trailer rail elongated edge 147 extends from the trail rail first top edge 67 downwards towards the trailer rail bottom edge 149. The trailer rail short edge 148 extends from the trailer rail first top edge 67 downwards towards the trailer rail second top edge 152. The trailer rail elongated edge 147 and the trailer rail short edge 148 are located on opposite sides of the trail rail first top edge 67. The trailer rail second top edge 152 extends from the trailer rail short edge 148 at a downward angle. The trailer rail first top edge 67 and the trailer rail second top edge 152 may not be parallel with each other. In alternative embodiments, the trailer rail first top edge 67 and the trailer rail second top edge 152 may be parallel with each other. The tongue trailer planar plate 72 extends from the trailer planar plate 71 at a non-zero angle. More specifically, the tongue trailer planar plate 72 extends at angle towards the trailer frame 10 from the trailer planar plate 71. The tongue rail top edge 155 extends from the trailer rail second top edge 152 at a non-zero angle. Similarly, the tongue rail bottom edge 157 extends from the trailer rail bottom edge 149 at a non-zero angle. The tongue rail top edge 155 and the tongue rail bottom edge 157 may be substantially parallel with each other. The tongue rail side edge 156 extends between the tongue rail top edge 155 and the tongue rail bottom edge 157. The tongue rail bracket 70 comprises at least one upper tab 75a and at least one lower tab 75b. The upper tabs 75a and the lower tabs 75b extend from the trailer rail elongated edge 147 and the trailer rail short edge 148 having a curved or arcuate shape. One of the upper tabs 75a extends from the trailer rail elongated edge 147 near the trailer rail first top edge 67 and another upper tab 75a extends from the trailer rail short edge 148 near the trailer rail first top edge 67. The lower tab 75b extends from the trailer rail elongated edge 147 near the trailer rail bottom edge 149.

Referring to FIG. 11, the tongue rail bracket 70 also includes at least one upper fastener receiver 76a and at least one lower fastener receiver 76b located on the trailer planar plate 71. The upper fastener receivers 76a are located near the trailer rail first top edge 67. The lower fastener receivers 76b are located near the trailer rail bottom edge 149. The tongue rail bracket 70 also includes at least one secondary fastener receiver 77 located on the trailer planar plate 71 and the tongue trailer planar plate 72. The secondary fastener receivers 77 are located between the upper fastener receivers 76a and the lower fastener receivers 76b on the trailer planar plate 71. The tongue trailer planar plate 72 includes an upper set of secondary fastener receivers 77 and a lower set of secondary fastener receivers 77. The upper set of secondary fastener receivers 77 are located near the tongue rail top edge 155. The lower set of secondary fastener receivers 77 are located near the tongue rail bottom edge 157. The secondary fastener receivers 77 are generally circular in shape and may be slightly smaller in size than the upper fastener receivers 76a and the lower fastener receivers 76b. In alternative embodiments, the secondary fastener receivers 77 may be substantially the same size or larger than the upper fastener receivers 76a and the lower fastener receivers 76b. In the preferred embodiment, one of the secondary fastener receivers 77 located on the trailer planar plate 71 is near the trailer rail elongated edge 147 and another secondary fastener receiver 77 is near the trailer rail short edge 148. In the preferred embodiment, four secondary fastener receivers 77 are located on the tongue trailer planar plate 72, with two of the secondary fastener receivers located near the tongue rail top edge 155 and two secondary fastener receivers located near the tongue rail bottom edge 157.

### Trailer Tongue Assembly

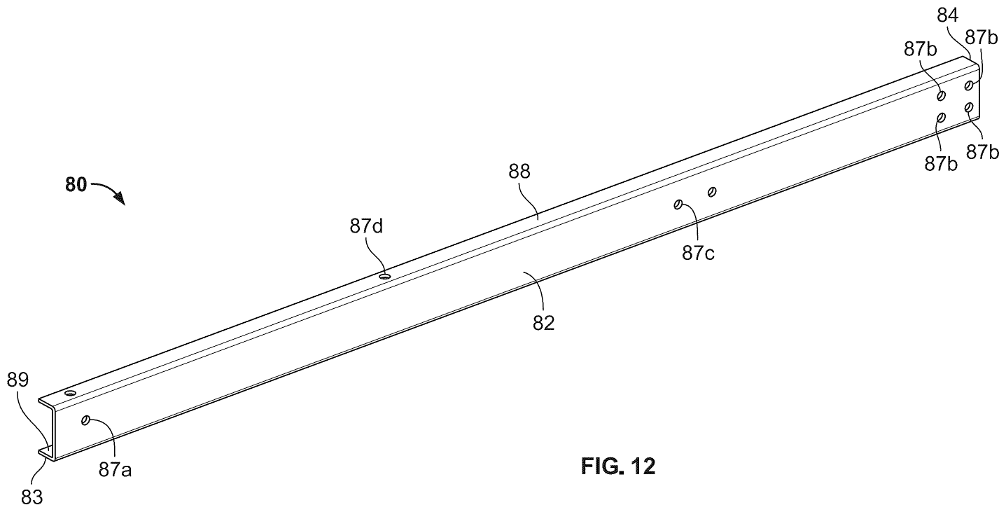

Referring to FIG. 12, the tongue rail 80 is shown. The tongue rail 80 may have a c-shape formed by a first sidewall 88, a second sidewall 89, and an attachment sidewall 82. The first sidewall 88 and the second sidewall 89 extend from opposite sides of the attachment sidewall 82. The first sidewall 88 extends from the attachment sidewall 82 forming an approximate 90-degree angle. The second sidewall 89 extends from the opposite side of the attachment sidewall 82 from the first sidewall 88 forming an approximate 90-degree angle. The first sidewall 88 and the second sidewall 89 are spaced apart from each other approximately the same length of the attachment sidewall 82. The first sidewall 88 and the second sidewall 89 are substantially parallel with each other. The tongue rail 80 also includes a hitch end 83 and a trailer end 84 located on the opposite end from the hitch end 83. The first sidewall 88 and the second sidewall 89 extend between the hitch end 83 and the trailer end 84. The tongue rail 80 further comprises at least one secondary fastener receiver 87 formed in the attachment sidewall 82 and the first sidewall 88 of the tongue rail 80. More specifically, one secondary fastener receiver 87a is located near the hitch end 83, four secondary fastener receivers 87b are located near the trailer end 84, and at least one secondary fastener receiver 87c is located in between the secondary fastener receivers 87a and the secondary fastener receivers 87b along the attachment sidewall 82. At least one secondary fastener receiver 87d may be located in the first sidewall 88 between the hitch end 83 and the trailer end 84. The secondary fastener receiver 87a is located on the attachment sidewall 82 between the first sidewall 88 and the second sidewall 89. The secondary fastener receivers 87c are located in between the secondary fastener receiver 87a and the secondary fastener receivers 87b. The secondary fastener receivers 87c may be located in the attachment sidewall 82 in between the first sidewall 88 and the second sidewall 89. The secondary fastener receivers 87b include two secondary fastener receivers 87b located near the first sidewall 88 and two secondary fastener receivers 87b located near the second sidewall 89. The secondary fastener receivers 87b near the first sidewall 88 are located the same distance from the first sidewall 88. The secondary fastener receivers 87b located near the second sidewall 89 are located the same distance from the second sidewall 89. The secondary fastener receivers 87b located near the first sidewall 88 are located above the corresponding secondary fastener receivers 87b located near the second sidewall 89. The secondary fastener receivers 87 are circular in shape. In alternative embodiments, there may be a different number of secondary fastener receivers 87 located along the attachment sidewall 82 and be a non-circular shape.

Referring to FIG. 13, the two front end brackets 60 couple to the trailer frame 10 are mirror images of each other. Each one of the front end brackets 60 is operable to couple one of the tongue rails 80 to the trailer frame 10. One of the front end brackets 60 is near the first side 15 of the trailer frame 10 and the mirror image second front end bracket 60 is near the second side 16 of the trailer frame 10. In the preferred embodiment, the upper tabs 65a and the lower tabs 65b of the front end brackets 60 may be inserted into the channel 21 of the rails 20. More specifically, the upper tabs 65a of the front end bracket 60 may be inserted into the channel 21 of the rails 20 forming a portion of the front end 13 of the upper rail frame 20a. The lower tabs 65b of the front end bracket 60 may be inserted into the channel 21 of the rails 20 forming a portion of the front end 13 of the lower rail frame 20b. The front end bracket 60 may be coupled to the trailer frame 10 by inserting the first bolts 32 through the upper fastener receivers 66a and the lower fastener receivers 66b and into the corresponding nuts 31 located in the channel 21 of the rails 20 forming portions of the front end 13 of the upper rail frame 20a and the lower rail frame 20b. In the preferred embodiment, four first bolts 32 may be used to couple the front end bracket 60 to the trailer frame 10. More specifically, first bolts 32 may be inserted through each of the upper fastener receivers 66a and the lower fastener receivers 66b located on the front end planar plate 61 to couple the front end bracket 60 to the trailer frame 10. In alternative embodiments, a different number of first bolts 32 may be used to couple the front end bracket 60 to the trailer frame 10. The front end bracket 60 is also coupled to the trailer frame 10 by inserting the second bolts 28 through each of the corresponding slots 64 located on the winged plate 62 and through the corresponding secondary fastener receivers 87c located in the attachment sidewall 82 of the tongue rail 80. In the preferred embodiment, two second bolts 28 are inserted into corresponding slots 64 and the secondary fastener receivers 87c and secured by the nut 252 (not shown) to the second bolts 28 adjacent to the attachment sidewall 82. In alternative embodiments, more than two or less than two second bolts 28 may be used to couple the front end bracket 60 to the trailer frame 10. In the preferred embodiment, the wing plate 62 extends from the front end planar plate 61 at substantially the same angle as the tongue rail 80. In alternative embodiments, the wing plate 62 extends from the front end planar plate 61 at different angles as the tongue rail 80.

Referring to FIG. 13, the two tongue rail brackets 70 couple to the trailer frame 10 are mirror images of each other. Each one of the tongue rail brackets 70 is operable to couple one of the tongue rails 80 to the trailer frame 10. One of the tongue rail brackets 70 may be near the first side 15 of the trailer frame 10 and the mirror image second tongue rail bracket 70 may be near the second side 16 of the trailer frame 10. In the preferred embodiment, the upper tabs 75a and the lower tabs 75b of the tongue rail brackets may be inserted into the channel 21 of the rails 20. More specifically, the upper tabs 75a of the tongue rail brackets 70 may be inserted into the channel 21 of the rails 20 forming a portion of the first side 15 of the upper rail frame 20a. The lower tabs 75b of the tongue rail bracket 70 may be inserted into the channel 21 of the rails 20 forming a portion of the first side 15 of the lower rail frame 20b. The tongue rail bracket 70 may be coupled to the trailer frame 10 by inserting the first bolts 32 through the upper fastener receivers 76a and the lower fastener receivers 76b and into the corresponding nuts 31 located in the channel 21 of the rails 20 forming portions of the first side 15 of the upper rail frame 20a and the lower rail frame 20b. In the preferred embodiment, four first bolts 32 may be used to couple the tongue rail bracket 70 to the trailer frame 10. More specifically, first bolts 32 may be inserted through each of the upper fastener receivers 76a and the lower fastener receivers 76b located on the trailer planar plate 71 to couple the tongue rail bracket 70 to the trailer frame 10. In alternative embodiments, a different number of first bolts 32 may be used to couple the tongue rail bracket 70 to the trailer frame 10. The tongue rail bracket 70 is also coupled to the trailer frame 10 by inserting the second bolts 28 through each of the secondary fastener receivers 77 and into the corresponding apertures located in the cross-member brackets 100 located on the trailer frame 10 in between the upper rail frame 20a and the lower rail frame 20b. In the preferred embodiment, two second bolts 28 are inserted into corresponding secondary fastener receivers 77. In alternative embodiments, more than two or less than two second bolts 28 may be used to couple the tongue rail bracket 70 to the trailer frame 10. The tongue rail bracket 70 may be coupled to the tongue rails 80 by inserting the second bolts 28 through each of the corresponding secondary fastener receivers 87b located on the attachment sidewall 82 of the tongue rail 80. In the preferred embodiment, four second bolts 28 are inserted into secondary fastener receivers 77 and through the secondary fastener receivers 87b and secured by the nut 252 (not shown) to the second bolts 28 adjacent to the attachment sidewall 82. In alternative embodiments, various numbers of second bolts 28 may be used to couple the tongue rail brackets 70 to the trailer frame 10. In the preferred embodiment, the tongue rail planar plate 72 extends from the trailer planar plate 71 at substantially the same angle as the tongue rail 80. In alternative embodiments, the tongue rail planar plate 72 extends from the trailer planar plate 71 at different angles as the tongue rail 80.

### Axle Bracket

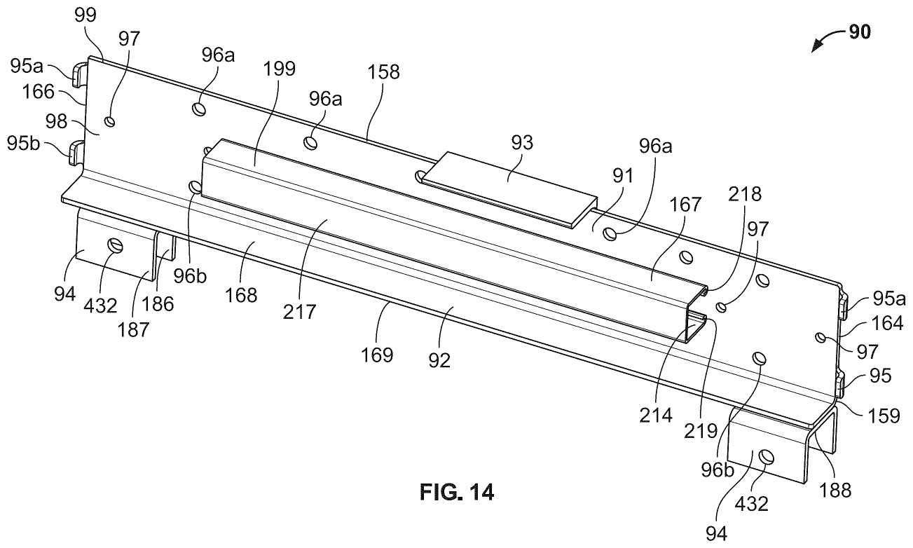

FIG. 14 shows an example of the axle bracket 90 to be coupled to the first side 15 of the trailer frame 10. The following description describes the axle bracket 90 coupled to the first side 15 of the trailer frame 10. It is understood the axle bracket 90 coupled to the second side 16 of the trailer frame 10 is a mirror image of the axle bracket 90 coupled to the first side 15. The axle bracket 90 includes an axle plate 91, a shelf 92, a joint cap 93, a set of hanger brackets 94, and an axle rail 167. The axle plate 91 is rectangular in shape and includes an axle trailer surface 98 and an axle tire surface 99 located on the opposite side of the axle bracket 90 from the axle trailer surface 98. The axle plate 91 includes a first longitudinal edge 158, a second longitudinal edge 159, a first axle side edge 164, and a second axle side edge 166. The second longitudinal edge 159 is vertically spaced apart from the first longitudinal edge 158. The axle trailer surface 98 is adjacent to the trailer frame 10 when the axle bracket 90 is coupled to the modular base trailer 2, see FIG. 2. The axle tire surface 99 is on the opposite side of the axle plate 91 from the axle trailer surface 98. The first longitudinal edge 158 extends between the axle trailer surface 98 and the axle tire surface 99. The first longitudinal edge 158 also extends between the first axle side edge 164 and the second axle side edge 166. The first axle side edge 164 extends from the first longitudinal edge 158 downwards towards the second longitudinal edge 159. The second axle side edge 166 extends from the first longitudinal edge 158 downwards towards the second longitudinal edge 159. The first axle side edge 164 and the second axle side edge 166 are located on opposites sides of the first longitudinal edge 158 and the second longitudinal edge 159. The axle bracket 90 comprises at least one upper tab 95a and at least one lower tab 95b. The upper tabs 95a and the lower tabs 95b extend from the first axle side edge 164 and the second axle side edge 166 having a curved or arcuate shape. One of the upper tabs 95a extends from the first axle side edge 164 and the other upper tab 95a extends from the second axle side edge 166. One of the lower tabs 95b extends from the first axle side edge 164 and the other lower tab 95b extends from the second axle side edge 166.

Referring to FIG. 14, the axle bracket 90 also includes at least one upper fastener receiver 96a and at least one lower fastener receiver 96b located on the axle plate 91. The upper fastener receivers 96a are located near the first longitudinal edge 158. The lower fastener receivers 96b are located near the second longitudinal edge 159. The axle bracket 90 also includes at least one secondary fastener receiver 97 located on the axle plate 91. The secondary fastener receivers 97 are located between the upper fastener receivers 96a and the lower fastener receivers 96b on the axle plate 91. The secondary fastener receivers 97 are generally circular in shape and may be slightly smaller in size than the upper fastener receivers 96a and the lower fastener receivers 96b. In alternative embodiments, the secondary fastener receivers 97 may be substantially the same size or larger than the upper fastener receivers 96a and the lower fastener receivers 96b.

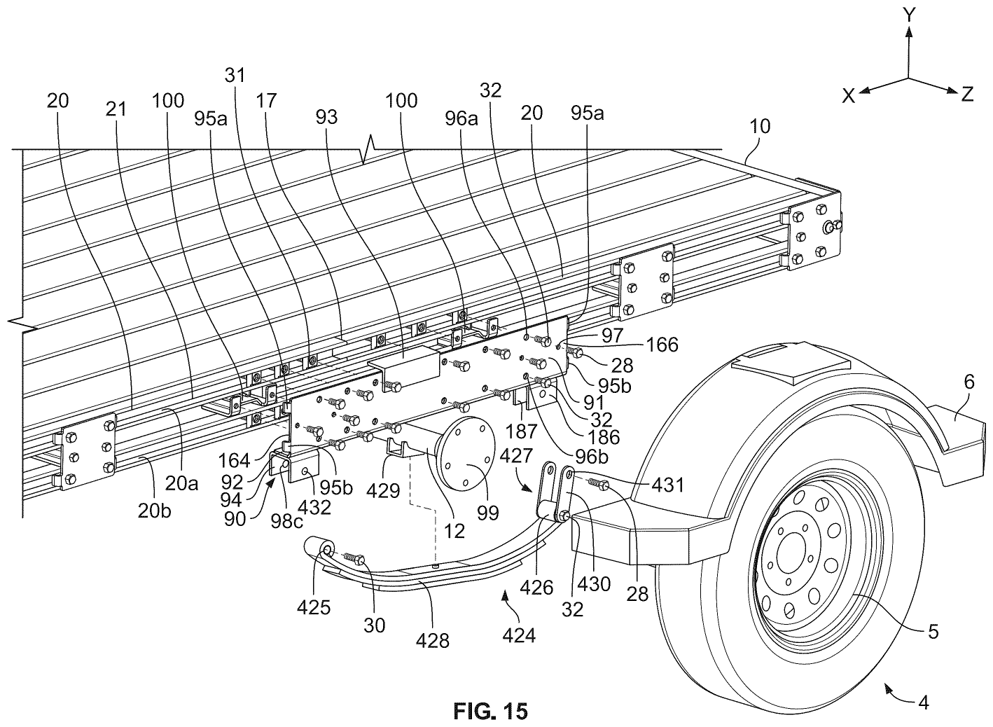

Referring to FIG. 14, the axle bracket 90 includes the shelf 92 extending from the second longitudinal edge 159 at an approximate 90-degree angle between the first axle side edge 164 and the second axle side edge 166. The shelf 92 has an upper surface 168 and a lower surface 169. The lower surface 169 is located on the opposite side of the shelf 92 from the upper surface 168. The hanger brackets 94 are coupled to the lower surface 169 of the shelf 92 on opposing ends of the axle bracket 90. More specifically, one of the hanger brackets 94 is located near the first axle side edge 164 and the other hanger bracket 94 is located near the second axle side edge 166. The hanger brackets 94 are integrally attached to the lower surface 169 of the shelf 92. The hanger brackets 94 include a hanger first sidewall 186, a hanger second sidewall 187, and a hanger top wall 188. The hanger brackets 94 are generally U-shaped and configured to receive a portion of the axle and wheel assembly 4, see FIG. 15. The hanger top wall 188 is coupled to and may be integral with the lower surface 169 of the shelf 92. The hanger first sidewall 186 and the hanger second sidewall 187 extend downwards and away from the hanger top wall 188. The hanger first sidewall 186 and the hanger second sidewall 187 are substantially parallel with each other and are spaced apart a distance of the width of the hanger top wall 188. The hanger first sidewall 186 and the hanger second sidewall 187 each include an engagement aperture 432. The engagement aperture 432 is circular in shape. The engagement aperture 432 located on the hanger first sidewall 186 aligns with the engagement aperture 432 located on the hanger second sidewall 187.

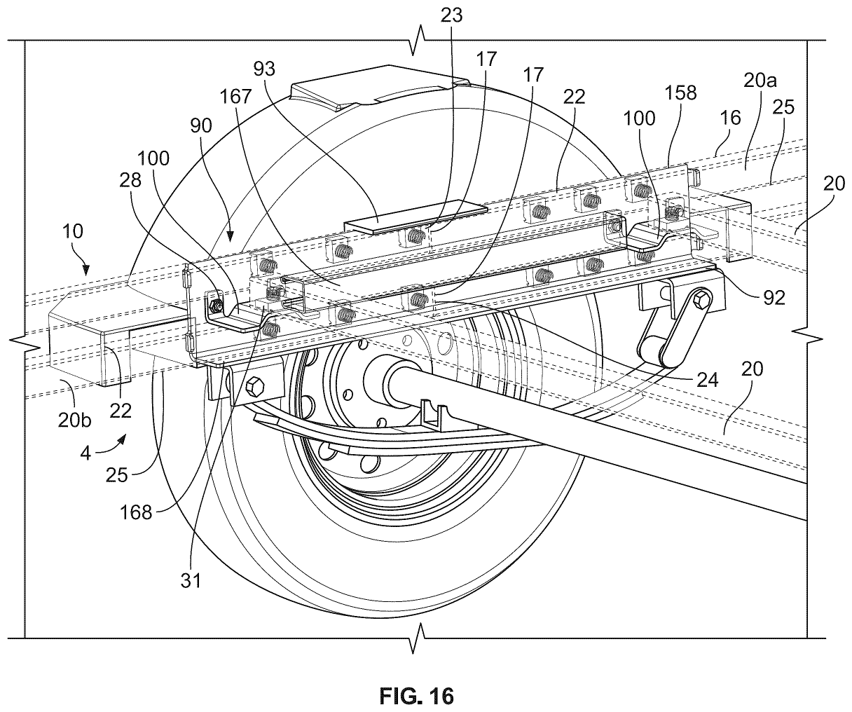

Referring to FIG. 14, the axle rail 167 integrally attaches to and extends away from the axle trailer surface 98 of the axle plate 91. The axle rail 167 includes an axle rail top wall 199, an axle rail bottom wall 214, and an axle rail sidewall 217. The axle rail top wall 199 and the axle rail bottom wall 214 are substantially parallel with each other and extend from the axle trailer surface 98 of the axle plate 91. The axle rail sidewall 217 extends between the axle rail top wall 199 and the axle rail bottom wall 214. The axle rail 167 is generally U-shaped. The axle rail top wall 199 includes a top inwardly curved edge 218 adjacent with the axle trailer surface 98. The axle rail bottom wall 214 includes a bottom inwardly curved edge 219 adjacent with the axle trailer surface 98. The attachment structure of the top inwardly curved edge 218 and the bottom inwardly curved edge 219 to the axle trailer surface 98 strengthens the attachment between the axle plate 91 and the axle rail 167. The joint cap 93 is generally L-shaped. A portion of the joint cap 93 is located on the axle tire surface 99 of the axle bracket 90, see FIG. 15. A portion of the joint cap 93 overlaps and makes contact with the axle plate first longitudinal edge 158. The joint cap 93 is located between the first axle side edge 164 and the second axle side edge 166 on the axle plate first longitudinal edge 158. A portion of the joint cap 93 may be adjacent to the top wall 22 of the rails 20 of the upper rail frame 20a to provide the trailer 10 with additional structural support, see FIG. 16.

Referring to FIG. 15, the axle bracket 90 couples the axle and wheel assembly 4 to the trailer frame 10. Additionally, the axle bracket 90 couples at least two rails 20 disposed co-axially in an end-to-end fashion. More specifically, the axle bracket 90 is provided to couple at least two rails 20 of the upper rail frame 20a that are co-axial with each other and couple at least two rails 20 of the lower rail frame 20b that are co-axial with each other. Therefore, the axle bracket 90 may couple four rails 20 to the trailer frame 10. Therefore, in the preferred embodiment, the upper tabs 95a and the lower tabs 95b of the axle bracket 90 may be inserted into the channel 21 of the rails 20. More specifically, the upper tabs 95a of the axle bracket 90 may be inserted into the channel 21 of the rails 20 forming the upper rail frame 20a. The lower tabs 95b of the axle bracket 90 may be inserted into the channel 21 of the rails forming the lower rail frame 20b. The axle bracket 90 is coupled to the trailer frame 10 by inserting the first bolts 32 through the upper fastener receivers 96a and the lower fastener receivers 96b and into the corresponding nuts 31 located in the channel 21 of the rails 20. In the preferred embodiment, twelve first bolts 32 are inserted through each of the fastener receivers 96, six upper fastener receivers 96a and six lower fastener receivers 96b, located on the axle plate 91 to couple the axle bracket 90 to the trailer frame 10. In alternative embodiments, a different number of first bolts 32 may be used to couple the axle bracket 90 to the trailer frame 10. The axle bracket 90 is also coupled to the trailer frame 10 by inserting the second bolts 28 through each of the secondary fasteners 97 and into the corresponding apertures located in the cross-member brackets 100 located on the trailer frame 10 in between the upper rail frame 20a and the lower rail frame 20b. The secondary fastener receivers 97 are located between the upper fastener receivers 96a and the lower fastener receivers 96b. In the preferred embodiment, four second bolts 28 are inserted into corresponding secondary fastener receivers 97. In alternative embodiments, more than four or less than four second bolts 28 may be used to couple the axle bracket 90 to the trailer frame 10.

Referring to FIG. 15, the axle bracket 90 further includes a leaf spring system 424. The leaf spring system 424 includes a first eye 425, a second eye 426, a leaf spring bracket 427, a plurality of leaves 428 extending between the first eye 425 and the second eye 426, and at least one axle perch 429. The first eye 425 is configured to be received in the hanger bracket 94 located near the first axle side edge 164 of the axle bracket 90 and/or near the front end 13 of the trailer frame 10. The leaf spring bracket 427 includes two bracket plates 430. Each bracket plate 430 includes two apertures 431 and are mirror images of each other. The bracket plates 430 are spaced apart a distance less than the length of the first bolts 32. Two apertures 431 located on the lower portion of each bracket plate 430 are configured to be adjacent to the second eye 426. The bracket plate 430 may be coupled to the leaf spring system 424 by inserting the first bolt 32 through one of the apertures 431 located on one of the bracket plates 430 in which the first bolt 32 extends through the second eye 426 to the aperture 431 located on the other bracket plate 430. The two apertures 431 located on the upper portion of each bracket plate 430 align with the engagement apertures 432 located on the hanger bracket 94 located near the second axle side edge 166 and/or near the rear end 14 of the trailer frame 10. More specifically, the bracket plates 430 are coupled to the lateral sides of the hanger first sidewall 186 and the hanger second sidewall 187. The second bolt 28 may be inserted into one of the apertures 431 located on the upper portion of the bracket plate 430 and extend through the engagement apertures 432 located in both the hanger first side wall 186 and the hanger second side wall 187 and through to the aperture 431 located on the upper portion of the other bracket plate 430. A fastening device, such as the nut 252 (not shown) may be fastened to the second bolts 28 to secure the leaf spring system 424 to the axle bracket 90. The at least one axle perch 429 is coupled to the leaf spring system 424 by a center bolt, not shown. More specifically, the center bolt may be inserted into the underside of the plurality of leaves 428 and extend through an aperture (not shown) located on the axle perch 429. The axle perch 429 assists in positioning the axle 12 in place to position at least one wheel 5 of the axle and wheel assembly 4. The axle perch 429 is welded to the axle 12 of the axle and wheel assembly 4. It is to be understood the present disclosure contemplates an overslung configuration and an underslung configuration for the axle and wheel assembly 4. The fender 6 is mounted over the at least one wheel 5 to prevent debris from being thrown into the air and to protect the wheel 5 from being punctured or damaged in any other type of way. It is to be understood that the present disclosure contemplates that the axle bracket 90 rigidly secures the upper rail frame 20a and/or the lower rail frame 20b at selectable locations on the trailer frame 10. Further, it is to be understood that the present disclosure contemplates that the axle bracket 90 rigidly secures at least two rails 20 wherein one rail 20 is part of the upper rail frame 20a of the trailer frame 10 and one rail is part of the lower rail frame 20b of the trailer frame 10. In another embodiment, the axle bracket 90 is selectively mounted at locations on the trailer frame 10 to make room for additional axle and wheel assemblies 4, such that the modular base trailer 2 includes at least four axle and wheel assemblies 4 for heavier or larger loads.

Referring to FIG. 16, the axle bracket 90 is shown coupled to the trailer frame 10 and the axle and wheel assembly 4. The bottom wall 25 of the rails 20 forming the lower rail frame 20b are adjacent to the upper surface 168 of the shelf 92 of the axle bracket 90. The joint cap 93 is adjacent to the top wall 22 of at least two rails 20 forming portions of the upper rail frame 20a. The joint cap 93 extends over and beyond the top wall 22 of the rails 20 forming a portion of the upper rail frame 20a. The axle rail 167 is configured to be located between the bottom wall 25 of the rail 20 of the upper rail frame 20a and the top wall 22 of the rail 20 of the lower rail frame 20b when the axle bracket 90 is secured to the trailer frame 10. Additionally, the axle rail 167 may be adjacent to cross-member brackets 100 coupled to trailer frame 10, such that a portion of the axle rail 167 is located above portions of the cross-member brackets 100. The axle bracket 90 couples four rails 20 together, two adjacent rails 20 forming a portion of the upper rail frame 20a and two adjacent rails 20 forming a portion of the lower rail frame 20b. A 0-degree joint 17 is formed where two ends of separate rails 20 are adjacent to each other on the upper frame 20a and/or the lower rail frame 20b. More specifically, the 0-degree joint 17 is formed when the first end 23 of one rail 20 is adjacent to the second end 24 of another rail 20. The axle rail 167 provides structural support to the trailer frame 10 at the 0-degree joint 17. The location of the axle rail 167 and/or the joint cap 93 increases the resistance to the stress at the 0-degree joint 17 where the two rails 20 of the upper rail frame 20a are adjacent to the two rails 20 of the lower rail frame 20b. The cross-member bracket 100 is shown coupled to the axle bracket 90 by the second bolts 28 inserted through the secondary fastener receivers 97. The nuts 252 are coupled to the second bolts 28 or some other fastening device is used to secure the cross-member brackets 100 to the axle bracket 90. The cross-member brackets 100 are located between the upper frame 20a and the lower frame 20b. The cross-member brackets 100 are also coupled to rails 20 (or cross-member rails 19) extending between the first side 15 of the trailer frame 10 (see FIG. 2) to the second side 16 of the trailer frame 10 by using the nut 31 located in the channel 21 of the rail 20 and the first bolt 32 (see FIG. 15). This arrangement provides structural support to the trailer frame 10 as well as the axle and wheel assembly 4 because at least one rail 20 is secured between the first side 15 and the second side 16 of the trailer frame 10, near the 0 degree joint 17 of at least two of the rails 20 that are disposed co-axially, and near the axle and wheel assembly 4 (which absorbs shock).

### Cross Member Bracket

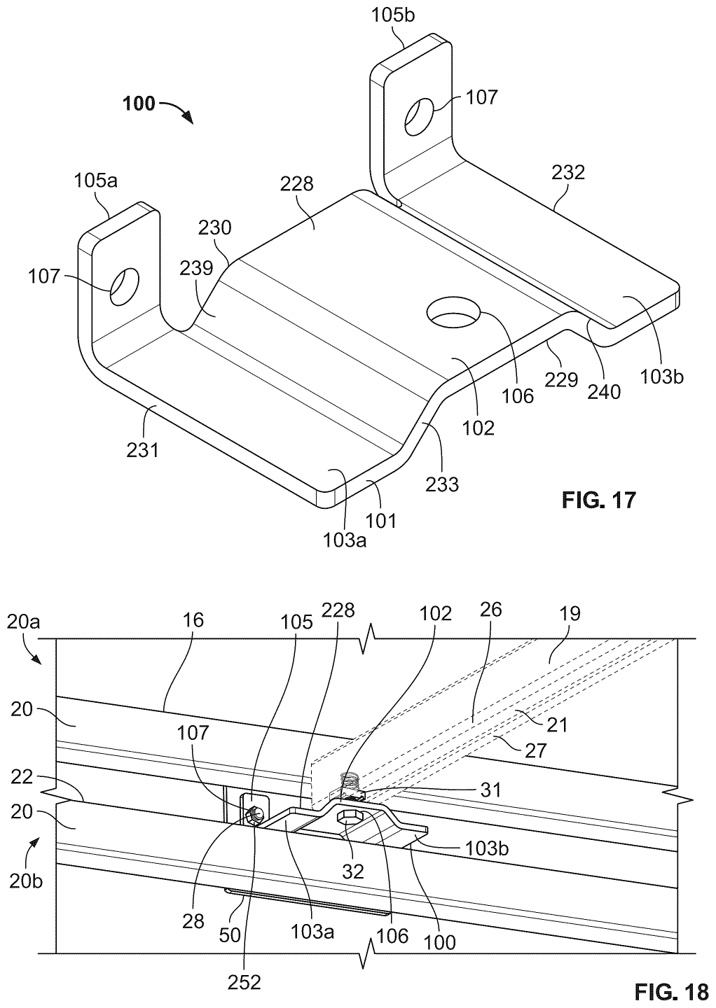

FIG. 17 shows the cross member bracket 100. The cross member bracket 100 comprises a non-planar plate 101 that includes an elevated platform 102, a first lower end 103a, a second lower end 103b, a first tab 105a, and a second tab 105b. The first tab 105a and the second tab 105b extending substantially perpendicular from the first lower end 103a and the second lower end 103b, respectively. The elevated platform 102 is located between the first lower end 103a and the second lower end 103b. The non-planar plate 101 includes a first ramp portion 239 and a second ramp portion 240. The first lower end 103a is adjacent to the first ramp portion 239. The first ramp portion 239 extends from the first lower end 103a at an upward angle towards the elevated platform 102. The second lower end 103b is adjacent to the second ramp portion 240. The second ramp portion 240 extends from the second lower end 103b at an upward angle towards the elevated platform 102. The first lower end 103a and the second lower end 103b are located in the same plane. The non-planar plate 101 includes an upward surface 228, a downward surface 229, a trailer frame edge 230, a first lateral edge 231, a second lateral edge 232, and a cross bar edge 233. The upward surface 228 is in a different plane than the first lower end 103a and the second lower end 103b. The downward surface 229 when coupled to the modular base trailer 2 is adjacent to the trailer frame 10, see FIG. 2. The upward surface 228 is on the opposite side of the non-planar plate 101 from the downward surface 229. The cross bar edge 233 extends between the upward surface 228 and the downward surface 229. The cross bar edge 233 also extends between the first lateral edge 231 and the second lateral edge 232. The first lateral edge 231 extends away from the cross bar edge 233 at an approximate 90-degree angle. The second lateral edge 232 extends away from the cross bar edge 233 at an approximate 90-degree angle. The first lateral edge 231 and the second lateral edge 232 are substantially parallel with each other. The trailer frame edge 230 extends between the first lateral edge 231 and the second lateral edge 232. In alternative embodiments, the first lateral edge 231 and the second lateral edge 232 may extend from the cross bar edge 233 and/or the trailer frame edge 230 at different angles.

Referring to FIG. 17, the cross member bracket 100 also comprises at least one opening 107 formed in each of the first tab 105a and the second tab 105b. The cross member bracket 100 also comprises at least one fastener receiver 106 formed in the elevated platform 102 of the non-planar plate 101. The fastener receiver 106 is located near the cross bar edge 233. In alternative embodiments, the fastener receiver 106 may be located in another area on the elevated platform 102.

Referring to FIG. 18, the cross member bracket 100 is operable to couple rails 20 of the upper rail frame 20a and the lower rail frame 20b to the cross-member rails 19 extending from the first side 15 of the trailer frame 10 to the second side 16 of the trailer frame 10, see FIG. 2. For example, the openings 107 located on the first tab 105a and the second tab 105b of the cross member bracket 100 align with the secondary fastener receivers 57 located on the longitudinal bracket 50. The second bolts 28 are inserted through the secondary fastener receivers 57 on the longitudinal bracket 50 and through the openings 107 on the first tab 105a and the second tab 105b located on the cross member bracket 100. The nuts 252 or another type of securing device are used to secure the second bolts 28 to the longitudinal bracket 50 and the cross member bracket 100. The fastener receiver 106 located on the elevated platform 102 of the cross member bracket 100 may be aligned with the nut 31 located in the channel 21 of the cross-member rail 19 extending from the first side 15 of the trailer frame 10 to the second side 16 of the trailer frame. The first bolt 32 may be used to secure the cross member bracket 100 to the cross-member rail 19 extending between the first side 15 of the trailer frame 10 to the second side 16 of the trailer frame by extending through the fastener receiver 106 to the nut 31. The use of the cross member bracket 100 positions the cross-member rails 19 extending between the first side 15 of the trailer frame and the second side 16 of the trailer frame 10 at a perpendicular angle relative to either the first side 15 or the second side 16 of the trailer frame 10 for structural support to the trailer frame 10. The first inwardly turned edge 26 and the second inwardly turned edge 27 of the cross-member rail 19 is adjacent to the upward surface 228 of the cross member bracket 100 when the first bolt 32 secures the cross member bracket 100 to the cross-member rail 19 extending between the first side 15 and the second side 16 of the trailer frame 10. More specifically, the first inwardly turned edge 26 and the second inwardly turned edge 27 are adjacent to the elevated platform 102. The first bottom end 103a and the second bottom end 103b of the cross member bracket 100 are positioned above the top wall 22 of the rails 20 forming portions of the lower rail frame 20b of the trailer frame 10.

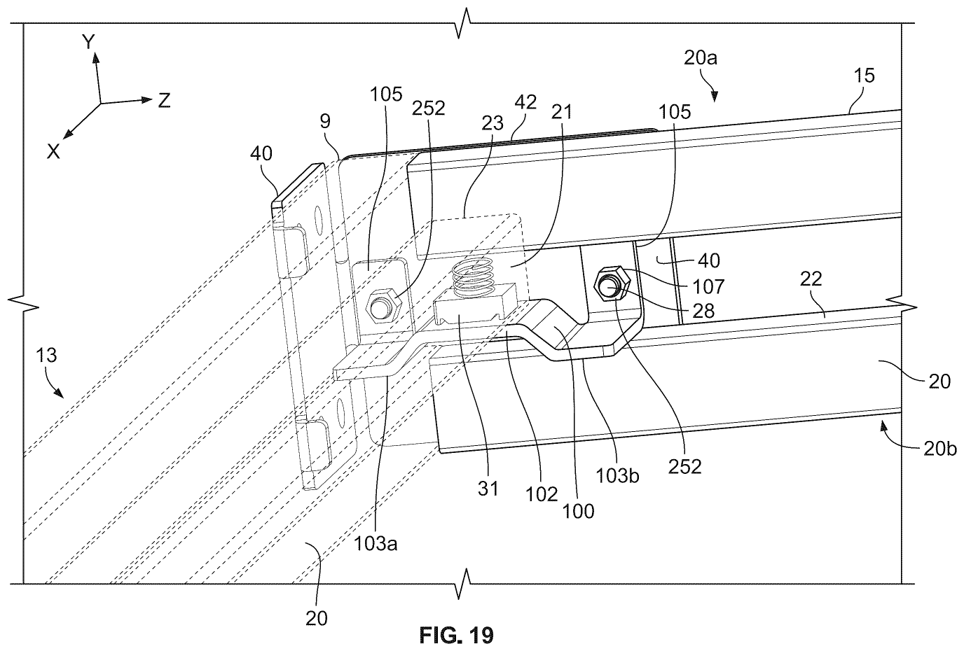

As shown in FIG. 19, the cross member bracket 100 is coupled to the corner bracket 40 in a similar manner as described above with respect to the longitudinal bracket 50. The bottom ends 103, specifically, the first bottom end 103a and the second bottom end 103b, of the cross member bracket 100 are positioned above the top wall 22 of the rails 20 forming the lower rail frame 20b. Specifically, the first bottom end 103a and the second bottom end 103b straddle two different rails 20 joined at an approximate 90-degree angle forming a portion of the lower rail frame 20b. More specifically, the first bottom end 103a or the second bottom end 103b may be adjacent to the cross-member rail 19 extending between the first side 15 and the second side 16 of the trailer frame 10 near the front end 13 of the trailer frame 10 or the rear end 14 of the trailer frame 10. The first bottom end 103a or the second bottom end 103b may be adjacent to the rail 20 extending longitudinally and forming a portion of the lower rail frame 20b. As shown in FIG. 19, the first bottom end 103a may be adjacent to the cross-member rail 19 extending between the first side 15 and the second side 16 of the trailer frame 10 near the front end 13. The second bottom end 103b may be adjacent to the rail 20 extending longitudinally and forming a portion of the lower frame 20b. The openings 107 located on the tabs 105, the first tab 105a and the second tab 105b, are aligned with the secondary fastener receivers 47 located on the corner bracket 40. The second bolts 28 are inserted through each of the secondary fastener receivers 47 and the openings 107 and secured with the nut 252 or some other fastening device to secure the corner bracket 40 to the cross member bracket 100. Portions of the cross-member rails 19 extending between the first side 15 and the second side 16 of the trailer frame 10 are positioned on top of the elevated platform 102 near the first rail end 7, the second rail end 8, the third rail end 9, and/or the fourth rail end 11 of the trailer frame 10. The nut 31 is received within the channel 21 of the cross-member rail 19 extending between the first side 15 and the second side 16 of the trailer frame 10. The first bolt 32 is inserted through the fastener receiver 106 formed in the elevated platform 102 and is threaded into the nut 31 located in the channel 21. The cross member bracket 100 perpendicularly joins at least one of the cross-member rails 19 extending between the first side 15 and the second side 16 to rails 20 forming either the first side 15 or the second side 16 of the upper rail frame 20a or the lower rail frame 20b of the trailer frame 10 and parallel to the rails 20 forming either the front end 13 or the rear end 14 of the upper rail frame 20a or the lower rail frame 20b of the trailer frame 10. This arrangement provides structural support to the first rail end 7, the second rail end 8, the third rail end 9, and the fourth rail end 11 of the trailer frame 10.

### Trailer Lighting System

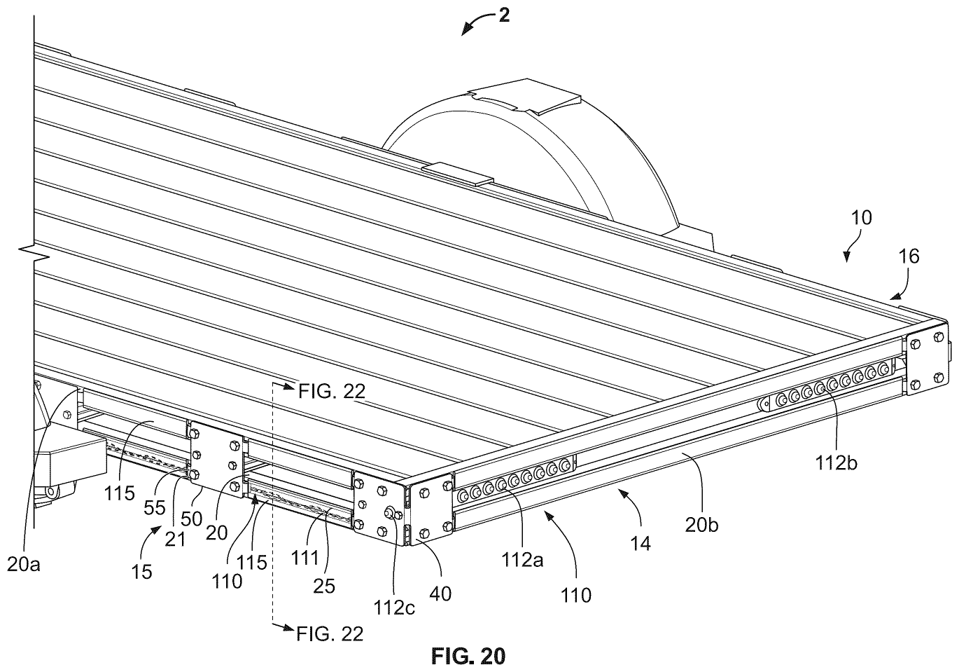

FIG. 20 shows at least a portion of the trailer lighting system 110 that includes a first taillight 112a, a second taillight 112b, a plurality of corner lights 112c, and an electrical harness 111. In some embodiments, the trailer lighting system 110 includes the electrical harness 111 being electrically connected in a conventional manner to the electrical system of the vehicle (not shown) towing the base trailer 2. In other embodiments, the trailer lighting system 110 includes the electrical harness 111, the first taillight 112a, the second taillight 112b, the plurality of corner lights 112c, and a battery (not illustrated) mounted to the trailer frame 10. The battery is operable to power the trailer lighting system 110. The electrical harness 111 is capable of reaching power sources, such as the electrical system of the vehicle or the battery mounted to the trailer frame 10. The electrical harness 111 may extend from the power source, such as the battery or vehicle electrical system, to around the trailer frame 10 within the channels 21 of the rails 20. A channel cover 115 is coupled to the rails 20 forming the trailer frame 10 to cover the channels 21. The channel covers 115 seal or partially seal the channels 21 and may prevent fluid and debris from gaining access to the channels 21 that may be harmful to the electrical harness 111 and other aspects of the trailer lighting system 110. Portions of the rails 20 not covered by the channel covers 115 are covered by the plurality of brackets coupled to the trailer frame 10, such as the longitudinal bracket 50 or the corner bracket 40 as examples. The electrical harness 111 is wired behind each of the plurality of brackets and the channel covers 115 therefore providing continuous coverage of the electrical harness 111 within the channel 21. It is to be understood that the present disclosure contemplates that the trailer lighting system 110 is operable to power any lighting configuration supported by the base trailer 2.

Referring to FIG. 20, the first taillight 112a and the second taillight 112b are located between the upper rail frame 20a and the lower rail frame 20b. The first taillight 112a and the second taillight 112b are recessed relative to the corner brackets 40 and portions of the rails 20 forming the rear end 14 of the trailer frame 10. The first taillight 112a and the second taillight 112b being recessed on the rear end 14 of the trailer frame 10 limits exposure to being damaged by debris, fluids, and/or other objects that may come into contact with the rear end 14 of the trailer frame 10. More specifically, the first taillight 112a is located on the rear end 14 near the first side 15 of the trailer frame 10. The second taillight 112b is located on the rear end 14 near the second side 16 of the trailer frame 10. In alternative embodiments, the first taillight 112a and the second taillight 112b may extend along the entire length of the rear end 14 of the trailer frame 10 in between the upper rail frame 20a and the lower rail frame 20b. In alternative embodiments, additional lights, such as the first taillights 112a and the second taillights 112b may be recessed on the other sides of the trailer frame 10, such as the front end 13, the first side 15, and/or the second side 16. The corner lights 112c are located on the first planar plates 42 of each of the corner brackets 40 used to form the base trailer 2. More specifically, two corner lights 112c are located on the first side 15 of the trailer frame 10 and two corner lights are located on the second side 16 of the trailer frame. As shown in FIG. 20, one corner light 112c is located in the corner bracket 40 coupling the rear end 14 to the first side 15. One corner light 112c is located in the corner bracket 40 coupling the front end 13 to the first side 15 (not shown). One corner light 112c is located in the corner bracket 40 coupling the front end 13 to the second side 16 (not shown). One corner light 112c is located in the corner bracket 40 coupling the rear end 14 to the second side 16 (not shown).

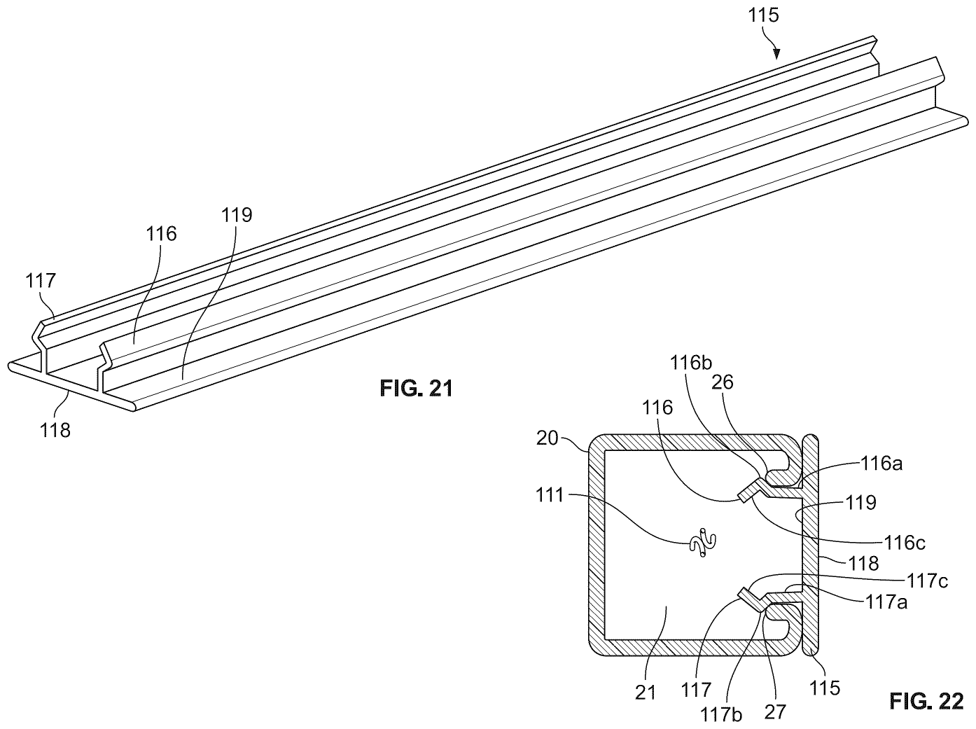

FIG. 21 shows the channel cover 115. The channel cover 115 may be selectively installed and removed from the rails 20 and includes a front surface 118 and a rear surface 119 wherein a first deformable arm 116 and a second deformable arm 117 protrude from the rear surface 119. Each of the first and second deformable arms 116, 117 of the illustrated embodiment extends from the rear surface 119 of the channel cover 115 in a generally parallel orientation with respect to each other and generally orthogonal to the rear surface 119 of the channel cover 115. The first deformable arm 116 and the second deformable arm 117 are mirror images of each other. The channel cover 115 covers and seals or partially seals the channels 21 of the rails 20 forming the trailer frame 10.

Referring to FIG. 22, each of the first and second deformable arms 116, 117 includes a first wall 116a, 117a, an outwardly-angled section 116b, 117b, and an inwardly-angled section, 116c, 117c. The first walls 116a, 117a define a length approximately equal to or greater than the length of each of the first and second inwardly-turned edges 26, 27. The first walls 116a, 117a are substantially parallel with each other and extend from the rear surface 119 of the channel cover 115 at an approximate 90-degree angle. The first walls 116a, 117a terminate and extend into the outwardly-angled sections 116b, 117b. The outwardly-angled sections 116b, 117b terminate and extend into the inwardly-angled sections 116c, 117c. The channel cover 115 is placed on the rail 20 such that the inwardly-angled sections 116c, 117c extend beyond the first and second inwardly-turned edges 26, 27 and are located within the channel 21. The channel covers 115 are coupled to the rails 20 by applying sufficient force to the front surface 118 of the channel cover 115. When installing the channel cover 115 to the rail 20, force is applied to the front surface 118 of the channel cover 115. The first and second deformable arms 116, 117 will bend slightly inwards or deflect inwards towards each other to permit the inwardly-angled sections 116, 117 to move beyond the first and second inwardly-turned edges 16,27. The outwardly-angled sections 116b, 117b maintain contact with portions of the first and second inwardly-turned edges 26,27 when the channel cover 115 is installed on the rails 20. The positioning of the outwardly-angled sections 116b, 117b relative to the first and second inwardly-turned edges 26, 27 prevents the channel cover 115 from slipping out of the channel 21 of the rails 20 inadvertently. The first and second deformable arms 116, 117 maintain contact with the first and second inwardly-turned edges 26, 27 with a friction type fit or a snap type fit. The outwardly-angled sections 116b, 117b are then closely engaged with the first and second inwardly-turned edges 26, 27 in order to prevent unselected removal of the channel cover 115 from the rail 20. It is to be understood that the present disclosure contemplates that the channel cover 115 comprises a length that may be altered, such as by cutting with a utility knife, so that the length of the channel cover 115 corresponds to the length of the channel 21 to be covered or sealed.

Referring to FIG. 22, the electrical harness 111 may be located within the channel 21 of the rail 20. The channel cover 115 protects the electrical harness 111 by covering the channel 21 and preventing unwanted fluid and debris from gaining access into the channel 21. The channel cover 115 therefore at least partially protects the electrical harness 111 from exposure to water, debris, and other elements the trailer frame 10 may be exposed to during operational and non-operational periods.

### Interchangeable Trailer Configurations

Another key aspect of the present invention is that the modular base trailer 2 and trailer kit 1 are designed to accommodate a variety of accessory mounting systems, accessory brackets, and/or one or more accessories that form a variety of trailer configurations on a single trailer frame 10. As such, the modular base trailer 2 are configurable into one or more trailer configurations. The trailer configurations are interchangeable such that the user can modify the trailer frame 10 from one trailer configuration to another by selectively mounting or removing certain accessory mounting systems, accessory brackets, and/or one or more accessories to/from the modular base trailer using the trailer frame 10. Each of the trailer configurations are interchangeably configurable to the trailer frame 10 without welding or drilling to the modular base trailer 2, the accessory mounting systems, the accessory brackets, or the accessories that may be coupled to the trailer frame 10.

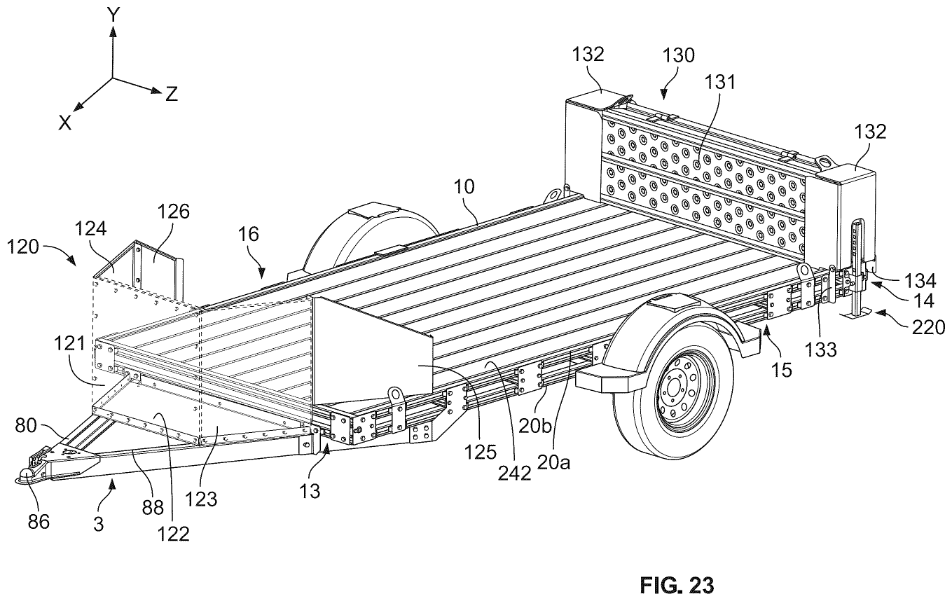

Referring to FIG. 23, the modular base trailer 2 is shown with a decking 242. The user may assemble all the pieces in the trailer kit 1 to construct an assembled modular base trailer 2 and may further install the decking 242. The accessory mounting systems, at least one accessory bracket, and/or one or more accessories are interchangeably fastened to the trailer frame 10 using the first bolts 32 and the nuts 31 and/or second bolts 28 and corresponding nuts 252 or other fastening methods. In the preferred embodiment, the plurality of brackets further comprises at least one accessory bracket operable to secure one or more accessories to the trailer frame 10. The accessory bracket is also operable to secure an accessory mounting system to the trailer frame 10, and therefore, the base trailer 2.

Each of the trailer configurations is interchangeably configurable to the trailer frame 10 without requiring modifications to the trailer frame 10. While the modular base trailer 2 is one trailer configuration, the modular base trailer 2 is used in combination with at least one of each of the accessory mounting systems, accessory brackets, and/or one or more accessories described below to define other trailer configurations. In some embodiments, multiple trailer configurations can be configured on the modular base trailer 2 at once. Thus, the modular base trailer 2 and the trailer kit 1 described in the present disclosure provides users with maximum flexibility to choose and combine a plurality of trailer configurations.

### Fairing System and Rear Ramp Storage System

FIG. 23 shows examples of accessory mounting systems wherein the accessory mounting system may be a fairing system 120 or a rear ramp storage system 130. The fairing system minimizes drag and prevents wind from dislodging the cargo carried by the trailer frame 10. The fairing system 120 is mounted to portions of the trailer tongue assembly 3, the front end 13 of the trailer frame 10, and the decking 242. The fairing system 120 includes a bottom panel 122, a front panel 121, a first side panel 123, a second side panel 124, a first decking panel 125, and a second decking panel 126. The first side panel 123 is coupled to the first sidewall 88 of the tongue rail 80 located near the first side 15. The second side panel 124 is coupled to the first sidewall 88 of the other tongue rail 80 located near the second side 16. The front panel 121 extends between the first side panel 123 and the second side panel 124 proximate the hitch 86. The first decking panel 125 is coupled to the first side panel 123. The first decking panel 125 is located on top of the decking 242 and portions of the upper rail frame 20a. The first decking panel 125 extends from a portion of the front side 13 diagonally to a portion of the first side 15 of the trailer frame 10. The second decking panel 126 mirrors the orientation of the first decking panel 125 extending from a portion of the front side 13 diagonally to a portion of the second side 16 on top of the decking 242 and portions of the upper rail frame 20a.

Referring to FIG. 23, the rear ramp storage system 130 includes at least one front storage bracket 133, at least one rear storage bracket 134, a stabilizer jack assembly 220, at least one pivoting ramp cover 132 and a ramp 131. In the preferred embodiment, two ramp covers 132 receive the respective ends of the ramp 131 in a storage configuration. The ramp 131 is collapsible and selectively stored or selectively removed and expanded to facilitate the loading or unloading of cargo near the rear end 14 of the trailer frame 10. In alternative embodiments, the ramp 131 may be removed and expanded on other sides or portions of the trailer frame 10, such as the front end 13, the first side 15, and/or the second side 16. The ramp covers 132 are pivotably coupled to the front storage brackets 133 and the rear storage brackets 134 to move between the storage configuration and a deployed configuration. The stabilizer jack assembly 220 is adjacent to at least one of the corner brackets 40. In the preferred embodiment, the stabilizer jack assembly is located on the first side 15 and another stabilizer jack assembly is located on the second side 16 near the rear end 14 of the trailer frame 10.

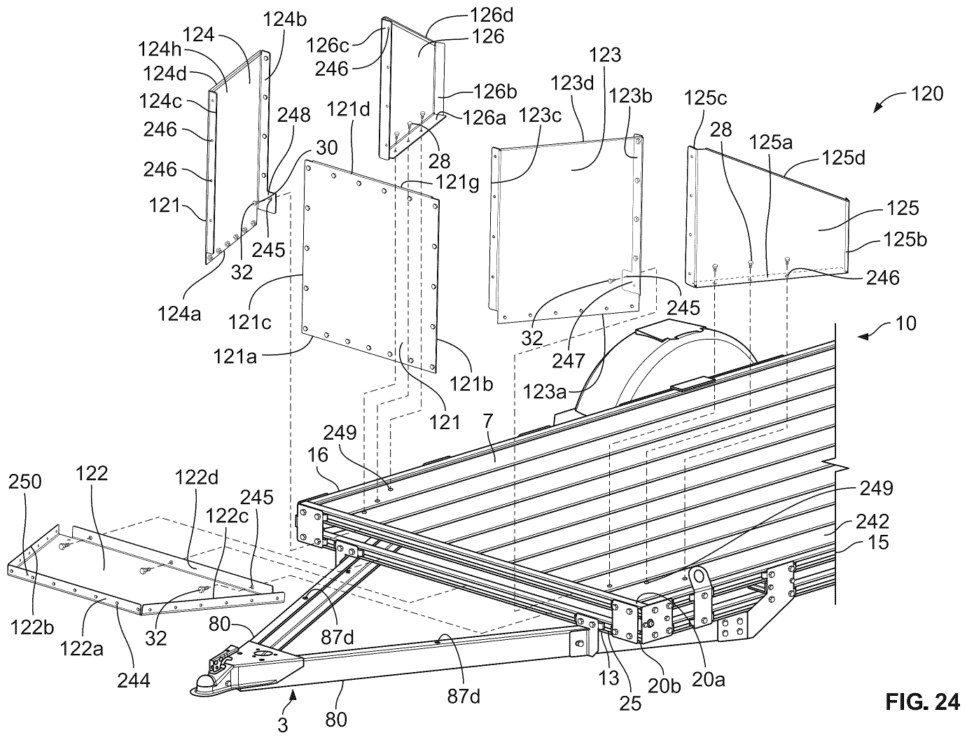

Referring to FIG. 24, the bottom panel 122 of the fairing system 120 is trapezoidal shaped and is adjacent to the front side 13 of the trailer frame 10 and is located on top of the tongue rails 80 extending the distance between the tongue rails 80. The bottom panel 122 includes at least one tongue aperture 250. The tongue apertures 250 are operable to receive the second bolts 28 that extend from the bottom panel 122 to the corresponding tongue rail apertures 87d located on the tongue rails 80. The bottom panel 122 also includes a plurality of fastener edges 122a, 122b, 122c, and 122d extending upwardly from the perimeter from the bottom panel 122 at an approximately 90-degree angle. The fastener edges 122a, 122b, and 122c includes a plurality of secondary fastener receivers 244. The fastener edge 122d includes a plurality of fastener receivers 245. In alternative embodiments, the fastener edges 122a, 122b, 122c, and 122d may include either the secondary fastener receivers 244 and/or the fastener receivers 245. The plurality of secondary fastener receivers 244 and fastener receivers 245 are operable to receive the second bolts 28 and the first bolts 32, respectively, for fastening portions of the fairing system 120 to the trailer frame 10. For example, the first bolts 32 couple the bottom panel 122 to the front end 13 of the trailer frame 10. More specifically, the first bolts 32 extend through the fastener receivers 245 located in the fastener edge 122d of the bottom panel 122 and threaded into the nuts 31 located in the channels 21 of the rails 20 forming portions of the lower rail frame 20b. The nuts 31 are positioned in the channels 21 to receive the corresponding first bolts 32 extending through the fastener receivers 245 located in the fastener edge 122d of the bottom panel 122. In alternative embodiments, the bottom panel 122 may be different shapes and be coupled to different portions of the trailer frame 10 and/or the tongue rails 80.

As shown in FIG. 24, the front panel 121 is substantially rectangular-shaped and includes a top fastener edge 121d, a bottom fastener edge 121a, a first side fastener edge 121b, and a second side fastener edge 121c. The front panel 121 also includes a plurality of secondary fastener receivers 246 located along the perimeter of the front panel 121. Specifically, secondary fastener receivers 246 are located near the top fastener edge 121d, the bottom fastener edge 121a, the first side fastener edge 121b, and the second side fastener edge 121c. The front panel 121 also includes a gusset plate 121g. The gusset plate 121g also includes secondary fastener receivers 246. The secondary fastener receivers 246 located in the gusset plate 121g align with the secondary fastener receivers 246 located in the front panel 121 near the top fastener edge 121d. The second bolts 28 may be inserted through the aligned secondary fastener receivers 246 of the front panel 121 near the top fastener edge 121d and the gusset plate 121g and secured to each other with corresponding nuts 252 or other fastening means or devices. The gusset plate 121g provides for structural reinforcement to the fairing system 120.

As shown in FIG. 24, the first side panel 123 is substantially rectangular-shaped and includes a top fastener edge 123d, a bottom fastener edge 123a, a first side fastener edge 123b, and a second side fastener edge 123c. The first side panel 123 also includes a plurality of secondary fastener receivers 246 located along a portion of the perimeter of the first side panel 123. Specifically, secondary fastener receivers 246 are located near the bottom fastener edge 123a. The first side fastener edge 123b and the second side fastener edge 123c extend from the first side panel 123 at an angle towards the second side 16 of the trailer frame 10. The first side fastener edge 123b and the second side fastener edge 123c are substantially perpendicular to bottom fastener edge 123a. The first side fastener edge 123b and the second side fastener edge 123c include secondary fastener receivers 246 spaced apart from each other along the length of the first side fastener edge 123b and the second side fastener edge 123c. The first side fastener edge 123b includes an extension bracket 247 located near the bottom fastener edge 123a. The extension bracket 247 includes at least one fastener receiver 245 operable to receive the first bolts 32 for coupling the first side fastener edge 123b to the upper rail frame 20a. More specifically, the first bolts 32 may go through the fastener receivers 245 located on the extension bracket 247 and be inserted into the corresponding nuts 31 located in the channels 21 of the rails 20 forming a portion of the front side 13 of the upper rail frame 20a. This arrangement provides additional structural support to the fairing system 120 by securing the fairing system 120 to the trailer frame 10.

As shown in FIG. 24, the second side panel 124 is substantially rectangular-shaped and includes a top fastener edge 124d, a bottom fastener edge 124a, a first side fastener edge 124b, and a second side fastener edge 124c. The second side panel 124 also includes the plurality of secondary fastener receivers 246 located along a portion of the perimeter of the second side panel 124. Specifically, secondary fastener receivers 246 are located near the bottom fastener edge 124a. The first side fastener edge 124b and the second side fastener edge 124c extend from the second side panel 124 at an angle towards the first side 15 of the trailer frame 10. The first side fastener edge 124b and the second side fastener edge 124c are substantially perpendicular to bottom fastener edge 124a. The first side fastener edge 124b and the second side fastener edge 124c include secondary fastener receivers 246 spaced apart from each other along the length of the first side fastener edge 124b and the second side fastener edge 124c. The first side fastener edge 124b includes an extension bracket 248 located near the bottom fastener edge 124a. The extension bracket 248 includes at least one of the fastener receiver 245 operable to receive the first bolts 32 for coupling the second side fastener edge 124b to the upper rail frame 20a. More specifically, the first bolts 32 may go through the fastener receivers 245 located on the extension bracket 248 and be inserted into the corresponding nuts 31 located in the channels 21 of the rails 20 forming a portion of the front side 13 of the upper rail frame 20a. This arrangement provides additional structural support to the fairing system 120 by securing the fairing system 120 to the trailer frame 10.

Referring to FIG. 24, the first decking panel 125 is substantially quadrilateral-shaped and includes a top fastener edge 125d, a bottom fastener edge 125a, a first side fastener edge 125b, and a second side fastener edge 125c. The bottom fastener edge 125a, the first side fastener edge 125b, the second side fastener edge 125c, and the top fastener edge 125d extend from the first decking panel 125 at an angle towards the second side 16 of the trailer frame 10. The bottom fastener edge 125a is adjacent to the decking 242. The bottom fastener edge 125a includes at least one of the secondary fastener receivers 246 operable to receive the second bolts 28 for coupling the first decking panel 125 to the decking 242. More specifically, the second bolts 28 may go through the secondary fastener receivers 246 located in the bottom fastener edge 125a and be inserted into a corresponding deck aperture 249 located in the decking 242. The nuts 252 are secured to the second bolts 28 inserted through the bottom fastener edge 125a and the decking 242 to secure the first decking panel 125 to the trailer frame 10. This arrangement provides additional structural support to the fairing system 120 by securing the fairing system 120 to the trailer frame 10.

Referring to FIG. 24, the second decking panel 126 is substantially quadrilateral-shaped and includes a top fastener edge 126d, a bottom fastener edge 126a, a first side fastener edge 126b, and a second side fastener edge 126c. The bottom fastener edge 126a, the first side fastener edge 126b, the second side fastener edge 126c, and the top fastener edge 126d extend from the second decking panel 126 at an angle towards the first side 15 of the trailer frame 10. The bottom fastener edge 125a is adjacent to the decking 242. The bottom fastener edge 126a includes at least one of the secondary fastener receivers 246 operable to receive the second bolts 28 for coupling the second decking panel 126 to the decking 242. More specifically, the second bolts 28 may go through the secondary fastener receivers 246 located in the bottom fastener edge 126a and be inserted into the corresponding deck apertures 249 located in the decking 242. The nuts 252 are secured to the second bolts 28 inserted through the bottom fastener edge 126a and the decking 242 to secure the second decking panel 126 to the trailer frame 10. This arrangement provides additional structural support to the fairing system 120 by securing the fairing system 120 to the trailer frame 10.

Referring to FIG. 24, portions of the bottom panel 122 are coupled to the front side 13 of the trailer frame 10, the first side panel 123, the front panel 121, and the second side panel 124. The rear fastener edge 122d includes the fastener receivers 245. The first bolts 32 may be inserted through the fastener receivers 245 located in the rear fastener edge 122d and be inserted and fastened to corresponding nuts 31 located in the channels 21 of the rails 20 forming a portion of the front side 13 of the lower rail frame 20b. The front panel 121 is coupled to the bottom panel 122. More specifically, the front panel 121 includes secondary fastener receivers 246 near the bottom fastener edge 121a and the front fastener edge 122a includes secondary fastener receivers 246. The secondary fastener receivers 246 of the front fastener edge 122a on the bottom panel 122 and the bottom fastener edge 121a of the front panel 121 align with each other to permit the second bolts 28 to be inserted through the aligned secondary fastener receivers 246 and secured with the nuts 252. The front fastener edge 122a is adjacent to the bottom fastener edge 121a when the front panel 121 is coupled to the bottom panel 122.

Referring to FIG. 24, the first side fastener edge 122c extends upwards from the bottom panel 122 at an approximate 90-degree angle. The first side fastener edge 122c includes the secondary fastener receivers 246. The first side fastener edge 122c is adjacent to the front fastener edge 122a and forms an angle greater than 90 degrees. The first side fastener edge 122c extends at an angle from the front fastener edge 122a to permit the entire length of the first side fastener edge 122c to be located above and adjacent to the first sidewall 88 of one of the tongue rails 80. The first side panel 123 includes the secondary fastener receivers 246 located near the bottom fastener edge 123a. The secondary fastener receivers 246 of the first side fastener edge 122c near the bottom panel 122 and the bottom fastener edge 123a of the first side panel 123 align with each other to permit the second bolts 28 to be inserted through the aligned secondary fastener receivers 246 and secured with the nuts 252. The first side fastener edge 122c is adjacent to the bottom fastener edge 123a when the first side panel 123 is coupled to the bottom panel 122. The second side fastener edge 123c includes the secondary fastener receivers 246 spaced apart from each other. The secondary fastener receivers 246 located near the first side fastener edge 121b of the front panel 121 may be aligned with the secondary fastener receivers 246 located in the second side fastener edge 123c. The second side fastener edge 123c extends from the first side panel 123 at an angle to permit the second side fastener edge 123c to be adjacent to the first side fastener edge 121b when the front panel 121 is coupled to the first side panel 123. The second bolts 28 may be inserted through the aligned secondary fastener receivers 246 located near the first side fastener edge 121b of the front panel 121 and the secondary fastener receivers 246 located in the second side fastener edge 123c. The nuts 252 may be secured to the second bolts 28 to couple the front panel 121 to the first side panel 123.

Referring to FIG. 24, the second side fastener edge 122b extends upwards from the bottom panel 122 at an approximate 90-degree angle. The second side fastener edge 122b includes the secondary fastener receivers 246. The second side fastener edge 122b is adjacent to the front fastener edge 122a and forms an angle greater than 90 degrees. The second side fastener edge 122b extends at an angle from the front fastener edge 122a to permit the entire length of the second side fastener edge 122b to be located above and adjacent to the first sidewall 88 of one of the tongue rails 80. The second fastener edge 122b is a mirror image of the first fastener edge 122c. The second side panel 124 includes the secondary fastener receivers 246 located near the bottom fastener edge 124a. The secondary fastener receivers 246 of the second side fastener edge 122b near the bottom panel 122 and the bottom fastener edge 124a of the second side panel 124 align with each other to permit the second bolts 28 to be inserted through the aligned secondary fastener receivers 246 and secured with the nuts 252. The second side fastener edge 122b is adjacent to the bottom fastener edge 124a when the second side panel 124 is coupled to the bottom panel 122. The second side fastener edge 124c includes the secondary fastener receivers 246 spaced apart from each other. The secondary fastener receivers 246 located near the second side fastener edge 121c of the front panel 121 may be aligned with the secondary fastener receivers 246 located in the second side fastener edge 124c. The second side fastener edge 124c extends from the second side panel 124 at an angle to permit the second side fastener edge 124c to be adjacent to the second side fastener edge 121c when the front panel 121 is coupled to the second side panel 124. The second bolts 28 may be inserted through the aligned secondary fastener receivers 246 located near the second side fastener edge 121c of the front panel 121 and the secondary fastener receivers 246 located in the second side fastener edge 124c. The nuts 252 may be secured to the second bolts 28 to couple the front panel 121 to the second side panel 124.

Referring to FIG. 24, the first decking panel 125 may be coupled to the first side panel 123. The second side fastener edge 125c and the first side fastener edge 125b are substantially perpendicular to the bottom fastener edge 125a. The second side fastener edge 125c includes the secondary fastener receivers 246 spaced apart from each other along the length of the second side fastener edge 125c. The secondary fastener receivers 246 located on the first side fastener edge 123b of the first side panel 123 align with the corresponding secondary fastener receivers 246 located on the second side fastener edge 125c located on the first decking panel 125. The second bolts 28 may be inserted through the aligned secondary fastener receivers 246 of the first side fastener edge 123b of the first side panel 123 and the second side fastener edge 125c of the first decking panel 125. The nuts 252 may be secured to the second bolts 28 to couple the first side panel 123 to the first decking panel 125.

Referring to FIG. 24, the second decking panel 126 may be coupled to the second side panel 124. The second side fastener edge 126c and the first side fastener edge 126b are substantially perpendicular to the bottom fastener edge 126a. The second side fastener edge 126c includes the secondary fastener receivers 246 spaced apart from each other along the length of the second side fastener edge 126c. The secondary fastener receivers 246 located on the first side fastener edge 124b of the second side panel 124 align with the corresponding secondary fastener receivers 246 located on the second side fastener edge 126c located on the second decking panel 126. The second bolts 28 may be inserted through the aligned secondary fastener receivers 246 of the first side fastener edge 124b of the second side panel 124 and the second side fastener edge 126c of the second decking panel 126. The nuts 252 may be secured to the second bolts 28 to couple the second side panel 124 to the second decking panel 126. The bottom panel 122, the front panel 121, the first side panel 123, the second side panel 124, the first decking panel 125, and the second decking panel 126 may be manufactured by folding sheet metal or alternatively by welding the edges to the bottom panel 122, the front panel 121, the first side panel 123, the second side panel 124, the first decking panel 125, and the second decking panel 126.

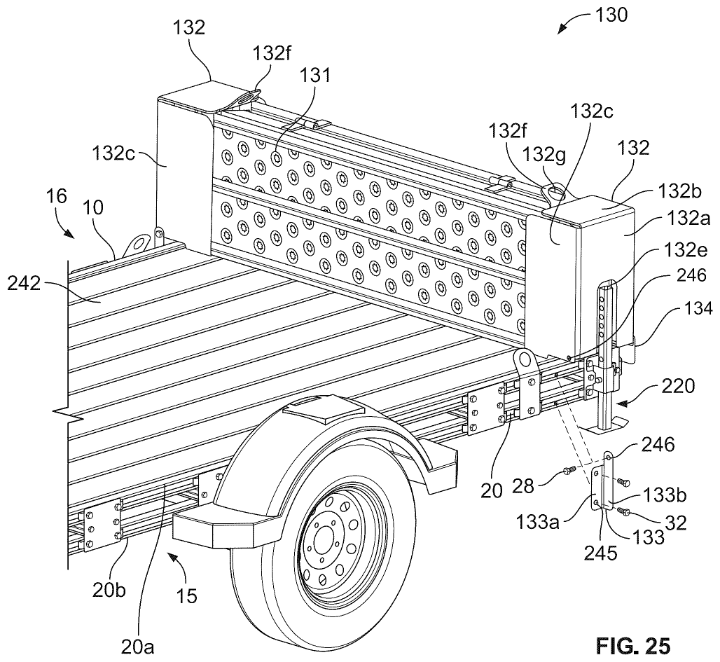

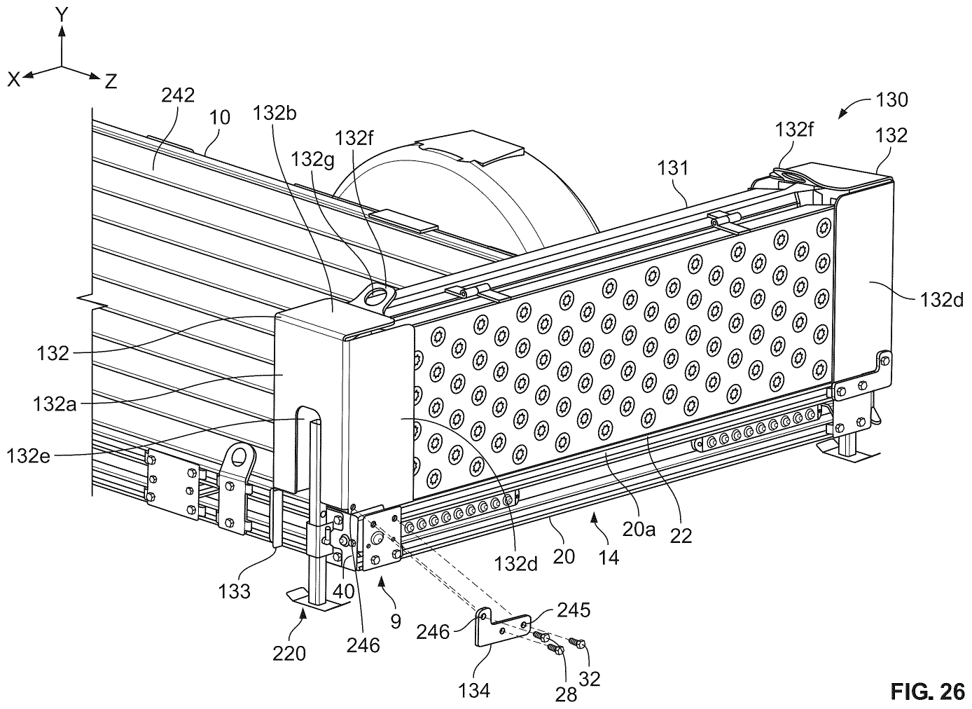

Referring to FIG. 25 and FIG. 26, two ramp covers 132 are provided to engage and retain each end of the ramp 131. The ramp cover 132 includes an end panel 132a, a top panel 132b, a first side panel 132c, and a second side panel 132d located on the opposite side of the end panel 132a from the first side panel 132c. The ramp covers 132 are configured to receive the respective ends of the ramp 131 to secure the ends of the ramp 131 within the ramp covers 132. The ramp covers 132 have a width and height at least as large as the corresponding dimensions of the ramp 131. The top panels 132b extend inward towards each other from the end panels 132a at substantially 90-degree angles. The top panel 132b includes an anchor 132f. The anchor 132f extends from the top panel 132b towards the opposite side of the trailer 10 at an upward angle. The anchor 132f includes a tie-down opening 132g. The tie-down opening 132g is configured to receive a tie-down (not shown) that extends between the anchor 132f located on one of the top panels 132b to the other anchor 132f located on the other top panel 132b on the opposite side of the trailer frame 10 to assist with securing the ramp storage system 130 in the storage configuration. The end panel 132a is substantially perpendicular to the top panel 132b. The first side panel 132c and the second side panel 132d of the ramp cover 132 on the first side 15 of the trailer frame 10 extend inwards towards the corresponding first side panel 132c and second side panel 132d of the ramp cover 132 on the second side 16 of the trailer 10. The first side panels 132c extend from the end panel 132a at substantially 90-degree angle. The first side panels 132c are substantially perpendicular to the top panels 132b and the end panels 132a. The first side panels 132c extend between the top panel 132b and the decking 242. The first side panels 132c are located more towards the front end 13 of the trailer frame 10 than the second side panels 132d. The second side panels 132d extend from the end panel 132a at substantially 90-degree angle. The second side panels 132d are substantially perpendicular to the top panels 132b and the end panels 132a. The second side panels 132d extend between the top panels 132b and the top wall 22 of the rails 20 forming the rear end 14 of the upper rail frame 20a. The second side panels 132d are located proximate the rear end 14 of the trailer frame 10. The top panel 132b, the end panel 132a, the first side panel 132c, and the second side panel 132d cooperate to define a volume to closely receive portions of the ramp 131 when the ramp is in the storage configuration. The first side panel 132c includes secondary fastener receiver 246 located near the decking 242. The second side panel 132d includes secondary fastener receiver 246 located near the third rail end 9. The end panel 132a includes a slot 132e located between the first side panel 132c and the second side panel 132d. The slot 132e is configured to receive portions of the stabilizer jack assembly 220.

Referring to FIG. 25, the front storage bracket 133 may be pivotably coupled to the first side panels 132c of the ramp covers 132 and be coupled to the trailer frame 10. The front storage bracket 133 includes a trailer plate 133a and a ramp cover plate 133b. The trailer plate 133a is substantially perpendicular to the ramp cover plate 133b. The trailer plate 133a includes fastener receivers 245. The ramp cover plate 133b includes secondary fastener receiver 246. The fastener receivers 245 are spaced apart a distance for one of the fastener receivers 245 to be aligned with the channel 21 of one of the rails 20 forming a portion of the upper rail frame 20a and the other fastener receiver 245 aligned with the channel 21 of one of the rails 20 forming a portion of the lower rail frame 20b. The front storage bracket 133 is coupled to the trailer frame 10 by using first bolts 32 and nuts 31 located in the channels 21 of the rails 20 forming portions of the upper rail frame 20a and the lower rail frame 20b. The first bolts 32 may be inserted through the fastener receivers 245 located on the trailer plate 133a of the front storage bracket 133 into the corresponding nuts 31 located in the channels 21 of the rails 20 forming portions of the upper rail frame 20a and the lower rail frame 20b. The second bolt 28 may be inserted through the secondary fastener receiver 246 located on the ramp cover plate 133b and through the secondary fastener receiver 246 located on the first side panel 132c of the ramp cover 132 and secured with nut 252 within the ramp cover 132.

Referring to FIG. 26, the rear storage bracket 134 may be pivotably coupled to the second side panels 132d of the ramp covers 132 and coupled to the trailer frame 10. The rear storage bracket 134 is substantially L-shaped. The rear storage bracket 134 includes fastener receivers 245 spaced apart a distance to align with the upper fastener receivers 46a located in the corner bracket 40. The rear storage bracket 134 includes secondary fastener receiver 246. The secondary fastener receiver 246 is vertically spaced apart from the fastener receivers 245 located in the rear storage bracket 134. The secondary fastener receiver 246 is located above the fastener receivers 245 and located more near the third rail end 9 than the fastener receivers 245. The secondary fastener receiver 246 on the rear storage bracket 134 may align with the corresponding secondary fastener receiver 246 located on the second side panel 132d of the ramp cover 132. The rear storage bracket 134 is also coupled to the trailer frame 10 by using first bolts 32 and nuts 31 located in the channels 21 of the rails 20 forming portions of the upper rail frame 20a and the lower rail frame 20b. The first bolts 32 may be inserted through the fastener receivers 245 located on the rear storage bracket 134, through the upper fastener receivers 46a on the corner bracket 40, and into the corresponding nuts 31 located in the channels 21 of the rails 20 forming portions of the upper rail frame 20a. The second bolt 28 may be inserted through the secondary fastener receiver 246 located on the rear storage bracket 134 and through the secondary fastener receiver 246 located on the second side panel 132d of the ramp cover 132 and secured with nut 252 within the ramp cover 132.

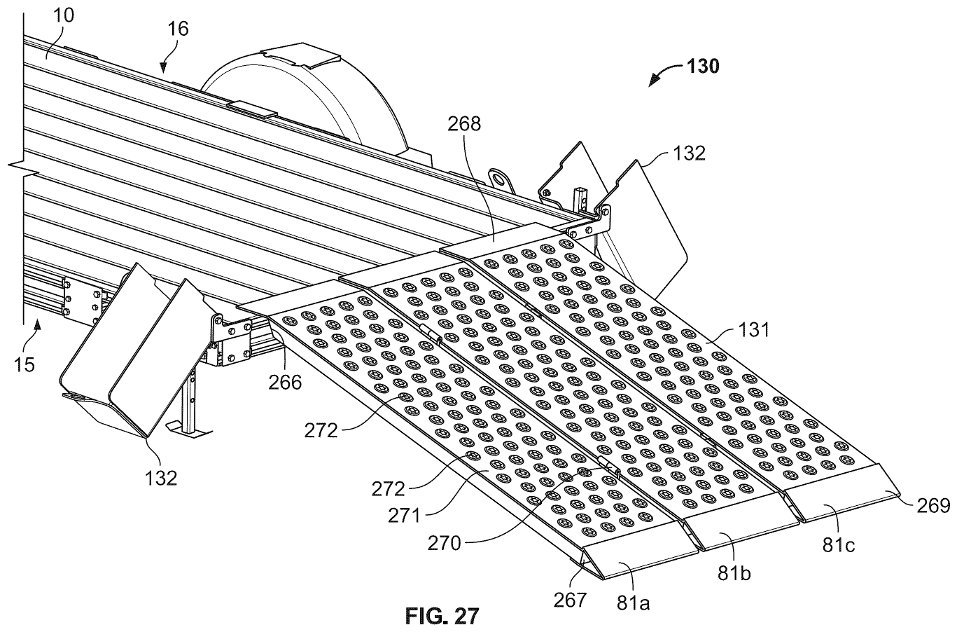

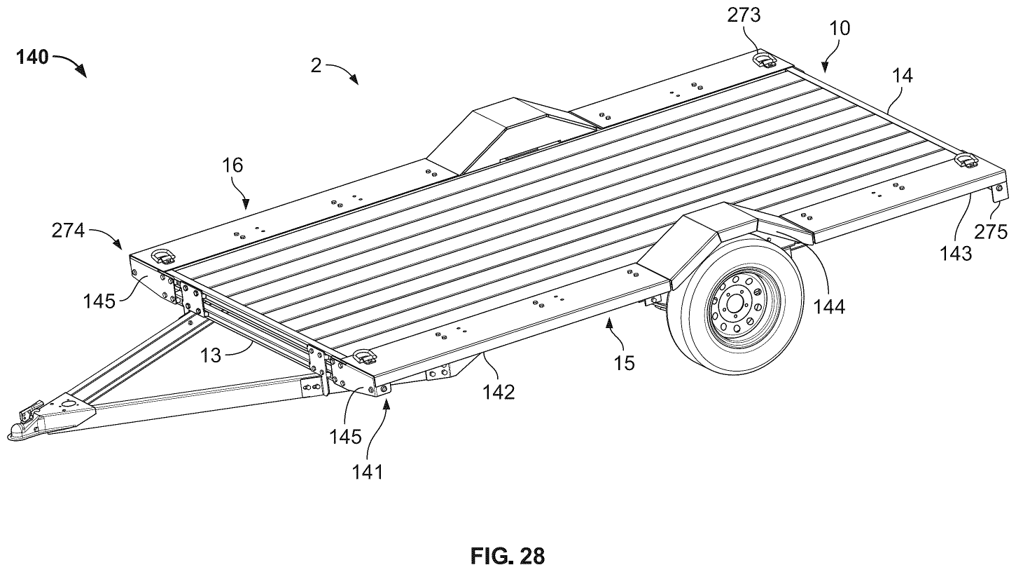

Referring to FIG. 27, the rear ramp storage system 130 is shown in the deployed configuration. The ramp covers 132 located near both the first side 15 and the second side 16 are rotated to expose end portions of the ramp 131. The ramp 131 may be unfolded from the storage configuration to the deployed configuration. The ramp 131 includes a plurality of ramp panels 81. In the preferred embodiment, the ramp 131 includes at least three ramp panels 81, a first side ramp panel 81a, a middle ramp panel 81b, and a second side ramp panel 81c. Each of the ramp panels includes a trailer end 266, a ground end 267, a trailer flange 268, ground support 269, a plurality of hinges 270, a ramp surface 271, and an underside surface (not shown). The trailer flanges 268 are movable relative to the ramp panels 81 and may be coupled to the trailer ends 266 of the ramp panels 81. The ground supports 269 are movable relative to the ground ends 267 and may be coupled to the ground ends 267. In the deployed configuration, the trailer flanges 268 are adjacent to the decking 242 and the upper rail frame 20a. The ground supports 269 are placed on the ground surface to provide the ramp 131 with stability when in use to move an object (not shown) on and/or off the trailer frame 10. The ramp surface 271 provides a surface to move an object on and/or off the trailer frame 10. The ramp surface may include a plurality of grips 272 to prevent objects from slipping off or on the ramp 131. The underside surface (not shown) is located on the opposite side of the ramp panels 81 from the ramp surface 271. In the deployed configuration, the underside surface is facing towards the ground surface. The ramp 131 includes a plurality hinges 270. The ramp panels 81 rotate about the hinges 270 to move between the storage configuration and the deployed configuration. The ramp 131 is foldable and may collapse and extend in an S-like manner. In the storage configuration, the first side ramp panel 81a may be overlapped with the middle panel 81b such that both of the ramp surfaces 271 of the first side ramp panel 81a and the middle ramp panel 81b are adjacent to each other. Also in the storage configuration, the second side ramp panel 81c may be overlapped with the middle panel 81b such that both of the underside surfaces of the second side ramp panel 81c and the middle ramp panel 81b are adjacent to each other. In the deployed configuration, the first side ramp panel 81a and the second side ramp panel 81c are rotated away from the middle ramp panel 81b to their respective deployed positions. In alternative embodiments, the ramp panels 81 may be oriented in different configurations, such that the ramp panels 81 may be extend and/or folded in various methods.

### Frame Extension System

FIG. 28 shows an accessory mounting system wherein the accessory mounting system comprises a frame extension system 140 to extend the overall width of the base trailer 2 for various purposes. The frame extension system 140 comprises a first side extension frame 141 and a second side extension frame 274. The first side extension frame 141 and the second side extension frame 274 allow for wide load loading and/or unloading. The first side extension frame 141 and the second side extension frame 274 provide a wide load with access to be driven or moved on and/or off the trailer frame 10 that require a wider footprint than the modular base trailer 2. The first side extension frame 141 extends from the front end 13 to the rear end 14 on the first side 15 of the trailer frame 10. The second side extension frame 274 extends from the front end 13 to the rear end 14 on the second side 16 of the trailer frame 10. The first side extension frame 141 is a mirror image of the second side extension frame 274. It is to be understood the first side extension frame 141 description below is applicable to the second side extension frame 274, but as its mirror image. The first side extension frame 141 includes a front extension 142, a rear extension 143, a fender extension 144, a front corner extension bracket 145, a rear corner extension bracket 275, and a D-ring 273. The front corner extension bracket 145 may be coupled to portions of the trailer frame 10 located on the front end 13 and the first side 15. The front extension 142 may be coupled to the front corner extension bracket 145 and to the fender extension 144. The fender extension 144 may be coupled to the front extension 142 and the rear extension 143. The rear extension 143 may be coupled to the fender extension 144 and the rear corner extension bracket 275. The rear corner extension bracket 275 may be coupled to portions of the trailer frame 10 located on the rear end 14 and the first side 15. The D-rings 273 may be coupled to portions of the front extension 142 and the rear extension 143. More specifically, the D-rings 273 may be coupled to the front extension 142 near the front end 13 and to the rear extension 143 near the rear end 14. In alternative embodiments, the D-rings 273 may be coupled to the front extension and/or rear extension 143 in various locations along the front extension 142 and/or the rear extension 143.

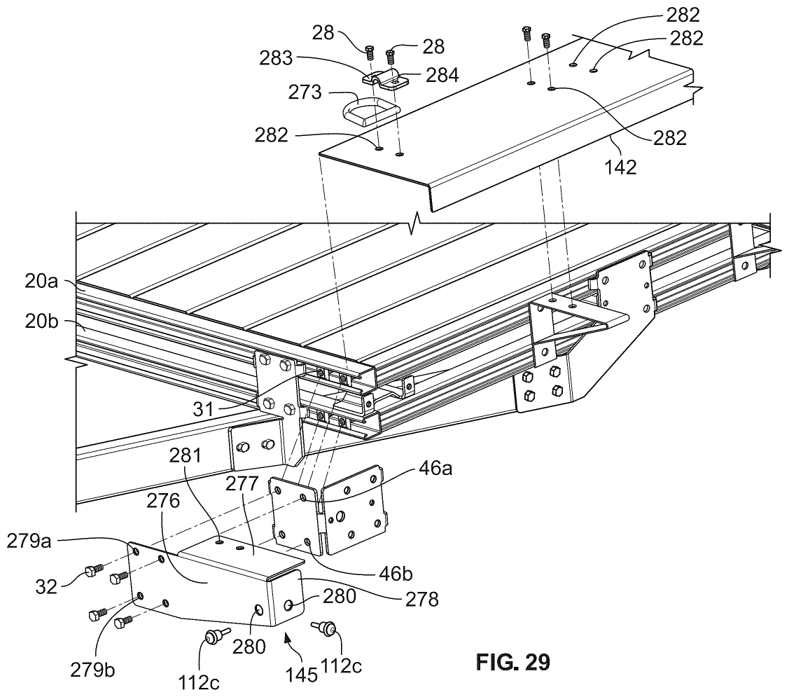

As shown in FIG. 29, the front corner extension bracket 145 includes a front plate 276, a shelf plate 277, and a lip plate 278. The front plate 276 includes at least one upper fastener receiver 279a and at least one lower fastener receiver 279b. In the preferred embodiment, the front plate 276 includes two upper fastener receivers 279a and two lower fastener receivers 279b. The upper fastener receivers 279a are spaced apart similarly to the upper fastener receivers 46a of the corner bracket 40. The lower fastener receivers 279a are spaced apart similarly to the lower fastener receivers 46b of the corner bracket 40. The front plate 276 also includes a light aperture 280. The light aperture 280 is configured to receive the corner light 112c. The light aperture 180 and the upper fastener receivers 279a and the lower fastener receivers 279b are located on opposite sides of the front plate 276. The shelf plate 277 extends from the front plate 276 at a 90-degree angle approximately and is adjacent to the top wall 22 of the rail 20 forming the upper rail frame 20a and the decking 242. The shelf plate 277 includes secondary fastener receivers 281. In the preferred embodiment, the shelf plate 277 includes two secondary fastener receivers 281. The secondary fastener receivers 281 are located distally relative to the front plate 276. The lip plate 278 extends from the front plate 276 at a 90-degree angle approximately extending in the direction along the first side 15 of the trailer frame 10. The lip plate 278, the shelf plate 277, and the front plate 276 are all generally perpendicular to each other. The lip plate 278 includes the light aperture 280. The light aperture 280 is configured to receive the corner light 112c.

Referring to FIG. 29, the front extension 142 includes a plurality of secondary fastener receivers 282 located along the length of the front extension 142. In the preferred embodiment, the D-ring 273 may be coupled to the front extension 142 by inserting the second bolts 28 through a D-ring bracket 283 having a pair of bracket apertures 284 into the secondary fastener receivers 282 located near the front end 13 of the trailer frame 10. The nuts 252 are secured to the second bolts 28 inserted through the bracket apertures 284 and the front extension 142 to secure the D-ring 273 to the front extension 142.

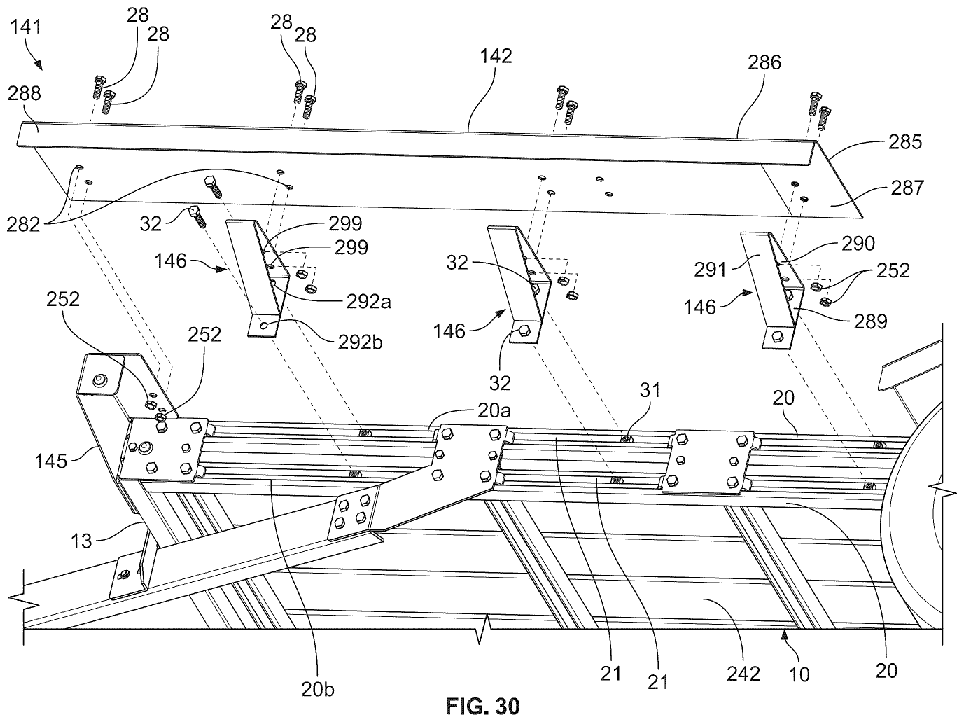

Referring to FIG. 29, the front corner extension bracket 145 may be coupled to the trailer frame 10 by inserting the first bolts 32 through the aligned upper fastener receivers 279a of the front corner extension bracket 145, the upper fastener receivers 46a of the corner bracket 40, and into the corresponding nuts 31 located in the channels 21 of the rails 20 forming portions of the upper rail frame 20a. The first bolts 32 may also be inserted through the aligned lower fastener receivers 279b of the front corner extension bracket 145, the lower fastener receivers 46b of the corner bracket 40, and into the corresponding nuts 31 located in the channels 21 of the rails 20 forming portions of the lower rail frame 20b. The front extension 142 may be coupled to the front corner extension bracket 145. The secondary fastener receivers 282 on the front extension 142 may align with the secondary fasteners 281 on the shelf plate 277 of the front corner extension bracket 145 to permit second bolts 28 to be inserted through the secondary fastener receivers 282 and secondary fastener receivers 281 and secured with the nuts 252, see FIG. 30.

Referring to FIG. 30, the front extension 142 further includes an extension plate 285 having an upper surface 286 and a lower surface 287 located on the opposite side of the extension plate 285 from the upper surface 286. The front extension 142 is located above the upper rail frame 20a and the decking 242. The front extension 142 also includes an overhang plate 288. The overhang plate 288 extends downward at a 90-degree angle approximately from the extension plate 285 towards the upper rail frame 20a and the lower rail frame 20b. The front extension 142 includes the secondary fastener receivers 282 located along the length of the front extension 142. The secondary fastener receivers 282 located nearest to the front end 13 of the trailer frame 10 may receive second bolts 28 to couple the front extension 142 to the front corner extension bracket 145. The second bolts 28 coupling the front extension 142 and the front corner extension bracket 145 together may be secured with nuts 252.

Referring to FIG. 30, the first side extension frame 141 also includes at least one outrigger bracket 146. The outrigger brackets 146 are adjacent to the lower surface 287 of the extension plate 285. The outrigger brackets 146 each include a rail plate 289, a shelf plate 290 and a diagonal arm 291. The shelf plate 190 extends from the rail plate 289 at a 90-degree angle approximately away from the trailer frame 10. The rail plate 289 may be substantially perpendicular to the shelf plate 290. The diagonal arm 291 extends from a middle portion of the rail plate 289 at an upward angle towards the shelf plate 290. The rail plate 289, the shelf plate 290, and the diagonal arm 291 form a triangular shape. The rail plate 289 also includes at least one upper fastener receiver 292a and at least one lower fastener receiver 292b. The upper fastener receiver 292a is operable to receive the first bolt 32 for coupling the outrigger bracket 146 to the upper rail frame 20a on the first side 15 of the trailer frame 10. The lower fastener receiver 292b is operable to receive the first bolt 32 for coupling the outrigger bracket 146 to the lower rail frame 20b on the first side 15 of the trailer frame 10. The first bolts 32 may be inserted through the upper fastener receiver 292a and the lower fastener receiver 292b and into the corresponding nuts 31 located in the channels 21 of the rails 20 forming the respective portions of the upper rail frame 20a and the lower rail frame 20b to secure the outrigger bracket 146 to the first side 15 of the trailer frame 10. The shelf plate 290 includes at least one secondary fastener receiver 299. The secondary fastener receivers 299 are operable to receive the second bolts 28 for coupling the front extension 142 to the outrigger brackets 146 and/or other accessories for the trailer frame 10, such as the D-ring 273, see FIG. 29. The nuts 252 may be fastened to the second bolts 28 to secure the front extension 142 to the outrigger brackets 146. In the illustrated embodiment, the front extension 142 is coupled to the front corner extension bracket 145 and three outrigger brackets 146.

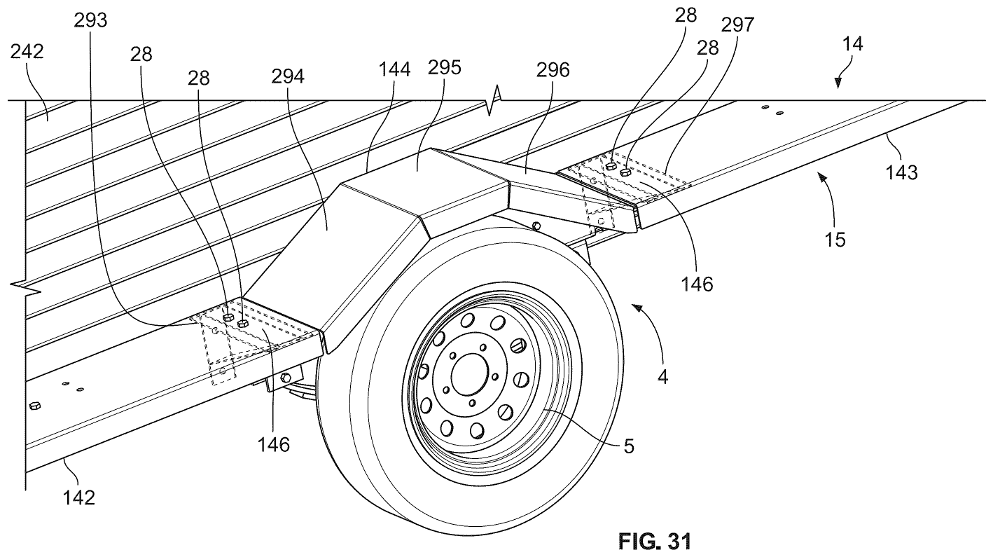

Referring to FIG. 31, the front extension 142 is coupled and secured to the fender extension 144. The fender extension 144 may also be coupled and secured to the rear extension 143. The fender extension 144 may be secured over the wheel 5 of the axle and wheel assembly 4. The fender extension 144 includes a front flap 293, a front ramp portion 294, a level portion 295, a rear ramp portion 296, and a rear flap 297. The front flap 293 may be coupled to a portion of the front extension 142 located near the wheel 5. One of the outrigger brackets 146 may be used to couple and secure the front flap 293 and the front extension 142 to each other using second bolts 28. One of the outrigger brackets 146 may be used to couple and secure the front flap 293 and the front extension 142 to the first side 15 of the trailer frame 10. The front ramp portion 294 may extend from the front flap 293 at an upward angle towards the rear end 14 of the trailer frame 10. The level portion 295 extends from the front ramp portion 294 at angle in which the level portion 295 is parallel with the decking 242. The level portion 295 may be the uppermost portion of the frame extension system 140. The rear ramp portion 296 extends from the level portion 295 in a downward angle towards the rear end 14 of the trailer frame 10. The rear ramp portion 296 may be a mirror image of the front ramp portion 294 with the level portion 295 located between the front ramp portion 294 and the rear ramp portion 296. The rear flap 297 may extend from the rear ramp portion 296 towards the rear end 14 of the trailer frame 10. The rear flap 297 and the front flap 293 may extend along the trailer frame 10 in the same plane. The rear flap 297 may be coupled to a portion of the rear extension 143 located near the wheel 5. One of the outrigger brackets 146 may be used to couple and secure the rear flap 297 and the rear extension 143 to each other using second bolts 28. One of the outrigger brackets 146 may be used to couple and secure the rear flap 297 and the rear extension 143 to the first side 15 of the trailer frame 10. The front flap 293, the front ramp portion 294, the level portion 295, the rear ramp portion 296, and the rear flap 297 form a generally arcuate shape. In alternative embodiments, the fender extension 144 may also be non-arcuate in shape.

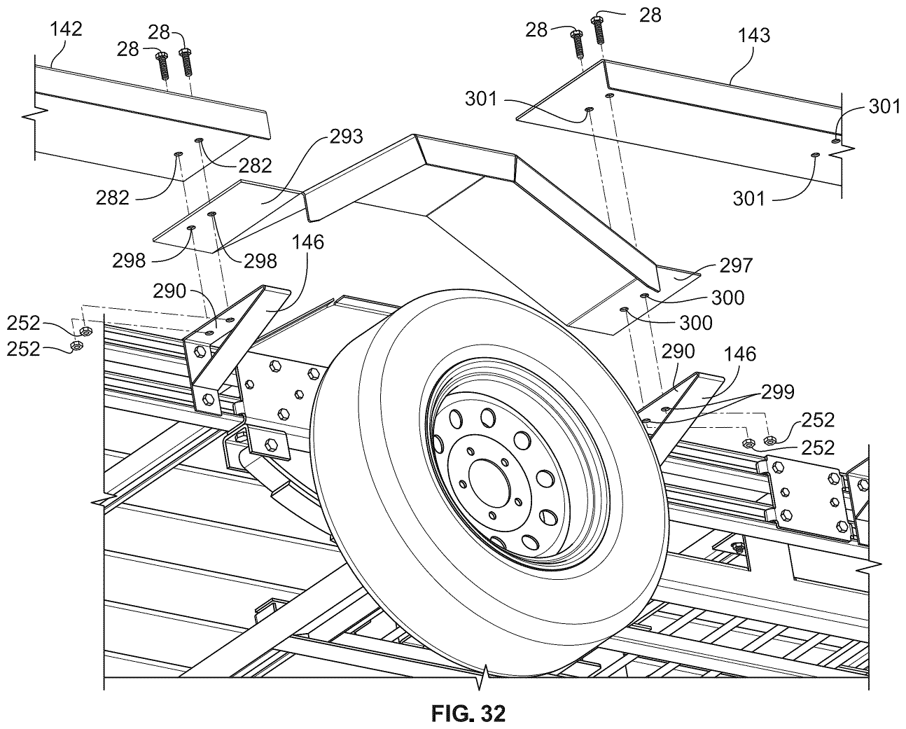

Referring to FIG. 32, the front flap 293 includes at least one secondary fastener receiver 298. In the exemplary embodiment, the secondary fastener receivers 298 located on the front flap 293 may align with the secondary fastener receivers 282 located on the front extension 142 nearest to the rear end 14 of the trailer frame 10. The secondary fastener receivers 298 located on the front flap 293 may also align with the secondary fastener receivers 299 located on the shelf plate 290 of the outrigger bracket 146. The second bolts 28 may be inserted through the aligned secondary fastener receivers 282 located in the front extension 142, the secondary fastener receivers 298 located in the front flap 293, and the secondary fastener receivers 299 located in the shelf plate 290 of the outrigger bracket 146. The second bolts 28 may be fastened to nuts 252 to secure the front extension 142, the front flap 293, and the outrigger bracket 146 to each other. The rear flap 297 includes at least one secondary fastener receiver 300. The rear extension 143 may include a plurality of secondary fastener receivers 301 spaced apart from each other along the length of the rear extension 143. In the exemplary embodiment, the secondary fastener receivers 300 located on the rear flap 297 may align with the secondary fastener receivers 301 located on the rear extension 143 nearest to the front end 13 of the trailer frame 10. The secondary fastener receivers 300 located on the rear flap 297 may also align with the secondary fastener receivers 299 located on the shelf plate 290 of another one of the outrigger brackets 146. The second bolts 28 may be inserted through the aligned secondary fastener receivers 301 located in the rear extension 143, the secondary fastener receivers 300 located in the rear flap 297, and the secondary fastener receivers 299 located in the shelf plate 290 of the outrigger bracket 146. The second bolts 28 may be fastened to nuts 252 to secure the rear extension 143, the rear flap 297, and the outrigger bracket 146 to each other.

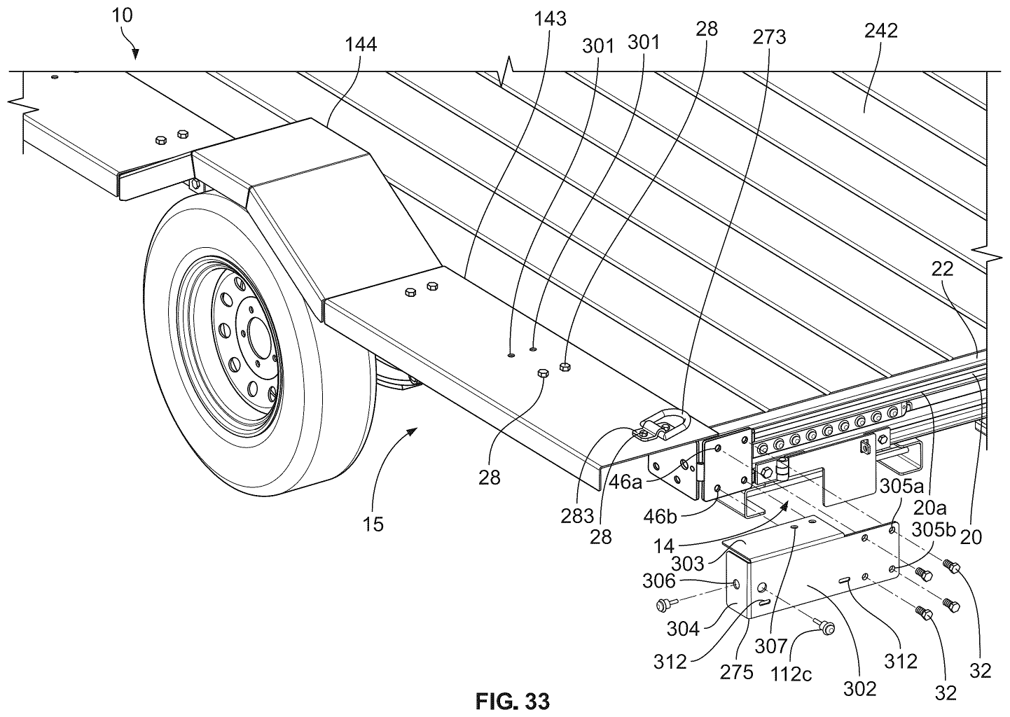

Referring to FIG. 33, the rear corner extension bracket 275 includes a rearward facing plate 302, a shelf plate 303, and a lip plate 304. The rearward facing plate 302 includes at least one upper fastener receiver 305a and at least one lower fastener receiver 305b. In the preferred embodiment, the rearward facing plate 302 includes two upper fastener receivers 305a and two lower fastener receivers 305b. The upper fastener receivers 305a are spaced apart similarly to the upper fastener receivers 46a of the corner bracket 40. The lower fastener receivers 305b are spaced apart similarly to the lower fastener receivers 46b of the corner bracket 40. The rearward facing plate 302 also includes a light aperture 306. The light aperture 306 is configured to receive the corner light 112c. The light aperture 306 and the upper fastener receivers 305a and the lower fastener receivers 305b are located on opposite ends of the rearward facing plate 302. The rearward facing plate 302 also includes at least one slot 312. In the preferred embodiment, the rearward facing place 302 includes two slots 312 spaced apart horizontally along the length of the rearward facing place 302. The slots 312 are located between the lower fastener receivers 305b and the lip plate 304. The slots 312 may be configured to receive a license plate (not shown) or some other accessory able to be coupled to the rearward facing plate 302 using the slots 312. The shelf plate 303 extends from the rearward facing plate 302 at a 90-degree angle approximately and is adjacent to the top wall 22 of the rails 20 forming the upper rail frame 20a and the decking 242 near the rear end 14 of the trailer frame 10. The shelf plate 303 includes secondary fastener receivers 307. In the preferred embodiment, the shelf plate 303 includes two secondary fastener receivers 307. The secondary fastener receivers 307 are located distally relative to the rearward facing plate 302. The lip plate 304 extends from the rearward facing plate 302 at a 90-degree angle approximately, extending in the direction along the first side 15 of the trailer frame 10. The lip plate 304, the shelf plate 303, and the rearward facing plate 303 are all generally perpendicular to each other. The lip plate 304 includes the light aperture 306. The light aperture 306 is configured to receive the corner light 112c.

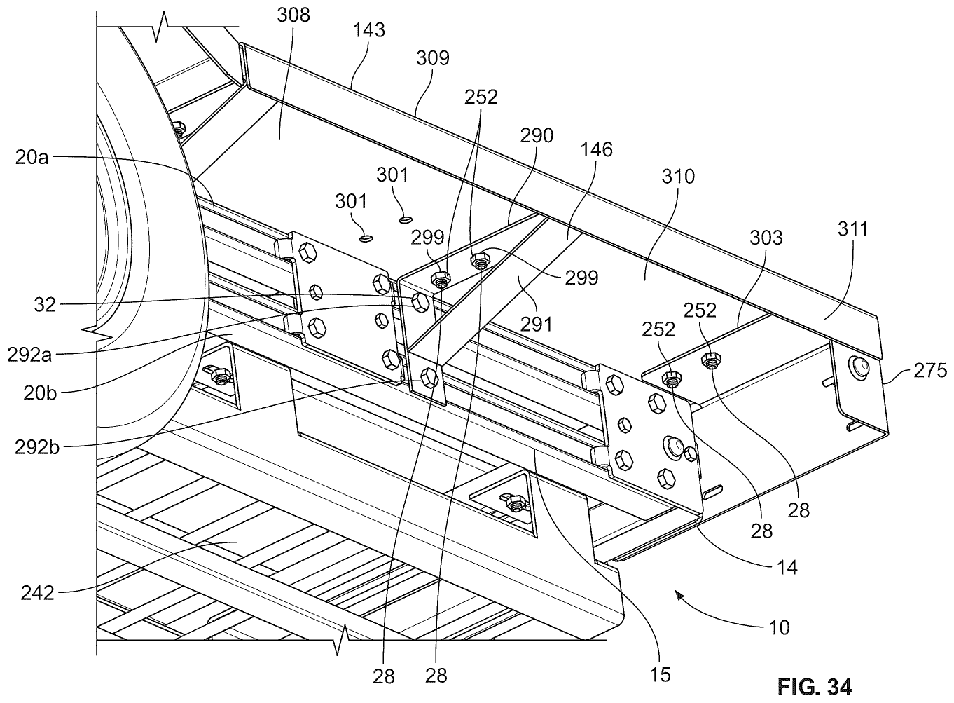

Referring to FIG. 33, the rear extension 143 includes the plurality of secondary fasteners 301 located along the length of the rear extension 143. In the preferred embodiment, the D-ring 273 may be coupled to the rear extension 143 by inserting second bolts 28 through the D-ring bracket 283 having the pair of bracket apertures 284 into the secondary fastener receivers 301 located near the rear end 14 of the trailer frame 10. The nuts 252, see FIG. 34, may secure the second bolts 28 inserted through the bracket apertures 284 and the rear extension 143 to secure the D-ring 273 to the rear extension 143.

Referring to FIG. 33, the rear corner extension bracket 275 may be coupled to the trailer frame 10 by inserting first bolts 32 through the upper fastener receivers 305a of the rear corner extension bracket 275, the upper fastener receivers 46a of the corner bracket 40, and into the corresponding nuts 31 located in the channels 21 of the rails 20 forming portions of the upper rail frame 20a. The first bolts 32 may also be inserted through the lower fastener receivers 305b of the rear corner extension bracket 275, the lower fastener receivers 46b of the corner bracket 40, and into the corresponding nuts 31 located in the channels 21 of the rails 20 forming portions of the lower rail frame 20b. The rear extension 143 may be coupled to the rear corner extension bracket 275. The secondary fastener receivers 301 located on the rear extension 143 and the secondary fastener receivers 307 on the shelf plate 303 of the rear corner extension bracket 275 may align with each other to permit the second bolts 28 to be inserted through the secondary fastener receivers 301 and the secondary fastener receivers 307 and secured with nuts 252, see FIG. 34.

Referring to FIG. 34, the rear extension 143 further includes an extension plate 308 having an upper surface 309 and a lower surface 310 located on the opposite side of the extension plate 308 from the upper surface 309. The rear extension 143 is located above the upper rail frame 20a and the decking 242. The rear extension 143 also includes an overhang plate 311. The overhang plate 311 extends downward at a 90-degree angle approximately from the extension plate 308 towards the upper rail frame 20a and the lower rail frame 20b. The rear extension 143 includes the secondary fastener receivers 301 located along the length of the rear extension 143. The secondary fastener receivers 301 located nearest to the rear end 14 of the trailer frame 10 may receive second bolts 28 to couple the rear extension 143 to the rear corner extension bracket 275. The second bolts 28 coupling the rear extension 143 and the rear corner extension bracket 275 together may be secured with nuts 252.

Referring to FIG. 34, the outrigger brackets 146 may also couple the rear extension 143 to the trailer frame 10 near the rear end 14 on the first side 15. The upper fastener receiver 292a is operable to receive first bolt 32 for coupling the outrigger bracket 146 to the upper rail frame 20a on the first side 15 of the trailer frame 10. The lower fastener receiver 292b is operable to receive the first bolt 32 for coupling the outrigger bracket 146 to the lower rail frame 20b on the first side 15 of the trailer frame 10. The first bolts 32 may be inserted through the upper fastener receivers 292a and the lower fastener receiver 292b and into the corresponding nuts 31 located in the channels 21 of the rails 20 forming the respective portions of the upper rail frame 20a and the lower rail frame 20b to secure the outrigger brackets 146 to the first side 15 of the trailer frame 10. The secondary fastener receivers 299 are operable to receive the second bolts 28 for coupling the rear extension 143 to the outrigger brackets 146 and/or other accessories for the trailer frame 10, such as the D-ring 273, see FIG. 33. The nuts 252 may be fastened to the second bolts 28 to secure the rear extension 143 to the outrigger brackets 146. In the illustrated embodiment, the rear extension 143 is fastened to one rear corner extension bracket 275 and at least one outrigger bracket 146. In some embodiments, the outrigger bracket 146 comprises the shelf plate 290 with a longer length than that shown in the illustrated embodiment, and therefore a longer diagonal arm 291, such that the outrigger bracket 146 may support wider frame extensions. It is to be understood that the present disclosure contemplates multiple outrigger brackets selectively mounted at a location on the trailer frame 10 and sufficient to support frame extensions that hold cargo of various lengths, widths, and weight.

### Fence System

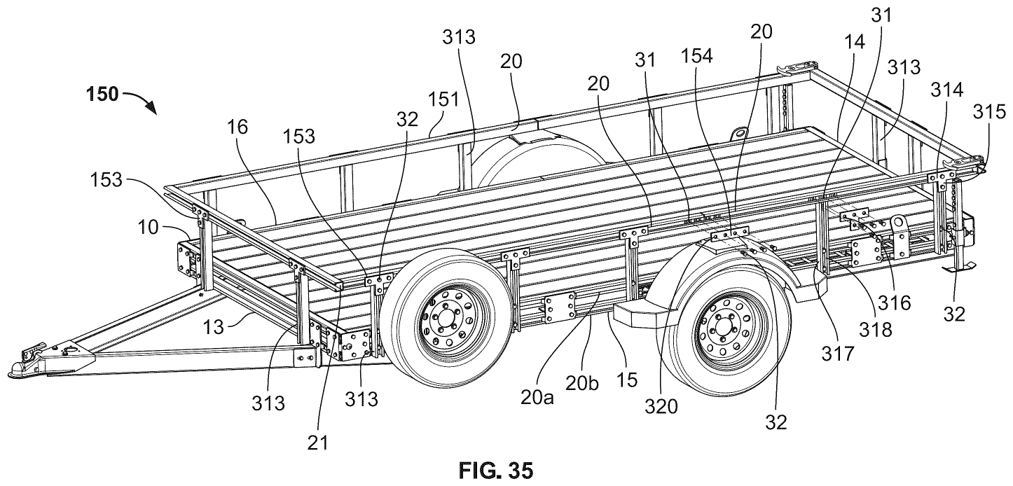

FIG. 35 shows an accessory mounting system wherein the accessory mounting system comprises a full fence system 150 secured to the trailer frame 10, operable to prevent unwanted dislodging of cargo. The full fence system 150 comprises a plurality of rails 20 that form a top railing 151, a plurality of upright rails 313, at least one T-plate bracket 153, and at least one I-plate bracket 154. The upright rails 313 may be perpendicularly coupled to the top railing 151. The upright rails 313 may also be coupled to the upper rail frame 20a and the lower rail frame 20b. The upright rails 313 may extend between the top railing 151 and the trailer frame 10. The top railing 151 is spaced apart vertically from the upper rail frame 20a and extends the entire perimeter of the trailer frame 10. In the preferred embodiment, the top railing 151 may be the same dimensions and configurations as the upper rail frame 20a and/or the lower rail frame 20b. In alternative embodiments, the top railing 151 may have different configurations and dimensions than the upper rail frame 20a and/or the lower rail frame 20b. The T-plate brackets 153 may couple portions of the top railing 151 to the upright rails 313. The T-plate brackets 153 include a horizontal portion 314 and a vertical portion 315. The horizontal portion 314 includes at least one fastener receiver 316 and the vertical portion 315 includes at least one fastener receiver 316. The upright rails 313 include a C-shaped sidewall 317 forming a channel 318 extending the length of the upright rails 313. The channel 318 is configured to receive the nuts 31, similar to the rails 20. The upright rails 313 have similar dimensions and configurations as the cross-member rails 19 and the rails 20, except for being different lengths. For example, the channel 21 and the channel 318 are both configured to receive the nuts 31 at various positions along the lengths of the channels 21 and the channels 318. The first bolts 32 may be inserted through the fastener receivers 316 located in the horizontal portion 314 of the T-bracket 153 and into the corresponding nuts 31 located in the channel 21 located in the rails 20 forming portions of the top railing 151. The first bolts 32 may be inserted through the fastener receivers 316 located in the vertical portion 315 of the T-bracket 153 and into the corresponding nuts 31 located in the channel 318 located in the upright rails 313. The upright rails 313 also include at least one fastener receiver 319 located in the channel 318. The upright rails 313 may be coupled to the trailer frame 10 by inserting the first bolt 32 through one of the fastener receivers 319 aligned with the upper rail frame 20a and into the corresponding nut 31 located in the channel 21 of the rail 20 forming a portion of the upper rail frame 20a. The first bolt 32 may be inserted through another fastener receiver 319 aligned with the lower rail frame 20b and into the corresponding nut 31 located in the channel 21 of the rail 20 forming a portion of the lower rail frame 20b. The I-plate bracket 154 may be coupled to two adjacent rails 20 forming a portion of the top railing 151. The I-plate bracket 154 includes at least two fastener receivers 320. The fastener receivers 320 on the I-plate bracket 154 may be aligned with the corresponding nuts 31 located in the channels 21 of the rails 20 forming portions of the top railing 151. The I-plate bracket 154 is secured to the top railing 151 by inserting first bolts 32 through the fastener receivers 320 and into the corresponding nuts 31 located in the channels 21 of the rails 20 forming portions of the top railing 151. The upright rails 313 may be located on the front end 13, the rear end 14, the first side 15, and the second side 16 of the trailer frame 10.

### Tailgate System

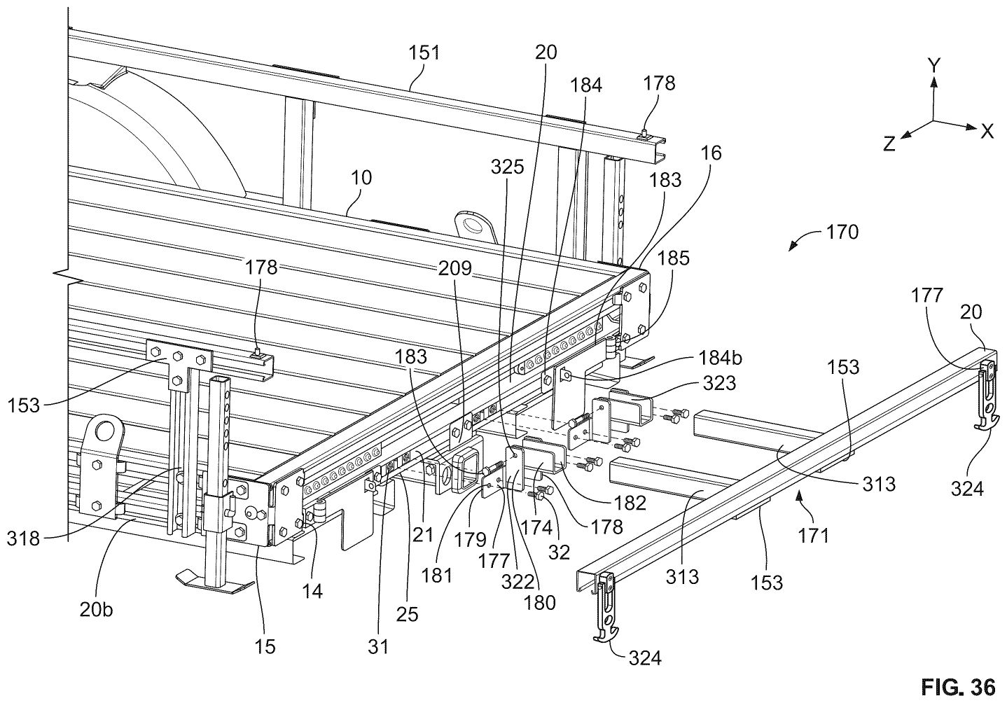

Referring to FIG. 36, the trailer frame 10 may also include an accessory mounting system having a tailgate system 170. The tailgate system 170 may be selectively lowered to provide access to the rear end 14 of the trailer frame 10 for loading and unloading cargo and selectively raised to prevent unwanted dislodging of cargo. The tailgate system 170 includes a tailgate 171, a first upright bracket 322, a second upright bracket 323, and a latch assembly 324. The first upright bracket 322 and the second upright bracket 323 are located on the rear end 14. More specifically, the first upright bracket 322 is located more near the first side 15 of the trailer frame 10 and the second upright bracket 323 is located more near the second side 16 of the trailer frame. The following description directed towards the first upright bracket 322 may also be applied to the second upright bracket 323. The first upright bracket 322 and the second upright bracket 323 are similar in structure and function, except for location on the rear end 14 of the trailer frame 10. The first upright bracket 322 includes a first side L-shaped bracket 177 and a second side L-shaped bracket 178. The first side L-shaped bracket 177 includes a trailer attachment portion 179 and an upright rail portion 180. The second side L-shaped bracket 178 is a mirror image of the first side L-shaped bracket 177. The trailer attachment portion 179 includes at least one fastener receiver 181. In the preferred embodiment, the trailer attachment 179 includes two fastener receivers 181. The first side L-shaped bracket 177 and the second side L-shaped bracket 178 may be coupled to the trailer frame 10 by inserting the first bolts 32 through the fastener receivers 181 and into the corresponding nuts 31 located in the channels 21 of the rails 20 forming the lower rail frame 20b. The upright rail portion 180 may include a secondary fastener receiver 325 located above the fastener receivers 181 on the trailer attachment portion 179. The first side L-shaped bracket 177 and the second side L-shaped bracket 178 are spaced apart horizontally on the lower rail frame 20b a distance to receive an upright rail holder 182. The upright rail holder 182 forms a C-shaped channel configured to receive a portion of the upright rails 313 located on the rear end 14 of the trailer frame 10. Each of the parallel sidewalls of the upright rail holder 182 includes a secondary fastener receiver, not shown, to align with the secondary fastener receiver 325 located on the upright rail portions 180. The upright rail portions 180 of both the first L-shaped bracket 177 and the second side L-shaped bracket 178 may be coupled to the upright rail holder 182 by inserting a pin 183 or another type of fastening device, into the secondary fastener receivers 325 and the secondary fastener receivers located in the upright rail holder 182. The upright rail holder 182 also includes a fastener receiver 184, not shown, located in the sidewall perpendicular to the sidewalls having secondary fastener receivers receiving the pin 183. The upright rails 313 may be coupled to the upright rail holder 182 by inserting the first bolt 32 through the fastener receiver 184 and into the corresponding nut 31 located in the channel 318 of the upright rail 313. The upright rail holder 182 may be pivotable relative to the upright rail portions 180. In the preferred embodiment, the first upright bracket 322 is pivotably coupled to one of the upright rails 313 located on the rear end 14 of the trailer frame 10 and the second upright bracket 323 is pivotably coupled to another one of the upright rails 313 located on the rear end 14 of the trailer frame 10. Each of the upright rails 313 coupled to the first upright bracket 322 and the second upright bracket 323 at one end may be coupled to the rail 20 forming a portion of the top railing 151 with the T-plate bracket 153 at the opposite end. The pin 183 inserted through the secondary fastener receivers located in the upright rail holder 182 and the secondary fastener receivers 325 located in the first upright rail portions 180 creates a pivot joint with limited rotational movement to permit the tailgate 171 to be selectively lowered to provide access to the rear end 14 of the trailer frame 10 for loading and unloading of cargo and selectively raised to prevent unwanted dislodging of cargo.

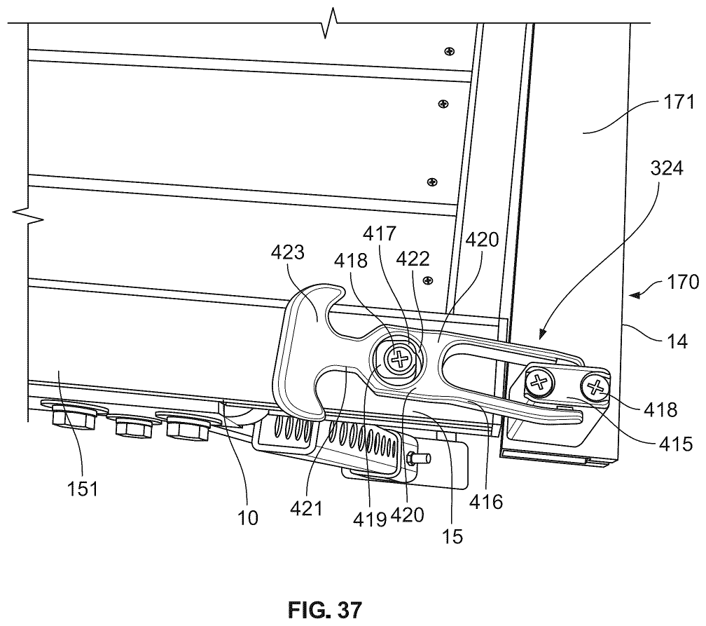

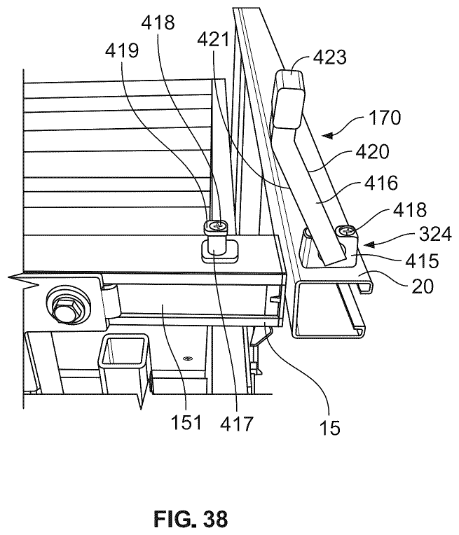

Referring to FIG. 37 and FIG. 38, the latch assembly 324 is shown in a closed configuration. The latch assembly 324 may be pivotable between an open configuration (FIG. 38) and the closed configuration. The tailgate system 170 may include multiple latch assemblies 324. For example, the latch assembly 324 may be located near the first side 15 of the trailer frame 10 and another latch assembly 324 may be located near the second side 16. The latch assembly 324 includes an attachment joint 415, a latch 416, and a post 417. The post 417 may extend from a portion of the top railing 151 near the rear end 14 of the trailer frame 10. The post 417 is generally circular in shape and includes a screw 418 in the center of the post 417. The post 417 includes a lip 419 extending from an upper portion of the post 417. The attachment joint 415 may be coupled to one of the rails 20 forming a portion of the tailgate system 170. A set of the screws 418 may be used to fasten and secure the attachment joint 415 to the rail 20 forming a portion of the tailgate 171. The attachment joint 415 includes an aperture configured to receive a portion of the latch 416. The latch 416 is pivotable about the attachment joint 415, allowing the latch 416 to move between the open configuration and the closed configuration. The latch 416 includes a latching portion 420 and a handle portion 421. The latching portion 420 includes a post opening 422 to receive a portion of the post 417. The lip 419 extending from the post 417 overlaps with a portion of the latching portion 420 securing the latch 416 in the closed position. The handle portion 421 upwardly extends from the latching portion 420 away from the top railing 151. The handle portion 421 includes a gripping portion 423. The user may use the gripping portion 423 to hold onto and pull the latch 416 in an upward direction to release the latching portion 420 from the post 417 or to push the latch 416 in a downward direction to secure the latching portion 420 to the post 417. The latch 416 and the post 417 may be composed of a flexible material permitting the user to manually push and/or pull the latch 416 from the open configuration to the closed figuration.

### Undercarriage Ramp Storage System

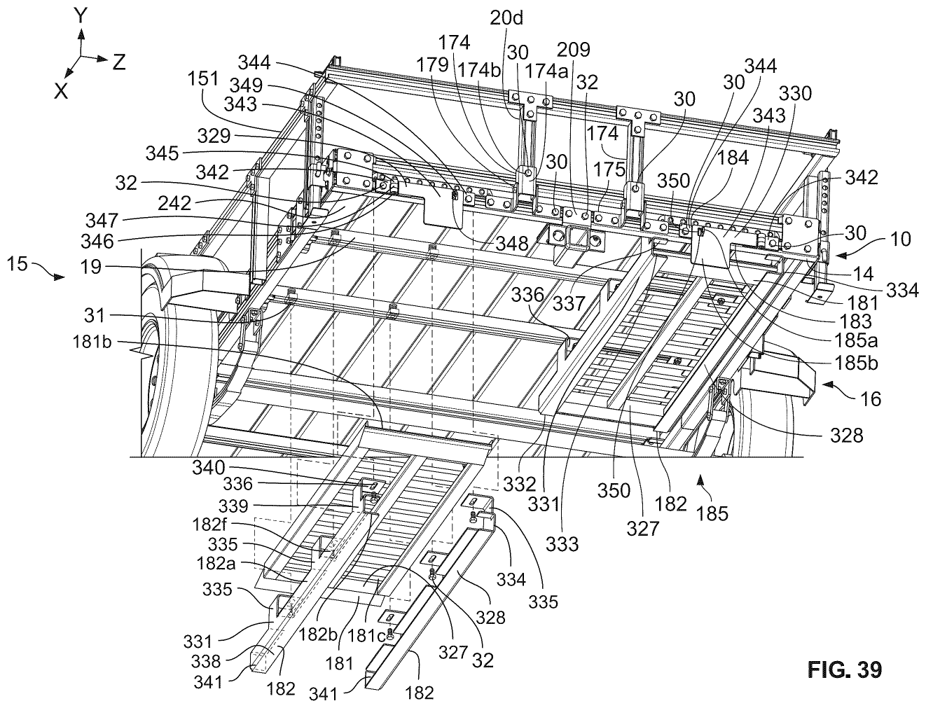

FIG. 39 shows an accessory mounting system wherein the accessory mounting system comprises an undercarriage ramp storage system 185 located adjacent the cross-member rails 19 supporting the decking 242. The undercarriage ramp storage system 185 includes at least two undercarriage ramps 327, at least two undercarriage ramp brackets 328, a first retaining bracket 329, and a second retaining bracket 330, which is a mirror image of the first retaining bracket 329. Each of the undercarriage ramps 327 are selectively stored within each of the undercarriage ramp brackets 328 during travel or selectively removed to facilitate the loading or unloading of cargo at the rear end 14 of the trailer frame 10. Each of the undercarriage ramp brackets 328 includes a first elongated c-shaped body 331 and a second elongated c-shaped body 334. The first elongated c-shaped body 331 is a mirror image of the second elongated c-shaped body 334. The following description for the first elongated c-shaped body 331 may be applicable to the mirror image of the second elongated c-shaped body 334. The first elongated c-shaped body 331 includes a front end 332, a rear end 333, a top wall 337, a bottom wall 338 and a sidewall 339 extending between the top wall 337 and the bottom wall 338, and a plurality of ramp bracket extensions 335 along the length of the first elongated c-shaped body 331 extending beyond the top wall 337 of the first elongated c-shaped body 331. Each of the ramp bracket extensions 335 include a rail attachment flange 336 extending from the ramp bracket extension 335 at a 90-degree angle approximately. The rail attachment flanges 336 are parallel with the top wall 337 and the bottom wall 338 of the first elongated c-shaped body 331. Each of the rail attachment flanges 336 may include a slot 340. Each of the rail attachment flanges 336 may be coupled to the cross-member rails 19 by being configured to receive the first bolt 32 through the slot 340 and into corresponding nuts 31 located in the channel 21 of the cross-member rails 19 extending between the first side 15 and the second side 16 of the trailer frame 10. The front end 332 of the first elongated c-shaped body 331 includes an end wall 341. The end wall 341 is located between the top wall 337 and the bottom wall 338. The end wall 341 extends from the sidewall 339 at a 90-degree angle approximately towards the other elongated c-shaped body, such as the second elongated c-shaped body 334. The end wall 341 prevents the undercarriage ramps 327 from extending beyond the end walls 341 or dislodging during periods of transport or other forms of use. For example, one of the undercarriage ramps 327 may be inserted into the first elongated c-shaped body 331 and the second elongated c-shaped body 334 of the undercarriage ramp bracket 328 from the rear end 333 and be pushed towards the end wall 341 of each of the first elongated c-shaped body 331 and the second elongated c-shaped body 334. The top wall 337 is spaced apart a distance from the bottom wall 338 to receive the undercarriage ramps 327 for a portion of the height of the undercarriage ramps 327. The front end 332 is spaced apart a distance from the rear end 333 to receive the length of the entire undercarriage ramps 327. In alternative embodiments, the ramp brackets 328 may be configured to only receive a portion of the length of the undercarriage ramps 327.

Referring to FIG. 39, the undercarriage ramps 327 are retained in the undercarriage ramp brackets 328 during periods of transport or storage by the first retaining bracket 329 and the second retaining bracket 330. The second retaining bracket 330 is a mirror image of the first retaining bracket 329. The description below is directed towards the first retaining bracket 329. It is to be understood the same description may be applicable to the mirror image of the second retaining bracket 330. The first retaining bracket 329 includes a hinge plate 342, a retaining plate 343, and a fastening plate 344. The hinge plate 342 includes a fastener receiver to receive the first bolt 32 to couple the hinge plate 342 to the rail 20 forming a portion of the lower rail frame 20b. The first bolt 32 may be inserted through the fastener receiver located in the hinge plate 342 and into the corresponding nut 31 located in the channel 21 of the rail 20 forming the rear end 14 of the lower rail frame 20b. The hinge plate 342 also includes a pivot point 345 to receive a pivot pin 346 to permit the retaining plate 343 and the hinge plate 342 to be pivotable relative to each other. The pivot point 345 includes a gap configured to receive a pivot portion 347 of the retaining plate 343. The pivot point 345 and the pivot portion 347 all include an opening. The openings align to permit the pivot pin 346 to extend between the two pivot portions 345 to permit the retaining plate 343 to be pivotable relative to the hinge plate 342. The fastening plate 344 includes a fastener receiver to receive the first bolt 32 to couple the fastener plate 344 to the rail 20 forming a portion of the lower rail frame 20b. The first bolt 32 may be inserted through the fastener receiver located in the fastening plate 344 and into the corresponding nut 31 located in the channel 21 of the rail 20 forming the rear end 14 of the lower rail frame 20b. The fastening plate 344 also includes a locking flange 348. The locking flange 348 extends from the fastening plate 344 at a 90-degree angle approximately away from the lower rail frame 20b. The locking flange 348 includes a locking aperture 349. The locking aperture 349 is configured to receive a locking device, not shown, such as a cotter pin, lock, etc. through the locking aperture 349. The retaining plate 343 includes a fastening plate opening 350. The fastening plate opening 350 is configured to permit the locking flange 348 to pass through to permit the retaining plate 343 to be adjacent to the fastening plate 344 in a closed position. In the closed position, as seen in FIG. 39, the retaining plate 343 is adjacent to the fastening plate 344 with the locking flange 348 extending through the fastening plate opening 350. The locking device, not shown, may be inserted through the locking aperture 349 to maintain the retaining plate 343 in the closed position and preventing the retaining plate 343 from pivoting away from the fastening plate 344. The locking device may be removed from the locking aperture 349 to permit the retaining plate 343 to pivot to an open position. The retaining plate 343 in the open position may permit the undercarriage ramps 327 to be inserted into the respective undercarriage ramp brackets 328. Once the undercarriage ramps 327 are fully inserted into the respective undercarriage ramp brackets 328, the retaining plate 343 may be pivoted from the open position to the closed position and locked by inserting the locking device through the locking aperture 349 to retain the undercarriage ramps 327 within the undercarriage ramp brackets 328 during periods of transport and/or storage. By removing the locking device from the locking aperture 349, the retaining plate 343 may pivot from the closed position to the open position to permit access to the undercarriage ramps 327. The first retaining bracket 329 and the second retaining bracket 330 maintain the undercarriage ramps 327 within the undercarriage ramp brackets 328 during periods of transport and/or storage.

### Spare Tire Bracket

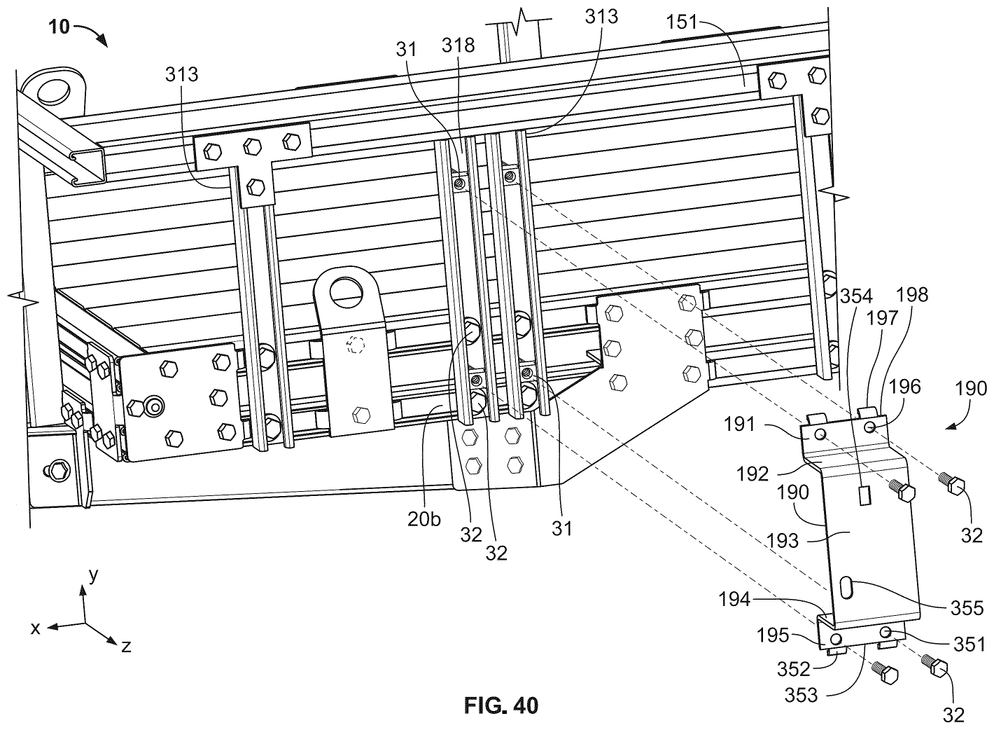

FIG. 40 shows another example of an accessory mounting system, a spare tire bracket 190. The spare tire bracket includes a top upright rail attachment portion 191, a top plate 192, a mounting plate 193, a bottom plate 194, and a bottom upright rail attachment portion 195. The top upright rail attachment portion 191 includes at least one fastener receiver 196 and at least one tab 197 extending from a top edge 198. The tabs 197 are configured to be inserted into the channels 318 of the upright rails 313 extending between the top railing 151 and the lower rail frame 20b. In the preferred embodiment, there are two fastener receivers 196 located near the top edge 198. The fastener receivers 196 are configured to receive the first bolts 32. The top plate 192 extends from the top upright rail attachment portion 191 at a 90-degree angle approximately on the side opposing the top edge 198. The top plate 192 extends away from the trailer frame 10. The mounting plate 193 extends from the top plate 192 at a 90-degree angle approximately. The top upright rail attachment portion 191 and the mounting plate 193 are substantially parallel with each other in different planes. The mounting plate 193 extends from the top plate 192 and towards the bottom plate 194. The bottom plate 194 extends from the mounting plate 193 at a 90-degree angle approximately. The bottom plate 194 extends from the mounting plate 193 and towards the bottom upright rail attachment portion 195. The bottom plate 194 extends towards the trailer frame 10 from the mounting plate 193. The bottom plate 194 and the top plate 192 are substantially parallel with each other. The bottom plate 194 and the top plate 192 are spaced apart from each other the length of the mounting plate 193. The bottom upright rail attachment portion 195 extends from the bottom plate 194 at a 90-degree angle approximately in the downwards direction away from the top plate 192. The bottom upright rail attachment portion 195 is substantially parallel with and in the same plane approximately as the top upright rail attachment portion 191. The bottom upright rail attachment portion 195 includes at least one fastener receiver 351 and at least one tab 352 extending from a bottom edge 353. The tabs 352 are configured to be inserted into the channels 318 of the upright rails 313 extending between the top railing 151 and the lower rail frame 20b. In the preferred embodiment, there are two fastener receivers 351 located near the bottom edge 353. The fastener receivers 351 are configured to receive the first bolts 32. The mounting plate 193 further includes a rectangular aperture 354 and an oval aperture 355. The rectangular aperture 354 and the oval aperture 355 are configured to receive the second bolts 28. In alternative embodiments, the rectangular aperture 354 and the oval aperture 355 may be of different shapes and be configured to receive the first bolts 32 or another type of fastening device.

Referring to FIG. 40, the spare tire bracket 190 may be coupled to at least one upright rail 313 extending between the top railing 151 and the rails 20 forming portions of the lower rail frame 20b. The uprights rails 313 used to secure the spare tire bracket 190 are coupled to the lower rail frame 20b and the upper rail frame 20a by inserting the first bolts 32 into the corresponding nuts 31 located in the channels of the rails 20 forming portions of the upper rail frame 20a and the lower rail frame 20b. The spare tire bracket 190 may be coupled to the trailer frame 10 by inserting the first bolts 32 through the fastener receivers 196 located in the top upright rail attachment portion 191 and into the corresponding nuts 31 located in the channels 318 of the upright rails 313. The spare tire bracket 190 may also be coupled to the trailer frame 10 by inserting the first bolts 32 through the fastener receivers 351 located in the bottom upright rail attachment portion 195 and into the corresponding nuts 31 located in the channels 318 of the uprights rails 313 located near the lower rail frame 20b. The tabs 197 may be inserted in the channels 318 of the upright rails 313 at a location above the nuts 31 in which the first bolts 32 being inserted through the fastener receivers 196 will be located. The tabs 352 may be inserted in the channels 318 of the upright rails 313 at a location below the nuts 31 in which the first bolts 32 being inserted through the fastener receivers 351 will be located.

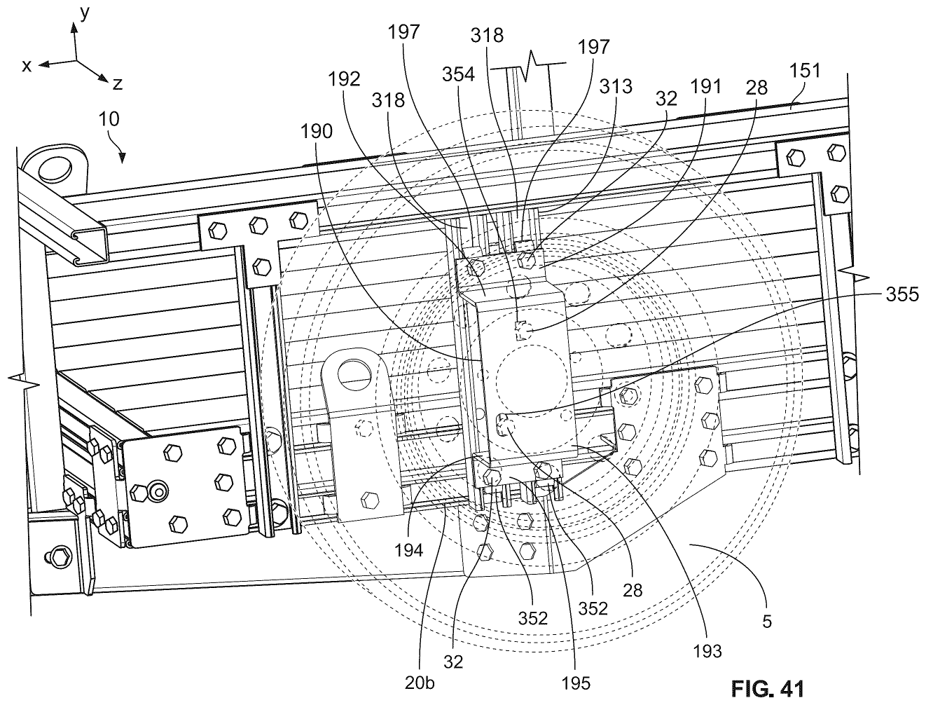

Referring to FIG. 41, the spare tire bracket 190 is shown coupled to the trailer frame 10 and the wheel 5. The tabs 197 are each configured to be inserted into one of the channels 318 of the upright rails 313 near the top railing 151. The tabs 352 are each configured to be inserted into one of the channels 318 of the upright rails 313 near the lower rail frame 20b. To secure the wheel 5 to the spare tire bracket 190, the second bolt 28 may be inserted through a lug hole located on the wheel 5 and be inserted through the rectangular aperture 354 located on the mounting plate 193. The nut 252 may be used to secure the wheel 5 to the mounting plate 193 by fastening to the second bolt 28 between the mounting plate 193 and the upright rails 313. Another second bolt 28 may be inserted through another lug hole located on the wheel 5 and be inserted through the oval aperture 355 located on the mounting plate 193. The nut 252 may be used to secure the wheel 5 to the mounting plate 193 by fastening to the second bolt 28 between the mounting plate 193 and the upright rails 313. The spare tire bracket 190 may be coupled to the upright rails 313 with the first bolts 32. In the preferred embodiment, four first bolts 32 are used to couple the spare tire bracket 190 to the upright rails 313. More specifically, two first bolts 32 are inserted through the top upright rail attachment portion 191 and coupled to the upright rails 313 near the top railing 151. Two additional first bolts 32 are inserted through the bottom upright rail attachment portion 195 and coupled to the upright rails 313 near the rails 20 forming a portion of the lower rail frame 20b. The height of the top plate 192 and the bottom plate 194 corresponds to the relative width of the wheel 5 such that the wheel does not press against the trailer frame 10, including portions of the top railing 151. In the preferred embodiment, there is a gap between the wheel 5 and the trailer frame 10 and the top railing 151 when the wheel 5 is mounted and secured to the spare tire bracket 190.

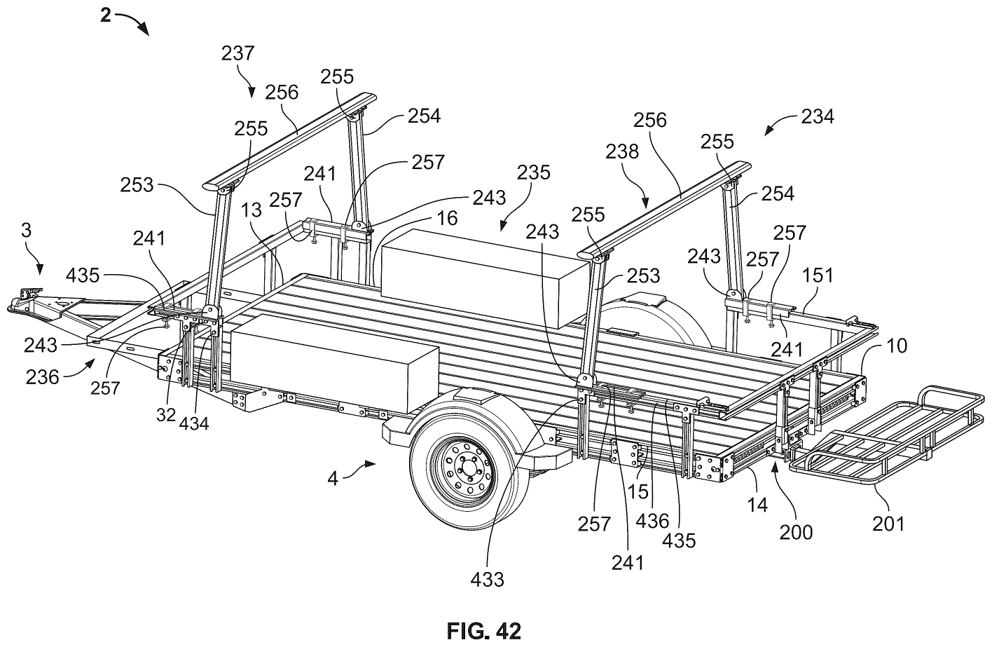

Referring to FIG. 42, the modular base trailer 2 may further be modified with additional accessories or configurations such as a hitch assembly 200, a rack assembly 234, a toolbox assembly 235, and/or a tongue tray assembly 236. The hitch assembly 200 may be coupled to the rear end 14 of the trailer frame 10. The rack assembly 234 may be coupled to portions of the top railing 151 near the front end 13 and the rear end 14 of the trailer frame 10. The toolbox assembly 235 may be coupled to the first side 15 and/or the second side 16 of the trailer frame 10. The toolbox assembly 235 may be located between the front end 13 and the axle and wheel assembly 4. The tongue tray assembly 236 may be coupled to the front end 13 of the trailer frame 10 near the trailer tongue assembly 3. All or some of the aforementioned accessories or configurations may be coupled to the base trailer 2 based upon the user preference.

### Rack Assembly

FIG. 42 shows an accessory mounting system wherein the accessory mounting system comprises the rack assembly 234 having a first rack 237 and a second rack 238. The rack assembly 234 provides the option to users to store items or tools, such as ladders (not shown), extending between the first rack 237 and the second rack 238. Additionally, items or tools may also be attached to either the first rack 237 or the second rack 238 by using a fastening device or being coupled together. The first rack 237 is located near the front end 13 and extends between the first side 15 and the second side 16 of the trailer frame. The second rack 238 is located near the rear end 14 and extends between the first side 15 and the second side 16 of the trailer frame 10. The first rack 237 is a mirror image of the second rack 238. It is to be understood the first rack 237 description below is applicable to the second rack 238, but as its mirror image. The first rack 237 includes at least two base plates 241, at least two lower post brackets 243, a first post support 253, a second post support 254, at least two upper post brackets 255, at least two rack rails 435, and a crossbar support 256. Each of the base plates 241 may be coupled to the rack rails 435 forming portions of the top railing 151 with a clamp 257. In the preferred embodiment, each base plate 241 may be secured to the top railing 151 with at least two clamps 257. The rack rails 435 extend between one of the upright rails 313 and the rail 20 forming a portion of the top railing 151 near the rear end 14 of the trailer frame 10. The rack rails 435 have similar dimensions and configurations at the rails 20, the cross member rails 19, and the upright rails 313, except for the length. The rack rails 435, cross member rails 19, rails 20, and the upright rails 313 only vary in length. Therefore, the rack rails 435, cross member rails 19, rails 20, and upright rails 313 may be interchangeable in various locations on the trailer frame 10.

Referring to FIG. 42, the first rack 237 may be coupled to a portion of the rack rail 435 forming a portion of the top railing 151. The rack rails 435 may be coupled to the trailer frame 10 with upright rails 313. The upright rails 313 may be coupled to portions of the rack rails 435 with a L-bracket 433. The L-bracket 433 provides stability and structure reinforcement between the trailer frame 10 and the rack rails 435 when the first rack 237 and/or the second rack 238 are coupled to the trailer frame 10. The L-bracket 433 includes fastener receivers 434 configured to receive the first bolts 32. In the preferred embodiment, the L-bracket 433 includes three fastener receivers 434. Two of the first bolts 32 may be inserted through the fastener receivers 434 and be inserted into corresponding nuts 31 located in a channel 436 of the rack rails 435 forming portions of the top railing 151. At least one of the first bolts 32 may be inserted into the fastener receiver 434 and be inserted into corresponding nuts 31 located in the channel 318 of the upright rail 313 extending between the top railing 151 and the trailer frame 10. One of the L-brackets 433 may be located on the first side 15 near the lower post bracket 243 and another L-bracket 433 may be located on the second side 16 near the lower post bracket 243. In an alternative embodiment, various elements of the first rack 237 or the second rack 238 may be adjustable, such that items or tools may be stored in multiple height positions relative to the decking 242 of the trailer frame 10. It is to be understood that the present disclosure contemplates that the rack assembly 234 may be selectively mounted at a location on the trailer frame 10 such that the distance between the first post support 253 and the second post support 254 may be adjusted to accommodate items or tools of different lengths. It is to be understood tat the present disclosure contemplates that the rack assembly 234 may be selectively mounted at various locations on the trailer frame such that the distance between the first rack 237 and the second rack 238 may be adjusted to accommodate items and tools of different lengths and configurations. It is also to be understood that one or more accessories may be mounted to the rack assembly 234 via fasteners, hooks, tie-downs, ratchet straps, or any other means of securing one or more accessories to the rack assembly 234.

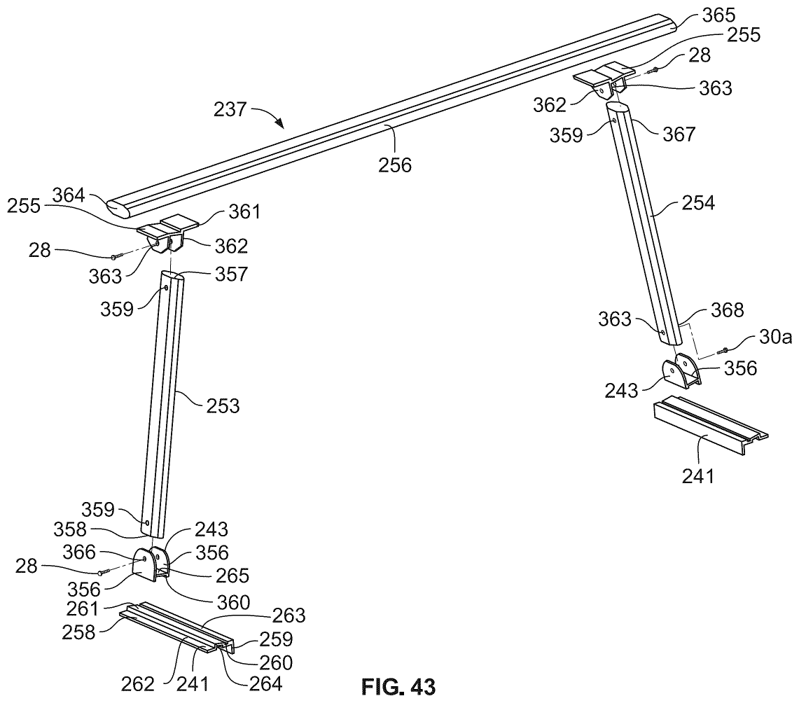

Referring to FIG. 43, the first rack 237 is shown. The base plates 241 include a railing plate 258 and a railing flange 259. The railing plate 258 and the railing flange 259 are substantially perpendicular to each other forming a 90-degree angle approximately. The railing plate 258 includes a recess 260, a guiderail 261, a first top wall 262 and a second top wall 263. The railing flange 259 extends downward from the second top wall 263. The second top wall 263 is adjacent to the recess 260. The second top wall 263 and the recess 260 extend along the base plate 241 in different planes. The recess 260 is located between the guiderail 261 and the second top wall 263. The guiderail 261. The guiderail 261 extends between the recess 260 and the first top wall 262. The guiderail 261 includes an angled surface 264 extending in an upward angle towards the first top wall 262. The first top wall 262 extends from a portion of the guiderail 261 and may be parallel with the top railing 151. The first top wall 262 and the second top wall 263 are substantially parallel with each other and extending along the base plate 241 in different planes. Each of the lower post brackets 243 includes a bottom wall 265 with at least two post flanges 356 extending from the bottom wall 265 at a 90-degree angle approximately. Each of the post flanges 356 includes a secondary fastener receiver 366 configured to receive the second bolt 28 to couple the first post support 253 to one of the lower post brackets 243. The lower post bracket 243 also includes an underside profile 360. The lower post brackets 243 are secured to the base plate 241 by inserting a portion of the underside profile 360 of the lower post bracket 243 into the recess 260 located on the railing plate 258. The underside profile 360 mates with portions of the recess 260, the angled surface 264 of the guiderail 261, and the first top wall 262. The lower post bracket 243 may be configured to couple to the base plates 241 by a snap-fit or friction type fit, or another method in which the lower post bracket 243 may be secured to the base plates 241. In alternative embodiments, the lower post brackets 243 maybe integrally attached to the base plates 241.

Referring to FIG. 43, the first post support 253 may be inserted in between the two post flanges 356 located on the lower post bracket 243. The first post support 253 includes a top end 357, a bottom end 358, and a plurality of secondary fastener receivers 359. The second bolt 28 may be inserted through the secondary fastener receivers 366 located in the lower post bracket 243 and through the secondary fastener receivers 359 located near the bottom end 358 of the first post support 253 when aligned. The first post support 253 may be secured to the lower post bracket 243 by fastening the nut 252 to the bolt 28 extending through the secondary fastener receivers 359 located near the bottom end and the secondary fastener receivers 366 located in the lower post bracket 243. The first post support 253 may extend between the lower post bracket 243 and the upper post bracket 255. The first post support 253 may be coupled to the lower post bracket 243 near the bottom end 358 and the upper post bracket 255 near the top end 357.

Referring to FIG. 43, the first post support 253 may be coupled and secured to the upper post bracket 255 near the top end 357. The upper post bracket 255 includes a crossbar plate 361 and at least two post flanges 362 extending from the crossbar plate 361 at a 90-degree angle approximately. The post flanges 362 are substantially perpendicular to the crossbar plate 361. Each of the post flanges 362 includes a secondary fastener receiver 363. The first post support 253 may be inserted in between the two post flanges 362 located on the upper post bracket 255. The second bolt 28 may be inserted through the secondary fastener receivers 363 located in the upper post bracket 255 and through the secondary fastener receivers 359 located near the top end 357 of the first post support 253 when aligned. The first post support 253 may be secured to the upper post bracket 255 by fastening the nut 252 to the bolt 28 extending through the secondary fastener receivers 359 located near the top end 357 and the secondary fastener receivers 363 located in the upper post bracket 255. The first post support 253 may extend between the lower post bracket 243 and the upper post bracket 255. The first post support 253 may be coupled to the lower post bracket 243 near the bottom end 358 and the upper post bracket 255 near the top end 357. The crossbar plate 361 is configured to be coupled to the crossbar support 256. In the preferred embodiment, the crossbar plate 361 may be coupled and secured to the crossbar support 256 with fasteners, such as the second bolts 28 and the nuts 252, not shown. In alternative embodiments, the crossbar support 256 may be integrally formed with the crossbar plate 361.

Referring to FIG. 43, the crossbar support 256 includes a first end 364 and a second end 365. The first end 364 of the crossbar support 256 may be coupled to the upper post bracket 255 on the first post support 253. The second end 365 of the crossbar support 256 may be coupled to the upper post bracket 255 coupled to the second post support 254. The second post support 254 includes a top end 367 and a bottom end 368. The upper post bracket 255 may be coupled to the top end 367 of the second post support 254 and a portion of the crossbar support 256 located near the second end 365. The top end 367 of the second support post 254 may be inserted in between the post flanges 362. The second bolt 28 may be inserted through the secondary fastener receivers 363 located on the post flanges 362 that may be aligned with the secondary fastener receivers 359 near the top end 367 of the second post support 254. The upper post bracket 255 may be secured to the second post support 254 by fastening the nut 252 to the second bolt 28 being inserted through the secondary fastener receivers 363 located on the post flanges 362 and the secondary fastener receivers 359 near the top end 367 of the second post support 254. The bottom end 368 of the second support post 254 may be inserted in between the post flanges 356 of the lower post brackets 243. The bottom end 368 of the second post support 254 may be coupled to the lower post brackets 243 by inserting the second bolt 28 through the secondary fastener receivers 359 near the bottom end 368 and the secondary fastener receivers 366 located in the lower post brackets 243. The second bolt 28 may be fastened and secured to the lower post bracket 243 and the bottom end 368 of the second support post 254 by fastening the nut 252 to the second bolt 28. The lower post bracket 243 coupled to the second support post 254 may also be coupled to the other base plate 241 separate from the first support post 253. In the illustrated embodiment, the rack assembly 237 includes four upper post brackets 255, each of which are operable to secure the top ends 357 of the first post support 253 and the top end 367 of the second post support 254 to the crossbar support 256. Items or tools may be selectively mounted on the first post support 253, the second post support, 254 and/or the crossbar support 256.

### Hitch Assembly

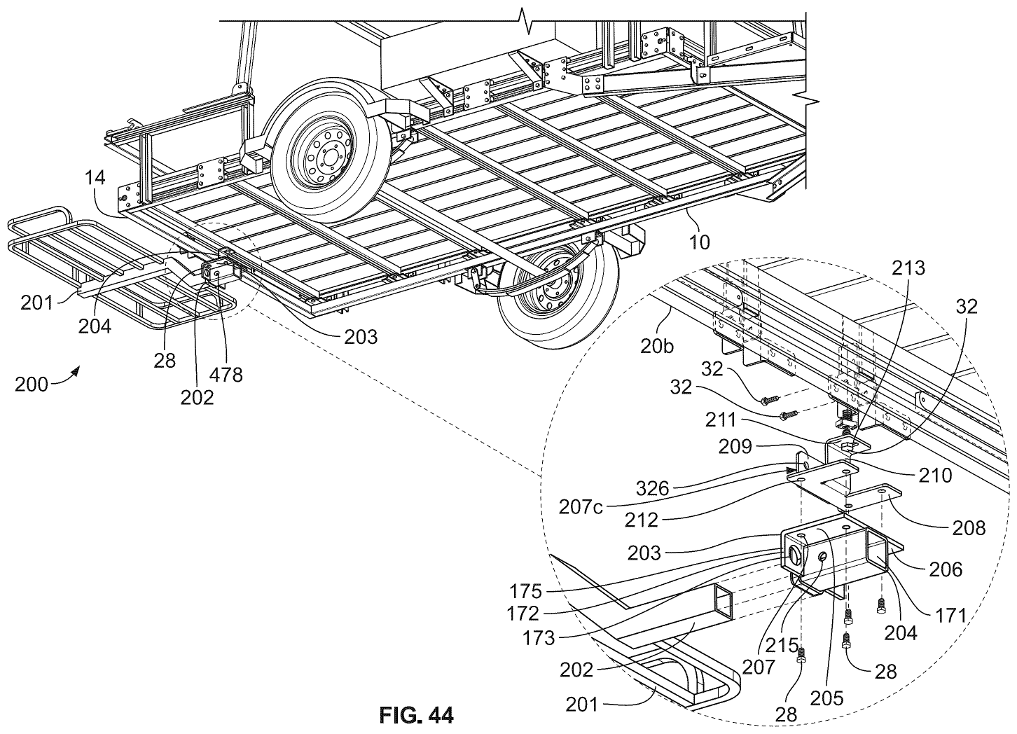

FIG. 44 shows an accessory mounting system wherein the accessory mounting system comprises a hitch assembly 200 that provides a means for the user to hitch an accessory to the trailer frame 10. The hitch assembly 200 is selectively mounted to the rear end 14 of the trailer frame 10. The hitch assembly 200 includes a hitch bracket 175 and a hitched device 201, such as a cargo rack as shown. The hitched device 201 includes a hitch 202. The hitch bracket 175 includes a hitch receiving portion 203 and a hitch trailer attachment portion 204. The hitch receiving portion 203 includes a rectangular hitch receiver 171 and a hitch receiving bracket 205. The hitch receiver 171 is a rectangular-shaped channel having openings on both ends configured to receive the hitch 202 that may have various lengths. In alternative embodiments, the hitch receiver 171 may be other shapes, such as a circular tubular structure. The hitch receiver 171 also includes a set of pin holes 215. The pin holes 215 are openings located in two opposing sidewalls of the rectangular hitch receiver 171. The pin holes 215 may be aligned with pin holes located on the hitch to permit a pin or another type of fastening device to secure the hitch bracket 175 to the hitch device 201. The hitch receiving bracket 205 includes an upper hitch plate 206 and a chain plate 172. The chain plate 172 and the upper hitch plate 206 are substantially perpendicular to each other. The chain plate 172 extends downwards from the upper hitch plate 206 towards the hitch receiver 171. The chain plate 172 partially surrounds the hitch receiver 171 near one end closest to the rear end 14 of the trailer frame 10. The chain plate 172 includes a chain aperture 173 located on two sides of the hitch receiver 171. In the preferred embodiment, one of the chain apertures 173 is located near the first side 15 of the trailer frame 10 and the other chain aperture 173 is located near the second side 16 of the trailer frame 10. The upper hitch plate 206 includes a plurality of secondary fastener receivers 207. In the preferred embodiment, the upper hitch plate 206 may include one of the secondary fastener receivers 207 in each corner. The trailer attachment portion 204 may be located above and adjacent to the upper hitch plate 206. The trailer attachment portion 204 includes a c-shaped plate 208, a trailer frame attachment portion 209, an extension plate 210, and a cross-member attachment plate 211. The c-shaped plate 208 includes secondary fastener receivers 212. The secondary fastener receivers 212 located on the c-shaped plate 208 may align with the secondary fastener receivers 207 located on the upper hitch plate 206. The second bolts 28 may be inserted through the aligned secondary fastener receivers 207 on the upper hitch plate 206 and the secondary fastener receivers 212 located on the c-shaped plate 208. The c-shaped plate 208 and the upper hitch plate 206 may be coupled and secured to each other by fastening the nut 252 to the second bolts 28 extending through the upper hitch plate 206 and the c-shaped plate 207. The trailer attachment portion 209 extends from the c-shaped plate 208 at a 90-degree angle approximately away from the upper hitch plate 206. The trailer attachment portion 209 includes a pair of fastener receivers 326 configured to receive the first bolts 32, see FIG. 39. The first bolts 32 may be inserted through the trailer attachment portion 209 and into corresponding nuts 31 located in the channels 21 of the rails 20 forming the lower rail frame 20b. The extension plate 210 is adjacent to the trailer attachment portion 209 and the c-shaped plate 209. The extension plate 210 extends from the c-shaped plate 209 in an upwards direction away from the upper hitch plate 206. The extension plate 210 extends beyond the trailer attachment portion 209 in the upwards direction. The extension plate 210 is substantially perpendicular with the cross-member attachment plate 211. The cross-member attachment plate 211 extends from the extension plate 210 at a 90-degree angle approximately. The cross-member attachment plate 211 includes a fastener receiver 213. The cross-member attachment plate 211 may be located between the upper rail frame 20a and the lower rail frame 20b. The cross-member attachment plate 211 may extend through a portion of the trailer frame 10 such that the fastener receiver 213 may be aligned with the nut 31 located in the channel 21 of the cross-member rail 19 extending between the first side 15 and the second side 16. The first bolt 32 may be inserted through the cross-member attachment plate 211 in the upwards direction and into the corresponding nut 31 located in the channel 21 of the rail 20.

### Tie Down Bracket

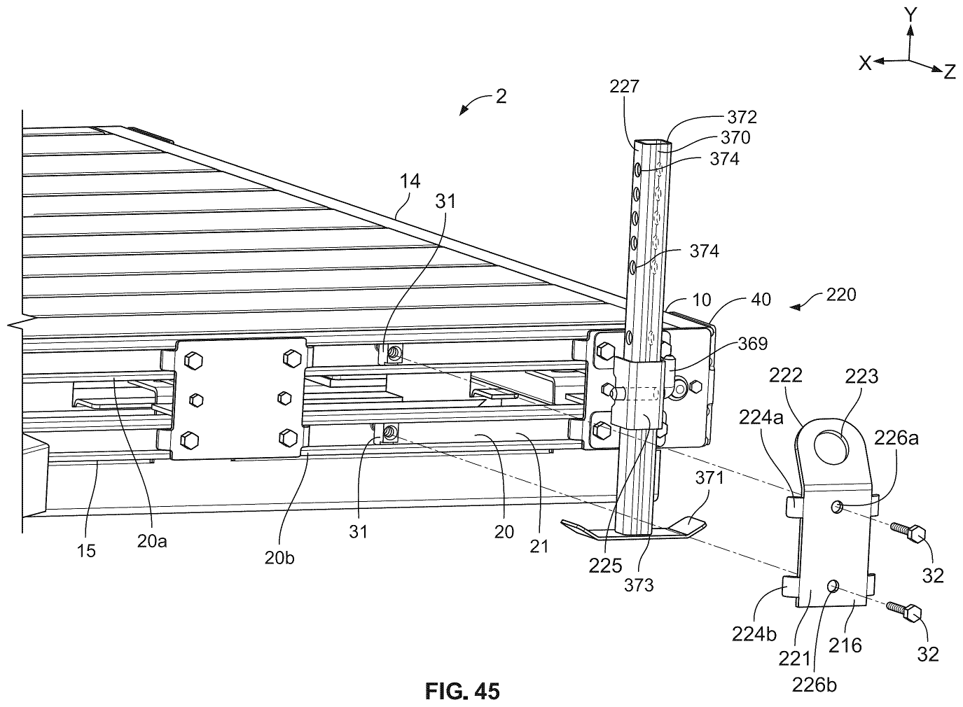

FIG. 45 shows an accessory mounting system wherein the accessory mounting system comprises a tie down bracket 216 coupled to the trailer frame 10 for securing tie-downs. The tie down bracket 216 includes a body 221 and an anchor plate 222. The anchor plate 222 includes an opening 223 for a tie down or ratchet straps of various sizes and/or configurations to be fastened to or extend through to another opening 223 of another anchor plate 222 located on the trailer frame 10, not shown. The anchor plate 222 extends from the body 221 at an upward angle extending towards the opposing side of the trailer 10. More specifically, the anchor plate 222 extends towards the second side 16 of the trailer frame 10 when the anchor plate 222 is extending from the body 221 of the tie down bracket 216 coupled to the first side 15 of the trailer frame 10. The body 221 includes at least one upper tab 224a and at least one lower tab 224b. The upper tabs 224a extend from opposing sides of the body 221 of the tie down bracket 216 and are operable to couple the body 221 to the rail 20 forming a portion of the upper frame 20a. The lower tabs 224b extend from opposing sides of the body 221 of the tie down bracket 216 and are operable to couple the body 221 to the rail 20 forming a portion of the lower frame 20b. The tie down bracket 216 also includes at least one upper fastener receiver 226a and at least one lower fastener receiver 226b. The upper fastener receiver 226a is operable to receive the first bolt 32 for fastening the body 221 to one of the rails 20 forming a portion of the upper rail frame 20a. The lower fastener receiver 226b is operable to receive the first bolt 32 for fastening the body 221 to one of the rails 20 forming a portion of the lower rail frame 20b. The first bolt 32 may be inserted through the upper fastener receiver 226a and into a corresponding nut 31 located within the channel 21 of the rail 20 forming a portion of the upper rail frame 20a. The first bolt 32 may be inserted through the lower fastener receiver 226b and into a corresponding nut 31 located within the channel 21 of the rail 20 forming a portion of the lower rail frame 20b. The tie down bracket 216 may be coupled to the trailer frame 10 at various locations. There may be more than one tie down bracket 216 coupled to the trailer frame 10. An advantage of the tie down bracket 216 is that it is selectively mounted at various locations of the trailer frame 10 in accordance with the load or cargo that may need to be secured to the trailer frame 10. It is to be understood that the present disclosure contemplates multiple tie-down brackets 216 selectively mounted to locations on the trailer frame 10.

### Stabilizer Jack Assembly

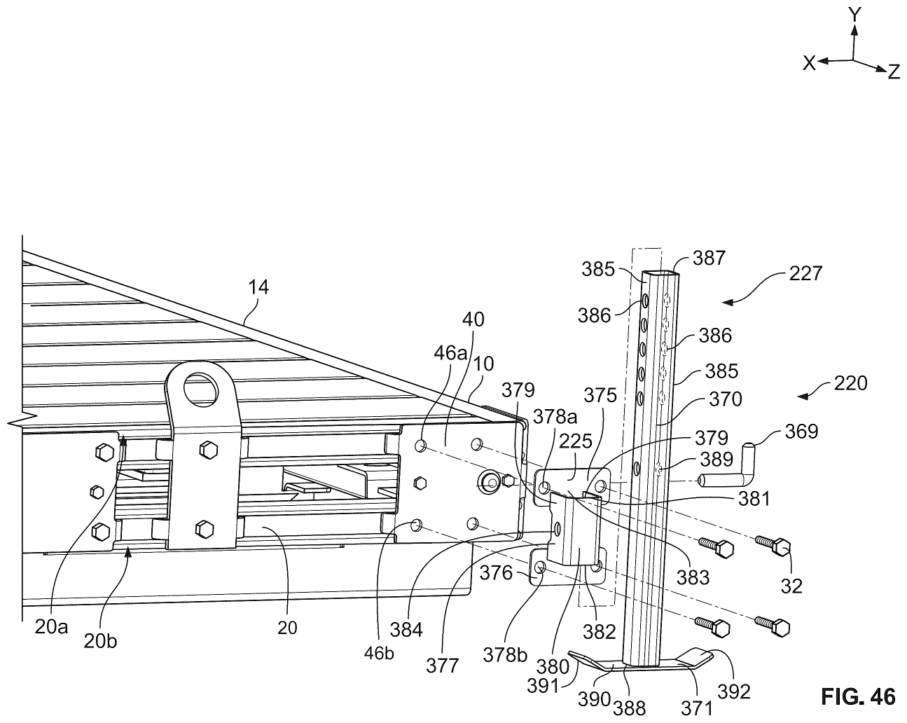

FIG. 45 and FIG. 46 show an accessory mounting system wherein the accessory mounting system comprises the stabilizer jack assembly 220 coupled to the trailer frame 10. The stabilizer jack assembly 220 provides a means for the user to stabilize the modular base trailer 2 by eliminating rocking or upending of the base trailer 2 during loading or unloading. The stabilizer jack assembly 220 includes a stabilizer jack bracket 225, a jack 227, and a securing pin 369. The jack 227 is slidable within a portion of the stabilizer jack bracket 225. The jack 227 includes a standard 370 and a base 371. The standard 370 includes a top end 372, a bottom end 373, and a plurality of adjustment apertures 374 located between the top end 372 and the bottom end 373. The base 371 may engage with the ground or another type of surface during periods of use. The stabilizer jack bracket 225 may be coupled to the corner brackets 40 located near the rear end 14 of the trailer frame 10. For example, the stabilizer jack bracket 225 may be coupled to the corner bracket 40 coupling portions of the rear end 14 and the first side 15 of the trailer frame 10 together. Another stabilizer jack bracket 225 may be coupled to the corner bracket 14 coupling portions of the rear end 14 and the second side 16 of the trailer frame 10 together, not shown. It is to be understood that the present disclosure contemplates that the stabilizer jack assembly 220 may be selectively mounted at a location on trailer frame 10 or the trailer tongue assembly 3. It is also to be understood that the present disclosure contemplates multiple stabilizer jack assemblies 220 selectively mounted at various locations on the trailer frame 10.

Referring to FIG. 46, the stabilizer jack bracket 225 includes a top plate 375, a bottom plate 376, and a U-shaped channel 377. The top plate 375 includes a set of fastener receivers 378a. The fastener receivers 378a are configured to receive the first bolts 32. The fastener receivers 378a are spaced apart horizontally from each other such that one of the fastener receivers 378a may be located more near the rear end 14 of the trailer frame 10 and the other fastener receiver 378a may be located more near the front end 13 of the trailer frame 10. The fastener receivers 378a may align with the corresponding fastener receivers 46a located on the corner bracket 40. The stabilizer jack assembly 220 is coupled to the trailer frame 10 by using first bolts 32 and nuts 31. The first bolts 32 may couple the stabilizer jack bracket 225 to the trailer frame 10 by being inserted through the fastener receivers 378a located on the stabilizer jack bracket 225 and through the fastener receivers 46a located on the corner bracket 40 and into the corresponding nuts 31 located in the channels 21 of the rail 20 forming a portion of the upper rail frame 20a.

Referring to FIG. 46, the bottom plate 376 is spaced apart from the top plate 375 and located below the top plate 375. The bottom plate 376 includes a set of fastener receivers 378b. The fastener receivers 378b are configured to receive the first bolts 32. The fastener receivers 378b are spaced apart horizontally from each other such that one of the fastener receivers 378b may be located more near the rear end 14 of the trailer frame 10 and the other fastener receiver 378b may be located more near the front end 13 of the trailer frame 10. The fastener receivers 378b may align with the corresponding fastener receivers 46b located on the corner bracket 40. The first bolts 32 may couple the stabilizer jack bracket 225 to the trailer frame 10 by being inserted through the fastener receivers 378b located on the stabilizer jack bracket 225 and through the fastener receivers 46b located on the corner bracket 40 and into the corresponding nuts 31 located in the channels 21 of the rail 20 forming a portion of the lower rail frame 20b.

Referring to FIG. 46, the U-shaped channel 377 extends between the top plate 375 and the bottom plate 376. The U-shaped channel 377 includes a set of parallel sidewalls 379 and a lateral wall 380 extending between the parallel sidewalls 379. The U-shaped channel 377 includes a first end 381 and a second end 382. Portions of the parallel sidewalls 379 near the first end 381 are integrally formed with the top plate 375. Portions of the parallel sidewalls 379 near the second end 382 are integrally formed with the bottom plate 376. In alternative embodiments, the parallel sidewalls 379 may be coupled to the top plate 375 and the bottom plate 376 with some type of fastening device, such as a bolt/nut arrangement, screws, or with a snap-fit arrangement. The parallel sidewalls 379, the lateral wall 380, the top plate 375, and the bottom plate 376 are configured to form an opening 383 to receive the standard 370. The standard 370 may be moveable within the opening 383. The parallel sidewalls 379 include a pin aperture 384. The pin apertures 384 are configured to receive the securing pin 369.

Referring to FIG. 46, the standard 370 of the stabilizer jack assembly 220 may include at least four sidewalls 385 forming a square shape having an exposed end 387 and a base end 388. The base end 388 is coupled to the base 371. The base end 388 may extend from the base 371 and be integrally formed with the base 371. The exposed end 387 may be located on the opposing end from the base end 388. The standard 370 may be hollow. The standard 370 includes a set of a plurality of holes 386 located on at least two of the sidewalls 385 opposing each other. The holes 386 on the opposing sidewalls 385 align with each other and are spaced longitudinally apart from each other extending between the exposed end 387 and the base end 388. The standard 370 also includes a storage hole 389. The storage hole 389 is located on the same opposing sidewalls 385 as the holes 386. The storage hole 389 is configured to align with the pin aperture 384 located on the U-shaped channel 377 to receive the securing pin 369. During periods when the stabilizer jack assembly 220 is not in use, the securing pin 369 may be inserted through the storage holes 389 and the pin apertures 384 to keep the jack 227 from sliding out of position and maintaining an elevated position away from the ground. To permit the standard 370 to slide and/or move within the U-shaped channel 377, the user may remove the securing pin 369 from the storage holes 389 and the pin apertures 384 to permit movement of the standard 370. Once the user selectively places the jack 227 at the proper and/or desired placement, the user may insert the securing pin 369 into one of the pin apertures 384, then through the selected holes 386 and through the remaining pin aperture 384 to secure the standard 370 in place at a desired placement/height during periods of use. In the preferred embodiment, the jack 227 may be locked in multiple height positions along the length of the standard 370 to stabilize and/or elevate the rear end 14 of the trailer frame 10 during loading or unloading of the trailer frame.

Referring to FIG. 46, the base 371 of the jack 227 is coupled to the base end 388 of the standard 370. The base 371 includes a ground engaging portion 390, a first slanted flange 391 and a second slanted flange 392. The ground engaging portion 390 is substantially perpendicular to the standard 370. The ground engaging portion 390 is relatively horizontal and may engage with the ground to stabilize the trailer frame 10. The first slanted flange 391 extends from the ground engaging portion 390 near the front end 13 of the trailer frame 10 at an upwards angle. The second slanted flange 392 extends from the ground engaging portion 390 near the rear end 14 of the trailer frame at an upwards angle. The first slanted flange 391 and the second slanted flange 392 may extend substantially the same upwards angles from the ground engaging portion 390 or different angles at an upward angle or downward angle.

### Toolbox Assembly

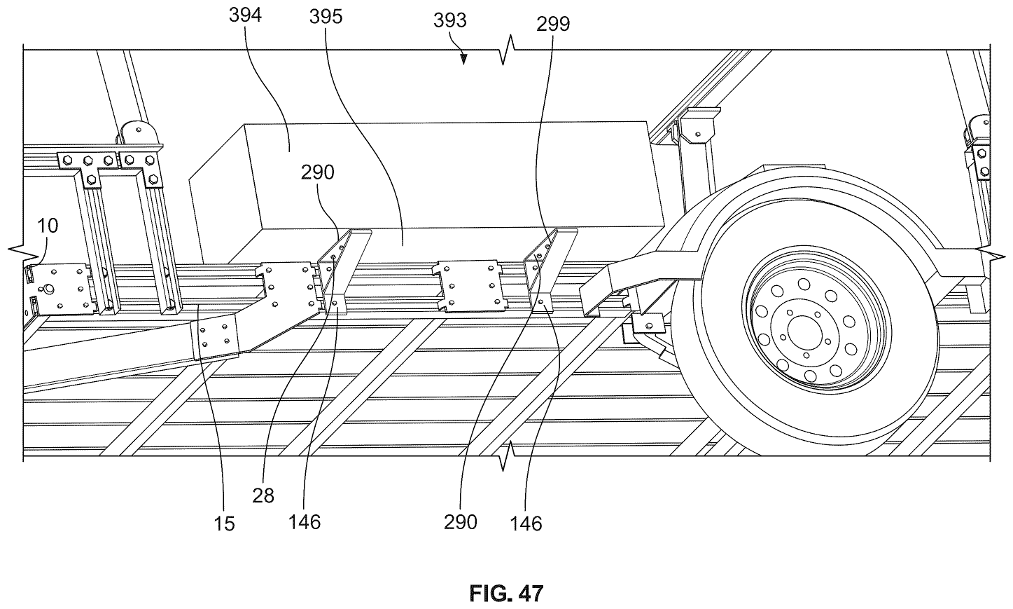

FIG. 47 shows an accessory mounting system wherein the accessory mounting system comprises a toolbox assembly 393 that provides a means for the user to store tools coupled to the trailer frame 10 on the first side 15. The toolbox assembly 393 includes a toolbox 394 and the outrigger brackets 146. More than one toolbox 394 may be coupled to the trailer frame 10. The toolbox 394 includes secondary fastener receivers (not shown) on a bottom surface 395 of the toolbox 394. The outrigger brackets 146 may be coupled to the trailer frame 10 at selected locations as discussed previously in this disclosure. The toolbox 394 may be selectively positioned on the trailer frame 10 by the user. At least two secondary fastener receivers located on the bottom surface 395 of the toolbox 394 may be aligned with the secondary fastener receivers 299 located on the shelf plate 290 of one of the outrigger brackets 146. Another set of secondary fastener receivers located on the bottom surface 395 of the toolbox 394 may be aligned with the secondary fastener receivers 299 located on the shelf plate 290 of another outrigger bracket 146. The outrigger brackets 146 coupled to the trailer frame 10 may be spaced apart the same distance as the secondary fastener receivers located on the bottom surface 395 of the toolbox 394. The second bolts 28 may secure the toolbox 394 to the outrigger brackets 146. More specifically, the second bolts 28 may be inserted through the bottom surface 395 of the toolbox 394 and through the secondary fastener receivers 299 located on the shelf plate 290 of the outrigger bracket 146 and secured with nuts 252, see FIG. 30. It is to be understood that the present disclosure contemplates multiple outrigger brackets selectively mounted on the trailer frame 10 at various locations and sufficient to hold or mount accessories of variable lengths, widths, and weight.

### Tongue Tray

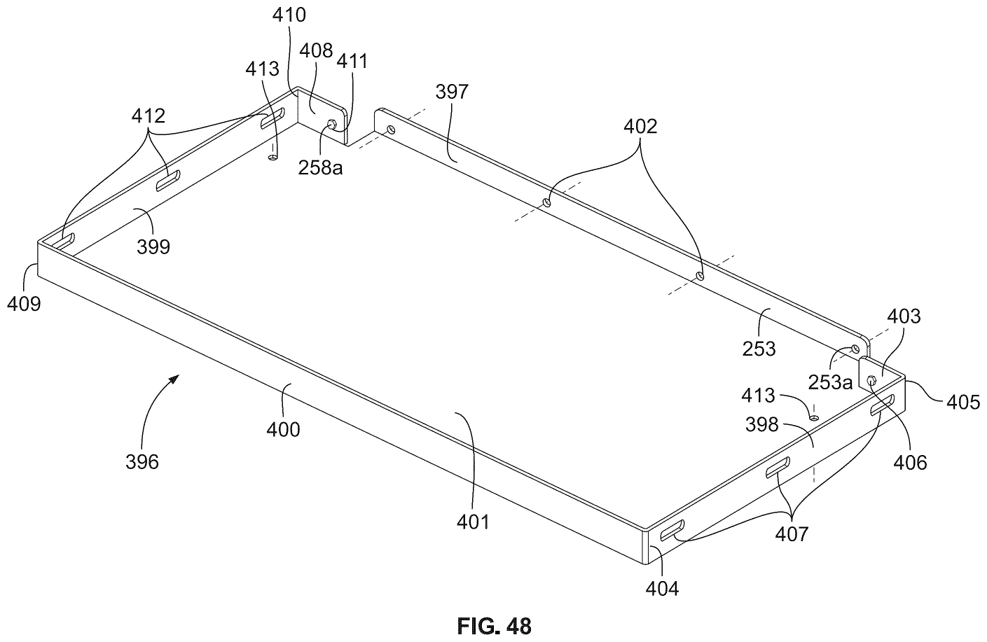

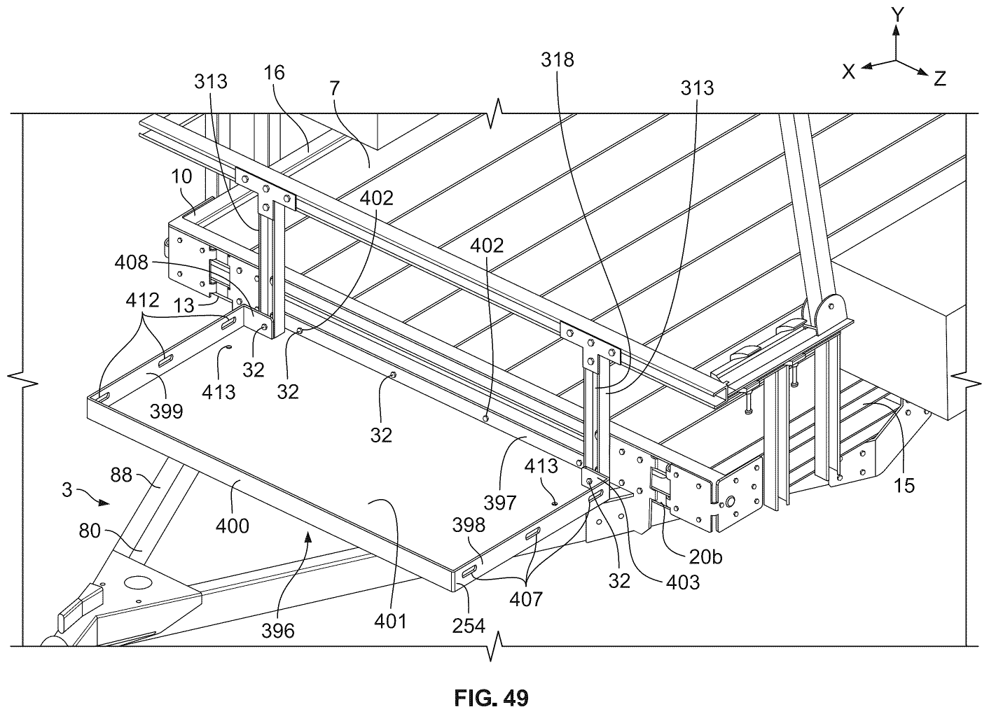

FIG. 48 shows an accessory mounting system wherein the accessory mounting system comprises a tongue tray 396 is shown. The tongue tray 396 includes a trailer wall 397, a first sidewall 398, a second sidewall 399, a front wall 400, and a tray plate 401. The tray plate 401 is substantially planar. The tray plate 401 includes a plurality secondary fastener receivers 413. One of the secondary fastener receivers 413 may be located near the first sidewall 398 and another secondary fastener receiver may be located near the second sidewall 399. The trailer wall 397 extends upwardly from the tray plate 401. The trailer wall 397 and the tray plate 401 are substantially perpendicular with each other. The trailer wall 397 includes a plurality of fastener receivers 402. The fastener receivers 402 are spaced apart horizontally from each other the length of the trailer wall 397. The front wall 400 extends upwardly from the tray plate 401. The front wall 400 and the tray plate 401 are substantially perpendicular with each other. The first sidewall 398 is a mirror image of the second sidewall 399. The first sidewall 398 extends upwardly from the tray plate 401. The first sidewall 398 and the tray plate 401 are substantially perpendicular with each other. The first sidewall 398 includes a first trailer flange 403, a front wall end 404, and a trailer end 405. The front wall end 404 is adjacent to the front wall 400. The trailer end 405 is adjacent to the first trailer flange 403. The first trailer flange 403 extends from the first sidewall 398 at a 90-degree angle approximately near the front wall end 404. The first trailer flange 403 is substantially perpendicular with the first sidewall 398. The first trailer flange 403 extends upwardly from the tray plate 401. The first trailer flange 403 includes a fastener receiver 406. The first sidewall 398 includes a plurality of slots 407. The slots 407 are spaced apart from each other along the length of the first sidewall 398. The second sidewall 399 extends upwardly from the tray plate 401. The second sidewall 399 and the tray plate 401 are substantially perpendicular with each other. The second sidewall 399 includes a second trailer flange 408, a front wall end 409, and a trailer end 410. The front wall end 409 is adjacent to the front wall 400. The trailer end 410 is adjacent to the second trailer flange 408. The second trailer flange 408 extends from the second sidewall 399 at a 90-degree angle approximately near the front wall end 404. The second trailer flange 408 is substantially perpendicular with the second sidewall 399. The second trailer flange 408 extends upwardly from the tray plate 401. The second trailer flange 408 includes a fastener receiver 411. The second sidewall 399 includes a plurality of slots 412. The slots 412 are spaced apart from each other along the length of the second sidewall 399. The first trailer flange 403 and the second trailer flange 408 extend from the first sidewall 398 and the second sidewall 399, respectively, towards each other.

Referring to FIG. 49, the tongue tray 396 is shown disposed on the trailer tongue assembly 3 and is mounted to the front end 13 of the trailer frame 10 to hold cargo. The secondary fastener receivers 413 located in the tray plate 401 may be aligned with the secondary fastener receivers 414 located in the first sidewalls 88 of the tongue rails 80. More specifically, the secondary fastener receiver 413 located near the second sidewall 399 may be aligned with the secondary fastener receiver 414 located in the first sidewall 88 of the tongue rail 80 located near the second side 16. The secondary fastener receiver 413 located near the first sidewall 398 may be aligned with the secondary fastener receiver 414 located in the first sidewall 88 of the tongue rail located near the first side 15. The second bolts 28, not shown, may be inserted through the aligned secondary fastener receivers 413 and the secondary fastener receivers 414 and be secured with the nuts 252, not shown, to couple the tongue tray 396 to the tongue assembly 3. The first trailer flange 403 may be adjacent to one of the upright rails 313. The second trailer flange 408 may be adjacent to another one of the upright rails 313. The first trailer flange 403 may be coupled to the upright rail 313 with the first bolt 32. The first bolt 32 may be inserted through the fastener receiver 406 and into the corresponding nut 31 located in the channel 318 of the upright rail 313. The second trailer flange 408 may be coupled to the upright rail 313 with the first bolt 32. The first bolt 32 may be inserted through the fastener receiver 411 and into the corresponding nut 31 located in the channel 318 of the upright rail 313. The fastener receivers 402 located in the trailer wall 397 may be aligned with corresponding nuts 31 located in the channel 21 of the rails 20 forming portions of the lower rail frame 20b. The tongue tray 396 may be coupled to the front end 13 of the lower rail frame 20b by inserting the first bolts 32 into the fastener receivers 402 and into the corresponding nuts 31 located in the channel 21 of the rail 20 forming a portion of the lower rail frame 20b. The slots 407 located on the first sidewall 398 and the slots 412 located on the second sidewall 399 are operable to receive fasteners (not shown), tie downs, bungee cords, or any other accessory. In alternative embodiments, the trailer wall 397, the first sidewall 398, the second sidewall 399, and front wall 400 are extended upwards, away from the tray plate 401, and may support a lid, not shown, thereby forming a box (not shown). In this embodiment, the lid may be secured to at least one hinge on the trailer wall 397. Also in this embodiment, the tongue tray 396 may be disposed on both of the tongue rails 80 or, alternatively, be positioned between the tongue rails 80. It to be understood that the present disclosure contemplates that the tongue tray 396 may be comprised of different shapes and sizes to hold cargo of different shapes and sizes.

It is to be understood that the present disclosure contemplates that the trailer kit 1 and the modular base trailer 2 are not limited to the plurality of trailer configurations shown in FIGS. 23-49. Similarly, the present disclosure contemplates that the above-described accessory mounting systems, brackets, and one or more accessories may be interchangeably secured to the trailer frame 10 with one another. For example, the undercarriage ramp storage system 185 shown in FIG. 39 is selectively mounted to the trailer frame 10 with the full fence system 150. In one embodiment, the undercarriage ramp storage system 185 may be selectively mounted to the trailer frame 10 with the frame extension system 140. In another embodiment, the fairing system 120 with the rear ramp storage system 130 may be selectively mounted to the trailer frame 10. Similarly, the hitch assembly 200 shown in FIGS. 42 and 44 that is selectively mounted to the trailer frame 10 with the full fence system 150 may also be selectively mounted to the trailer frame 10 with the fairing system 120. Further, the stabilizer jack assembly 220 shown in FIGS. 45 and 46 that is selectively mounted to the trailer frame 10 may also be selectively mounted to the trailer frame 10 with the fairing system 120 or with the full fence system 150. As such, the accessory mounting systems, the accessory brackets, and the one or more accessories are interchangeable with each other and do not limit the modular base trailer 2 or trailer kit 1 to the one or more trailer configurations shown in the figures. Indeed, the present disclosure contemplates that the plurality of rails, the plurality of uprights, the plurality of brackets, the accessory mounting systems, the accessory brackets, and the one or more accessories may support additional accessories secured to the modular base trailer 2 by a variety of fasteners, tie-downs, brackets, hooks, clamps, cleats, and the like.

### Method of Assembly

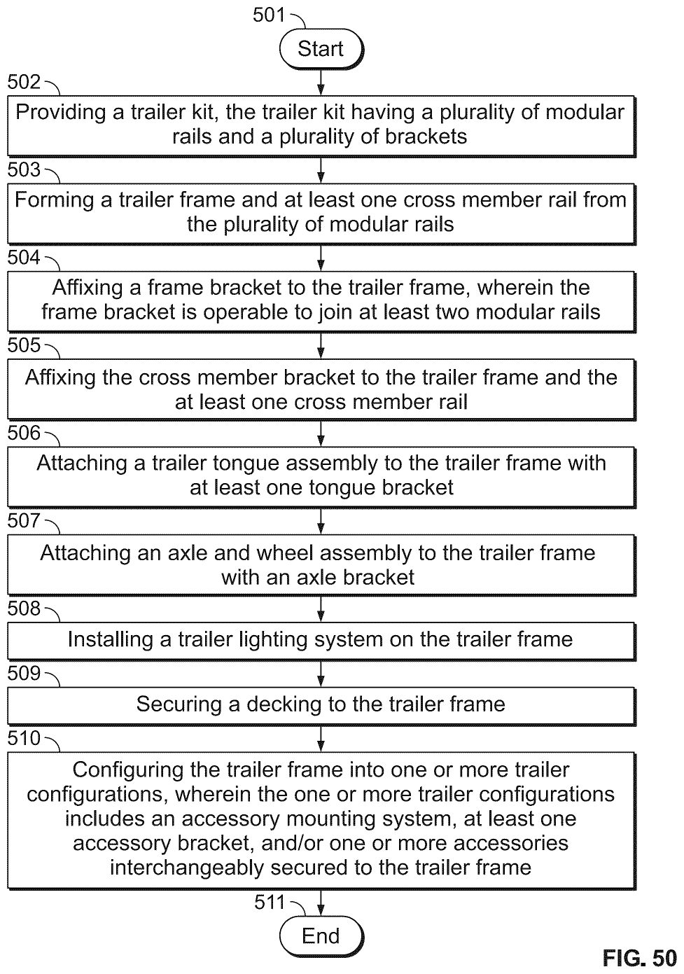

The present disclosure also contemplates a method of assembling the trailer kit 1 to form a modular base trailer 2. Referring to FIG. 50, the example method steps may start at step 501. At step 502, the method comprises providing the trailer kit 1, the trailer kit 1 having the rails, and the plurality of front end brackets 60, the plurality of cross-member brackets 100, the plurality of corner brackets 40, the plurality of tongue rail brackets 70, the plurality of longitudinal brackets 50, and the plurality of axle brackets 90.

At step 503, the method also comprises forming the trailer frame 10 and at least one cross-member rail 19 extending between the first side 15 and the second side 16. The rails 20 and the cross-member rails 19 are selectively interconnected by the cross-member brackets 100) such that any of the rails 20 and any of the cross-member rails 19 may be selected to form the trailer frame 10. In the illustrated embodiment, the trailer frame 10 forms a rectangular shape and comprises the upper rail frame 20a and the lower rail frame 20b.

At step 504, the method also comprises affixing the corner brackets 40 and the longitudinal brackets 50 to the trailer frame 10. The longitudinal bracket 50 may be operable to join at least two rails 20. In the illustrated embodiment, the longitudinal bracket 50 of the frame bracket is operable to join at least one of the rails 20 to another one of the rails 20 co-axially. Additionally, the corner bracket 40 of the frame bracket is operable to join at least one of the rails 20 to another one of the rails 20 at a 90 degree angle in different axes.

At step 505, the method also comprises affixing the cross member bracket 100 to the trailer frame 10 and the cross-member rails 19 extending from the first side 15 to the second side 16. In the illustrated embodiment, at least one cross-member rail 19 extending between the first side 15 and second side 16 is positioned perpendicular to a first side 15 and a second side 16 of the trailer frame 10. For example, the method includes securing the cross member bracket 100 to any of the plurality of brackets such as the longitudinal bracket 50, the corner bracket 40, or the axle bracket 90 with the first bolts 32. The method also includes securing the cross-member rail 19 extending between the first side 15 and the second side 16 to the cross member bracket 100 with the fastener receiver 32.

At step 506, the method also comprises affixing the trailer tongue assembly 3 to the trailer frame 10 with the tongue rail bracket 70. In the illustrated embodiment, the trailer tongue assembly 3 includes at least one tongue rail 80 and a hitch 86 operable to join the tongue rail 80 at a fixed angle. The method includes securing the front end bracket 60 to the tongue rail 80 at angle relative to the front end 13 of the trailer frame 10. The method also includes securing the tongue rail bracket 70 to the tongue rail 80 at an angle relative to the first side 15 (or second side 16) of the trailer frame 10. The method further includes securing the hitch 86 to the hitch end 83 the tongue rail 80. As such, the method includes forming an a-frame with the tongue rail 80.

At step 507, the method also comprises attaching an axle and wheel assembly 4 to the trailer frame 10 with the axle bracket 90. In the illustrated embodiment, the axle bracket 90 is operable to provide structural support between at least two rails 20 selectively interconnected at the 0 degree joint 17. For example, the method includes fastening the axle bracket 90 to the upper rail frame 20a and the lower rail frame 20b at the joint 17 with the first bolt 32 and the nut 31. The method also includes fastening the axle and wheel assembly 4 to the axle bracket 90 with the first bolts 32 and the nuts 31. The example steps may proceed to the end step 511. It is to be understood that the present disclosure is not limited to the specific order of the steps 501-507 and ending at step 511.

The method optionally comprises installing the trailer lighting system 110 on the trailer frame 10. In the illustrated embodiment, the electrical harness 111 powers the trailer lighting system 110 and at least one light 112 a,b,c. The method therefore may optionally include mounting the light 112 a,b,c to any of the plurality of brackets such as the corner bracket 40 or at the rear end 14 of the trailer frame 10. The method optionally comprises securing the decking 242 to the trailer frame 10.

The method further comprises attaching an accessory mounting system, at least one accessory bracket, and/or or one or more accessories to the trailer frame 10, the rails 20, the cross member rails 19 extending between the first side 15 and the second side 16, and/or the upright rails 313. Similarly, the method further comprises removing the accessory mounting system, at least one accessory bracket, and/or or one or more accessories from the trailer frame 10, the rails 20, the cross member rails 19 extending between the first side 15 and the second side 16, and/or the upright rails 313. As such, the method comprises configuring the modular base trailer 2 into one or more trailer configurations. Similarly, the method further comprises configuring the modular base trailer 2 to include multiple trailer configurations on the trailer frame 10. For example, the method includes attaching and/or removing one or more trailer configurations such as the fairing system 120, the rear ramp storage system 130, the frame extension system 140, the full fence system 150, the tailgate system 170, the undercarriage ramp storage system 185, the spare tire bracket 190, the hitch assembly 200, the tie down bracket 216, the stabilizer jack assembly 220, the rack assembly 234, the toolbox assembly 393, and the tongue tray 396. In the illustrated embodiment, the accessory mounting system and one or more accessories include at least one accessory bracket operable to selectively mount the accessory mounting system and one or more accessories at a location on the trailer frame 10, on the cross member rails 19 extending between the first side 15 and the second side 16, and/or on the upright rails 313. For example, the method includes selectively mounting or removing the spare tire bracket 190 or the tie down bracket 216. As such, the method optionally comprises securing at least one accessory bracket to the trailer frame 10, the cross member rails 19 extending between the first side 15 and the second side 16, the upright rails 313, and/or any of the plurality of brackets with the first bolts 32 and the nuts 31 and/or the second bolts 28 and the nuts 252.

It is to be understood that the term “at least one” means there must be a minimum of one of the components that the term “at least one” is modifying, it is further understood that if the specification refers to “a” component or “the” component that those terms (“a” and “the”) have the same meaning as the term “at least one” and that the disclosure is not limited to only one of that component, but also contemplates, and can include, a plurality of those components.

The present described disclosure is described in such full, clear, concise, and exact terms as to enable any person skilled in the art to which it pertains to practice the same. It is to be understood that the foregoing described preferred aspects of the disclosure and that modification may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed:

1. A trailer kit comprising:
a plurality of modular rails, wherein the plurality of modular rails forms a trailer frame, the trailer frame including at least one cross member; and
a plurality of brackets, wherein the plurality of brackets comprises:
a frame bracket operable to join at least two modular rails,
a tongue bracket operable to secure a trailer tongue assembly to the trailer frame,
an axle bracket operable to secure an axle and wheel assembly to the trailer frame, and
a cross member bracket operable to secure the at least one cross member to the trailer frame.

2. The trailer kit of claim 1, wherein each of the plurality of modular rails defines a first end, a second end, and a channel extending between the first and the second end.

3. The trailer kit of claim 2, further comprising at least one fastener, wherein at least a portion of the least one fastener is received within the channel such that the at least one fastener is operable to be fastened to any of the plurality of modular rails.

4. The trailer kit of claim 3, wherein the at least one fastener comprises a nut and a bolt, wherein the nut is received within the channel, the at least one fastener operable to fasten any of the plurality of brackets to any of the plurality of modular rails.

5. The trailer kit of claim 2, wherein the channel of each of the plurality of modular rails is operable to receive an electrical harness, the electrical harness operable to power a trailer lighting system.

6. The trailer kit of claim 5, further comprising a channel cover secured within the channel of each of the plurality of modular rails, the channel cover operable to at least partially seal the channel.

7. The trailer kit of claim 3, wherein each of the plurality of brackets comprises:
a body;
at least one tab extending from the body, operable to couple the body to any of the plurality of modular rails; and
at least one fastener receiver formed in the body, operable to receive the least one fastener for fastening the body to any of the plurality of modular rails or any of the plurality of brackets.

8. The trailer kit of claim 7, wherein the trailer frame comprises an upper set of modular rails and a lower set of modular rails.

9. The trailer kit of claim 8, wherein,
the at least one tab comprises at least one upper tab and at least one lower tab;
the at least one fastener receiver comprises at least one upper fastener receiver and at least one lower fastener receiver;
the at least one upper tab is operable to couple the body to the upper set of modular rails and the at least one lower tab is operable to couple the body to the lower set of modular rails; and
the at least one upper fastener receiver is operable to receive the fastener for fastening the body to the upper set of modular rails and the at least one lower fastener receiver is operable to receive the fastener for fastening the body to the lower set of modular rails, thereby coupling the upper set of modular rails to the lower set of modular rails.

10. The trailer kit of claim 1, wherein the plurality of brackets further comprises at least one accessory bracket operable to secure one or more accessories to the trailer frame, the least one cross member, and/or at least one of the plurality of uprights.

11. The trailer kit of claim 1, wherein the frame bracket comprises:
a corner bracket operable to join at least one of the plurality of modular rails to another one of the modular rails at a 90 degree angle; and
a longitudinal bracket operable to join at least one of the plurality of modular rails to another one of the plurality of modular rails.

12. The trailer kit of claim 11, the corner bracket further comprising a lighting receiver, operable to receive and mount a light to the corner bracket.

13. The trailer kit of claim 1, wherein the tongue bracket comprises:
a front end bracket operable to secure at least one tongue rail to a front end of the trailer frame; and
a tongue rail bracket operable to secure the at least one tongue rail to a side of the trailer frame.

14. The trailer kit of claim 1, wherein the cross member bracket comprises at least one opening in at least one tab formed on a body such that the fastener inserted through the at least one opening is operable to fasten the cross member bracket to any of the plurality of brackets.

15. A base trailer, comprising:
a plurality of modular rails, wherein the plurality of modular rails form a trailer frame; and
a plurality of brackets operable to reinforce the trailer frame,
wherein the base trailer is configurable into one or more trailer configurations and the trailer configurations are interchangeable.

16. The base trailer of claim 15, wherein multiple trailer configurations can be configured on the trailer frame.

17. The base trailer of claim 15, further comprising an accessory mounting system.

18. The base trailer of claim 17, wherein the accessory mounting system comprises one or more accessory brackets.

19. The base trailer of claim 18, wherein the trailer configurations comprise one or more accessories.

20. The base trailer of claim 19, wherein the accessory brackets and/or accessories are interchangeably fastened to the trailer frame with at least one fastener.

21. The base trailer of claim 15, wherein each of the trailer configurations are interchangeably configurable to the trailer frame without welding or drilling into the trailer frame.

22. A method of assembling a trailer kit, comprising:
providing a trailer kit, the trailer kit having a plurality of modular rails and a plurality of brackets, wherein the plurality of brackets comprises:
a frame bracket,
a tongue bracket,
an axle bracket, and
a cross member bracket;
forming a trailer frame and at least one cross member from the plurality of modular rails;
affixing the frame bracket to the trailer frame, wherein the frame bracket is operable to join at least two modular rails;
affixing the cross member bracket to the trailer frame and the least one cross member;
attaching a trailer tongue assembly to the trailer frame with the at least one tongue bracket; and
attaching an axle and wheel assembly to the trailer frame with the axle bracket.

23. The method of claim 22, wherein the method further comprises attaching at least one accessory mounting system, at least one accessory bracket, one or more accessories to the trailer frame, and/or at least one of plurality of uprights.

24. The method of claim 23, wherein the method further comprises removing the at least one accessory mounting system, the at least one accessory bracket, the one or more accessories from the trailer frame, and/or the plurality of uprights.
